(19) United States
(12) Patent Application Publication
(10) Pub. No.: US 2011/0037689 A1
(43) Pub. Date: Feb. 17, 2011

(54) ACTIVE MATRIX SUBSTRATE, MANUFACTURING METHOD OF ACTIVE MATRIX SUBSTRATE, LIQUID CRYSTAL PANEL, MANUFACTURING METHOD OF LIQUID CRYSTAL PANEL, LIQUID CRYSTAL DISPLAY APPARATUS, LIQUID CRYSTAL DISPLAY UNIT, AND TELEVISION RECEIVER

(75) Inventor: Toshihide Tsubata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/988,860

(22) PCT Filed: Jan. 19, 2009
(86) PCT No.: PCT/JP2009/050681

§ 371 Date: Oct. 21, 2010

(30) Foreign Application Priority Data
May 28, 2008 (JP) 2008-140074

(51) Int. Cl. G09G 3/36; G02F 1/1343

(52) U.S. Cl. 345/103; 349/39

(57) ABSTRACT

A liquid crystal panel of the present invention is a liquid crystal panel including a scanning signal line (16x), a data signal line (15x), a transistor (12a) being connected with the scanning signal line (16x) and the data signal line (15x), a first pixel electrode (17a), and a second pixel electrode (17b), the first pixel electrode (17a) and the second pixel electrode (17b) being provided in a single pixel (101), said liquid crystal panel, further including a first capacitor electrode (37a) and a second capacitor electrode (37b), the first capacitor electrode (37a), the first pixel electrode (17a), and a conductive electrode (9a) of the transistor (12a) being electrically connected with each other, the second capacitor electrode (37b) being electrically connected with the second pixel electrode (17b), the first capacitor electrode (37a) and the second pixel electrode (17b) forming a capacitor, and the second capacitor electrode (37b) and the first pixel electrode (17a) forming a capacitor. The arrangement makes it possible to improve a manufacturing yield of an active matrix substrate of a pixel division method of a capacitive coupling type, and that of a liquid crystal panel including the active matrix substrate.

### TECHNICAL FIELD

The present invention relates to an active matrix substrate in which a plurality of pixel electrodes are provided in one pixel region, and to a liquid crystal display apparatus (pixel division method) including the active matrix substrate.

### BACKGROUND ART

For improvement of viewing angle dependence of a γ characteristic of a liquid crystal display apparatus (e.g., for suppressing excess brightness etc. on a display screen), there proposed a liquid crystal display apparatus (pixel division method; see, e.g., Patent Literature 1). The liquid crystal display apparatus controls a plurality of subpixels provided in one pixel so that the plurality of subpixels have respective different luminances. Thus, the liquid crystal display apparatus displays a halftone by area coverage modulation of the plurality of subpixels.

As illustrated in FIG. 41, in an active matrix substrate disclosed in Patent Literature 1, three pixel electrodes 121a through 121c are arranged in one pixel region along a data signal line 115. A source electrode 116s of a transistor 116 is connected with a contact electrode 117a. The contact electrode 117a and a control electrode 118 are connected with each other via a drawing wire 119. The control electrode 118 and a contact electrode 117b are connected with each other via a drawing wire 126. The contact electrode 117a and the pixel electrode 121a are connected with each other via a contact hole 120a. The contact electrode 117b and the pixel electrode 121c are connected with each other via a contact hole 120b. The pixel electrode 121b which is electrically floating and the control electrode 118 overlap each other via an insulating layer, and is capacitively coupled with each of the pixel electrodes 121a and 121c (a pixel division method of a capacitive coupling type). A retention capacitor is formed in an area where the control electrode 118 and a capacitor line 113 overlap each other. The liquid crystal display apparatus including the active matrix substrate can use, as bright subpixels, subpixels corresponding respectively to the pixel electrodes 121a and 121c, and use, as a dark subpixel, a subpixel corresponding to the pixel electrode 121b so that a halftone can be expressed by area coverage modulation of the bright subpixels (two pixels) and the dark subpixel (one pixel).

### CITATION LIST

### Patent Literature 1

Japanese Patent Application Publication, Tokukai, No. 2006-39290 A (Publication Date: Feb. 9, 2006)

### SUMMARY OF INVENTION

However, if, e.g., short-circuiting of the control electrode 118 and the pixel electrode 121b occurred in the active matrix substrate illustrated in FIG. 41, potential control of the pixel electrode 121b cannot be carried out, although cutting the drawing wire 119 makes it possible to prevent a signal potential from being supplied from the data signal line to the pixel electrode 121b. Thus, in conventional active matrix substrates, a subpixel (dark subpixel) corresponding to the pixel electrode 121b is likely to be defective. This leads to a decrease in manufacturing yield.

In view of the problem, the present invention proposes an arrangement for increasing a manufacturing yield of an active matrix substrate of a pixel division method of a capacitive coupling type.

An active matrix substrate of the present invention is an active matrix substrate including a scanning signal line, a data signal line, a transistor being connected with the scanning signal line and the data signal line, a first pixel electrode, and a second pixel electrode, the first pixel electrode and the second pixel electrode being provided in a single pixel region, said active matrix substrate, further comprising a first capacitor electrode and a second capacitor electrode, the first capacitor electrode, the first pixel electrode, and a conductive electrode of the transistor being electrically connected with each other, the second capacitor electrode being electrically connected with the second pixel electrode, the first capacitor electrode and the second pixel electrode forming a capacitor, and the second capacitor electrode and the first pixel electrode forming a capacitor.

According to the arrangement, the first pixel electrode and the second pixel electrode each provided in a single pixel region are connected with each other via two parallel capacitors (coupling capacitors) in an active matrix substrate of a pixel division method of a capacitive coupling type. Even if any one of the two parallel capacitors has a failure in a manufacturing step or the like, the arrangement makes it possible to maintain a state in which the first pixel electrode and the second pixel electrode each of which receives a signal potential from the data signal line are connected with each other via the other one of the two parallel capacitors. For example, even if short-circuiting of the first capacitor electrode and the second pixel electrode occurred, the connected state can be maintained by cutting the first capacitor electrode between a part where the short-circuiting occurred and a part where the first capacitor electrode and the first pixel electrode are connected with each other. This makes it possible to improve a manufacturing yield of the active matrix substrate and a liquid crystal panel including the active matrix substrate.

The active matrix substrate of the present invention can be arranged such that the conductive electrode of the transistor, the first capacitor electrode, and the second capacitor electrode are formed in a same layer. This makes it possible to simplify a layered structure of the active matrix substrate and also simplify manufacturing steps of the active matrix substrate.

The active matrix substrate of the present invention can be arranged such that at least a part of the first capacitor electrode and the second pixel electrode overlap each other via an interlayer insulating film which covers a channel of the transistor, and at least a part of the second capacitor electrode and the first pixel electrode overlap each other via the interlayer insulating film.

The active matrix substrate of the present invention can be arranged such that each of an outer periphery of the first pixel electrode and an outer periphery of the second pixel electrode includes a plurality of sides; one of the plurality of sides of the first pixel electrode is adjacent to one of the plurality of sides of the second pixel electrode; and each of the first capacitor electrode and the second capacitor electrode, the first pixel electrode, the second pixel electrode, and a gap between the one of the plurality of sides of the first pixel electrode and the one of the plurality of sides of the second pixel electrode are provided so as to overlap one another. Therefore, even if the first pixel electrode and the second pixel electrode become misaligned with respect to the first capacitor electrode and the second capacitor electrode in a direction perpendicular to the gap, an area where the first capacitor electrode and the second pixel electrode overlap each other and an area where the second capacitor electrode and the first pixel electrode overlap each other complement each other. This is advantageous in that a total amount of capacitances of the two coupling capacitors is unlikely to change. In this case, the active matrix substrate of the present invention can be arranged such that the first and second capacitor electrodes are provided so that, if the first capacitor electrode is virtually rotated by 180° around a point of the gap, the first capacitor electrode is substantially located in a place where the second capacitor electrode is provided. Alternatively, the active matrix substrate of the present invention can be arranged such that the first and second capacitor electrodes are provided so that, if the first capacitor electrode (i) is moved in a direction parallel to a longitudinal direction of the gap and (ii) is axisymmetrically moved with respect to an axis which extends along a center line of the gap which center line extends in the longitudinal direction, the first capacitor electrode is substantially located in a place where the second capacitor electrode is provided.

The active matrix substrate of the present invention can be arranged such that the conductive electrode of the transistor is connected with the first pixel electrode via a contact hole, and is connected with the first capacitor electrode via a wire for drawing out the first capacitor electrode.

The active matrix substrate of the present invention can be arranged such that the conductive electrode is connected with the first pixel electrode via a contact hole, and the first pixel electrode is connected with the first capacitor electrode via a contact hole.

The active matrix substrate of the present invention can be arranged such that the first pixel electrode and the second pixel electrode are arranged in a column direction which is perpendicular to a line direction in which the scanning signal line extends. The active matrix substrate of the present invention can be arranged such that the first pixel electrode and the second pixel electrode are arranged in a line direction in which the scanning signal line extends. The active matrix substrate of the present invention can be arranged such that the first pixel electrode surrounds and encloses the second pixel electrode. The active matrix substrate of the present invention can be arranged such that the second pixel electrode surrounds and encloses the first pixel electrode.

The active matrix substrate of the present invention can be arranged such that the transistor is closer to the first pixel electrode than to the second pixel electrode.

The active matrix substrate of the present invention can be arranged such that first and second pixel regions, adjacent to each other in the line direction, in each of which the first and second pixel electrodes are arranged in the column direction, and a first pixel electrode in the first pixel region is adjacent, in the line direction, to the second pixel electrode in the second pixel region. The active matrix substrate of the present invention can be arranged such that first and second pixel regions, adjacent to each other in the column direction, in each of which the first and second pixel electrodes are arranged in the line direction, and a first pixel electrode in the first pixel region is adjacent, in the column direction, to the second pixel electrode in the second pixel region.

The active matrix substrate of the present invention can further include a retention capacitor wire, (i) the retention capacitor wire and the first pixel electrode or an electric conductor being electrically connected with the first pixel electrode forming a capacitor, and (ii) the retention capacitor wire and the second pixel electrode or an electric conductor being electrically connected with the second pixel electrode forming a capacitor. In this case, the active matrix substrate of the present invention can be arranged such that the retention capacitor wire extends so as to cross a center of the pixel region in a direction in which the scanning signal line extends. Alternatively, the active matrix substrate of the present invention can be arranged such that each of the first capacitor electrode and the second capacitor electrode and the retention capacitor wire form a capacitor.

The active matrix substrate of the present invention can be arranged such that the interlayer insulating film includes an inorganic insulating film and an organic insulating film which is thicker than the inorganic insulating film; and no organic insulating film is provided in (i) at least a part of a portion of the interlayer insulating film in which portion the interlayer insulating film, the first capacitor electrode, and the second pixel electrode overlap one another and (ii) at least a part of a portion of the interlayer insulating film in which portion the interlayer insulating film, the second capacitor electrode, and the first pixel electrode overlap one another.

The active matrix substrate of the present invention can be arranged such that the gap between the first pixel electrode and the second pixel electrode serves as an alignment-controlling structure.

The active matrix substrate of the present invention can be arranged such that each of an outer periphery of the first pixel electrode and an outer periphery of the second pixel electrode includes a plurality of sides; one of the plurality of sides of the first pixel electrode is adjacent to one of the plurality of sides of the second pixel electrode; each of the first capacitor electrode and the second capacitor electrode, the first pixel electrode, the second pixel electrode, and a gap between the one of the plurality of sides of the first pixel electrode and the one of the plurality of sides of the second pixel electrode are provided so as to overlap one another; and the retention capacitor wire has an opening so that the opening, the gap, and the first capacitor electrode overlap one another.

The active matrix substrate of the present invention can be arranged such that the first pixel electrode surrounds and encloses the second pixel electrode; an outer periphery of the second pixel electrode includes two parallel sides; an outer periphery of the first pixel electrode includes a side facing, via a first gap, one of the two parallel sides, and a side facing the other of the two parallel sides via a second gap; the first capacitor electrode is provided so that the first capacitor electrode, the first pixel electrode, the first gap, and the second pixel electrode overlap one another; and the second capacitor electrode is provided so that the second capacitor electrode, the second pixel electrode, the second gap, and the first pixel electrode overlap one another.

A method of the present invention for manufacturing an active matrix substrate is a method for manufacturing an active matrix substrate which comprises a scanning signal line, a data signal line, a transistor being connected with the scanning signal line and the data signal line, a first pixel electrode, and a second pixel electrode, the first pixel electrode and the second pixel electrode being provided in a single pixel region, said method including: forming (i) a first capacitor electrode electrically connected with the first pixel electrode and a conductive electrode of the transistor and (ii) a second capacitor electrode electrically connected with the second pixel electrode, the first capacitor electrode and the second pixel electrode forming a capacitor, and the second capacitor electrode and the first pixel electrode forming a capacitor; detecting at least one of (i) short-circuiting of the first capacitor electrode and the second pixel electrode and (ii) short-circuiting of the second capacitor electrode and the first pixel electrode; cutting the first capacitor electrode between a part where the short-circuiting occurred and a part where the first capacitor electrode and the first pixel electrode are connected with each other, in a case where the short-circuiting of the first capacitor electrode and the second pixel electrode is detected; and cutting the second capacitor electrode between a part where the short-circuiting occurred and a part where the second capacitor electrode and the second pixel electrode are connected with each other, in a case where the short-circuiting of the second capacitor electrode and the first pixel electrode is detected.

A method of the present invention for manufacturing an active matrix substrate is a method for manufacturing an active matrix substrate which comprises a scanning signal line, a data signal line, a retention capacitor wire, a transistor being connected with the scanning signal line and the data signal line, a first pixel electrode, and a second pixel electrode, the first pixel electrode and the second pixel electrode being provided in a single pixel region, said method including: forming (i) a first capacitor electrode electrically connected with the first pixel electrode and a conductive electrode of the transistor and (ii) a second capacitor electrode electrically connected with the second pixel electrode, the first capacitor electrode and the second pixel electrode forming a capacitor, the first capacitor electrode and the retention capacitor wire forming a capacitor, the second capacitor electrode and the first pixel electrode forming a capacitor, and the second capacitor electrode and the retention capacitor wire forming a capacitor; detecting at least one of (i) short-circuiting of the first capacitor electrode and the second pixel electrode, (ii) short-circuiting of the second capacitor electrode and the first pixel electrode, (iii) short-circuiting of the first capacitor electrode and the retention capacitor wire, and (iv) short-circuiting of the second capacitor electrode and the retention capacitor wire; cutting the first capacitor electrode between a part where the short-circuiting occurred and a part where the first capacitor electrode and the first pixel electrode are connected with each other, in a case where the short-circuiting of the first capacitor electrode and the second pixel electrode is detected or the short-circuiting of the first capacitor electrode and the retention capacitor wire; and cutting the second capacitor electrode between a part where the short-circuiting occurred and a part where the second capacitor electrode and the second pixel electrode are connected with each other, in a case where the short-circuiting of the second capacitor electrode and the first pixel electrode is detected or the short-circuiting of the second capacitor electrode and the retention capacitor wire is detected.

A method of the present invention for manufacturing an active matrix substrate is a method for manufacturing a liquid crystal panel which comprises a scanning signal line, a data signal line, a transistor being connected with the scanning signal line and the data signal line, a first pixel electrode, and a second pixel electrode, the first pixel electrode and the second pixel electrode being provided in a single pixel, said method including: forming (i) a first capacitor electrode electrically connected with the first pixel electrode and a conductive electrode of the transistor and (ii) a second capacitor electrode electrically connected with the second pixel electrode, the first capacitor electrode and the second pixel electrode forming a capacitor, and the second capacitor electrode and the first pixel electrode forming a capacitor; detecting at least one of (i) short-circuiting of the first capacitor electrode and the second pixel electrode and (ii) short-circuiting of the second capacitor electrode and the first pixel electrode; cutting the first capacitor electrode between a part where the short-circuiting occurred and a part where the first capacitor electrode and the first pixel electrode are connected with each other, in a case where the short-circuiting of the first capacitor electrode and the second pixel electrode is detected; and cutting the second capacitor electrode between a part where the short-circuiting occurred and a part where the second capacitor electrode and the second pixel electrode are connected with each other, in a case where the short-circuiting of the second capacitor electrode and the first pixel electrode is detected.

A method of the present invention for manufacturing an active matrix substrate is a method for manufacturing a liquid crystal panel which comprises a scanning signal line, a data signal line, a retention capacitor wire, a transistor being connected with the scanning signal line and the data signal line, a first pixel electrode, and a second pixel electrode, the first pixel electrode and the second pixel electrode being provided in a single pixel, said method including: forming (i) a first capacitor electrode electrically connected with the first pixel electrode and a conductive electrode of the transistor and (ii) a second capacitor electrode electrically connected with the second pixel electrode, the first capacitor electrode and the second pixel electrode forming a capacitor, the first capacitor electrode and the retention capacitor wire forming a capacitor, the second capacitor electrode and the first pixel electrode forming a capacitor, and the second capacitor electrode and the retention capacitor wire forming a capacitor; detecting at least one of (i) short-circuiting of the first capacitor electrode and the second pixel electrode, (ii) short-circuiting of the second capacitor electrode and the first pixel electrode, (iii) short-circuiting of the first capacitor electrode and the retention capacitor wire, and (iv) short-circuiting of the second capacitor electrode and the retention capacitor wire; cutting the first capacitor electrode between a part where the short-circuiting occurred and a part where the first capacitor electrode and the first pixel electrode are connected with each other, in a case where the short-circuiting of the first capacitor electrode and the second pixel electrode is detected or the short-circuiting of the first capacitor electrode and the retention capacitor wire; and cutting the second capacitor electrode between a part where the short-circuiting occurred and a part where the second capacitor electrode and the second pixel electrode are connected with each other, in a case where the short-circuiting of the second capacitor electrode and the first pixel electrode is detected or the short-circuiting of the second capacitor electrode and the retention capacitor wire is detected.

A liquid crystal panel of the present invention includes any one of the active matrix substrates. A liquid crystal display unit of the present invention includes the liquid crystal panel and a driver. A liquid crystal display apparatus of the present invention includes the liquid crystal display unit and a light source device. A television receiver of the present invention includes the liquid crystal display apparatus and a tuner section for receiving a television broadcast.

Thus, the present invention is such that the first pixel electrode and the second pixel electrode each provided in a single pixel region are connected with each other via two parallel capacitors (coupling capacitors) in an active matrix substrate of a pixel division method of a capacitive coupling type. Even if any one of the two parallel capacitors has a failure in a manufacturing step or the like, the arrangement makes it possible to maintain a state in which the first pixel electrode and the second pixel electrode each of which receives a signal potential from the data signal line are connected with each other via the other one of the two parallel capacitors. This makes it possible to improve a manufacturing yield of the active matrix substrate.

### BRIEF DESCRIPTION OF DRAWINGS

FIG. 1

FIG. 1 is a circuit diagram illustrating an arrangement of a liquid crystal panel of a first embodiment.

FIG. 2

FIG. 2 is a plan view illustrating one concrete example of the liquid crystal panel illustrated in FIG. 1.

FIG. 3

FIG. 3 is that fragmentary cross-sectional view corresponding to FIG. 2 which has been taken along a line between X and Y in FIG. 2.

FIG. 4

FIG. 4 is that fragmentary cross-sectional view of a modification of the example illustrated in FIG. 2 which has been taken along the line between X and Y in FIG. 2.

FIG. 5

FIG. 5 is a timing chart showing a driving method of a liquid crystal display apparatus including the liquid crystal panel illustrated in FIG. 1.

FIG. 6

(a) and (b) of FIG. 6 are explanatory views illustrating respective two display states of two frames which two display states are realized by the driving method shown in FIG. 5.

FIG. 7

FIG. 7 is a plan view illustrating a correction method for the liquid crystal panel illustrated in FIG. 2.

FIG. 8

FIG. 8 is a plan view illustrating another concrete example of the liquid crystal panel illustrated in FIG. 1.

FIG. 9

FIG. 9 is a plan view illustrating another concrete example of the liquid crystal panel illustrated in FIG. 1.

FIG. 10

FIG. 10 is a plan view illustrating another concrete example of the liquid crystal panel illustrated in FIG. 1.

FIG. 11

FIG. 11 is a circuit diagram illustrating another arrangement of the liquid crystal panel of the first embodiment.

FIG. 12

FIG. 12 is a plan view illustrating a concrete example of the liquid crystal panel illustrated in FIG. 11.

FIG. 13

FIG. 13 is a circuit diagram illustrating another arrangement of the liquid crystal panel of the first embodiment.

FIG. 14

(a) and (b) of FIG. 14 are explanatory views illustrating respective two display states of two frames which two display states are realized in a case where the driving method shown in FIG. 5 is used in a liquid crystal display apparatus including the liquid crystal panel illustrated in FIG. 13.

FIG. 15 is a plan view illustrating a concrete example of the liquid crystal panel illustrated in FIG. 13.

FIG. 16 is a circuit diagram illustrating an arrangement of a liquid crystal panel of a second embodiment.

FIG. 17

(a) and (b) of FIG. 17 are explanatory views illustrating respective two display states of two frames which two display states are realized in a case where the driving method shown in FIG. 5 is used in a liquid crystal display apparatus including the liquid crystal panel illustrated in FIG. 16.

FIG. 18

FIG. 18 is a plan view illustrating a concrete example of the liquid crystal panel illustrated in FIG. 16.

FIG. 19

FIG. 19 is a plan view illustrating another concrete example of the liquid crystal panel illustrated in FIG. 16.

FIG. 20

FIG. 20 is a plan view illustrating a correction method for the liquid crystal panel illustrated in FIG. 19.

FIG. 21

FIG. 21 is a circuit diagram illustrating another arrangement of the liquid crystal panel of the second embodiment.

FIG. 22

(a) and (b) of FIG. 22 are explanatory views illustrating respective two display states of two frames which two display states are realized in a case where the driving method shown in FIG. 5 is used in a liquid crystal display apparatus including the liquid crystal panel illustrated in FIG. 21.

FIG. 23

FIG. 23 is a plan view illustrating a concrete example of the liquid crystal panel illustrated in FIG. 21.

FIG. 24

FIG. 24 is a circuit diagram illustrating an arrangement of a liquid crystal panel of a third embodiment.

FIG. 25

FIG. 25 is a plan view illustrating a concrete example of the liquid crystal panel illustrated in FIG. 24.

FIG. 26

FIG. 26 is a plan view illustrating another concrete example of the liquid crystal panel illustrated in FIG. 24.

FIG. 27

FIG. 27 is a plan view illustrating another concrete example of the liquid crystal panel illustrated in FIG. 24.

FIG. 28

FIG. 28 is a plan view illustrating another concrete example of the liquid crystal panel illustrated in FIG. 24.

FIG. 29

FIG. 29 is a plan view illustrating another concrete example of the liquid crystal panel illustrated in FIG. 24.

FIG. 30

FIG. 30 is a plan view illustrating another concrete example of the liquid crystal panel illustrated in FIG. 24.

FIG. 31

FIG. 31 is a circuit diagram illustrating another arrangement of the liquid crystal panel of the third embodiment.

FIG. 32

FIG. 32 is a plan view illustrating a concrete example of the liquid crystal panel illustrated in FIG. 31.

FIG. 33

FIG. 33 is a plan view illustrating a concrete example of the liquid crystal panel illustrated in FIG. 1.

FIG. 34

FIG. 34 is a plan view illustrating a modification of the liquid crystal panel illustrated in FIG. 2.

FIG. 35

(a) of FIG. 35 is a schematic view illustrating an arrangement of a liquid crystal display unit of the present invention. (b) of FIG. 35 is a schematic view illustrating an arrangement of a liquid crystal display apparatus of the present invention.

FIG. 36

FIG. 36 is a block diagram illustrating an overall arrangement of the liquid crystal display apparatus.

FIG. 37

FIG. 37 is a block diagram explaining functions of the liquid crystal display apparatus.

FIG. 38

FIG. 38 is a block diagram explaining functions of a television receiver of the present invention.

FIG. 39

FIG. 39 is an exploded perspective view illustrating an arrangement of the television receiver.

FIG. 40

FIG. 40 is a plan view illustrating a correction method for the liquid crystal panel illustrated in FIG. 8.

FIG. 41

FIG. 41 is a plan view illustrating an arrangement of a conventional liquid crystal panel.

### REFERENCE SIGNS LIST

101 through 104 Pixel
12a, 12c, and 12A Transistor
15x and 15y Data signal line
16x and 16y Scanning signal line
17a, 17b, 17c, 17d, 17A, and 17B Pixel electrode
18p and 18q Retention capacitor line
22 Inorganic gate insulating film
25 Inorganic interlayer insulating film
26 Organic interlayer insulating film
37a, 37b, 37A, 37B, 37c, and 37d Capacitor electrode
84 Liquid crystal display unit
800 Liquid crystal display apparatus

### DESCRIPTION OF EMBODIMENTS

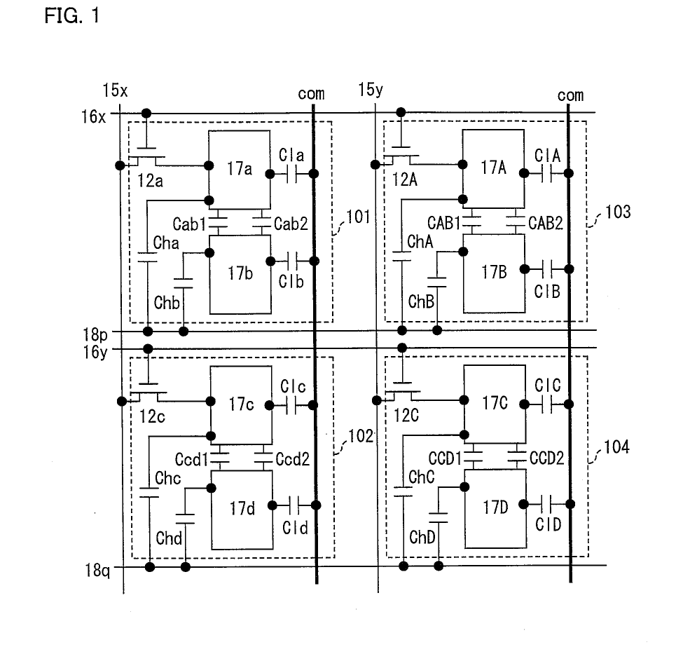

The following describes examples of embodiments of the present invention, with reference to FIGS. 1 through 39. In the following description, for convenience, a direction in which scanning signal lines extend is described as a line direction. Needless to say, whether the scanning signal lines extend in a lateral direction or in a longitudinal direction will not cause any problem while a liquid crystal display apparatus including a liquid crystal panel of the present invention (or an active matrix substrate provided in the liquid crystal panel) is in used (watched). In the following description, the description of an alignment-controlling structure provided in the liquid crystal panel is omitted as appropriate.

### First Embodiment

FIG. 1 is an equivalent circuit diagram illustrating a part of a liquid crystal panel of a first embodiment. As illustrated in FIG. 1, the liquid crystal panel includes: data signal lines (15x and 15y) which extend in the column direction (i.e., in a longitudinal direction in FIG. 1); scanning signal lines (16x and 16y) which extend in the line direction (i.e., in a transverse direction in FIG. 1); pixels (101 through 104) which are arranged in the line and column directions; retention capacitor wires (18p and 18q); and a common electrode (counter electrode) com. The pixels have an identical arrangement. A column of pixels which contains the pixels 101 and 102 is adjacent to a column of pixels which contains the pixels 103 and 104. A line of pixels which contains the pixels 101 and 103 is adjacent to a line of pixels which contains the pixels 102 and 104.

In the liquid crystal panel, one data signal line and one scanning signal line are provided for a corresponding one pixel. Two pixel electrodes are provided in one pixel so as to be arranged in the column direction. Specifically, two pixel electrodes 17a and 17b provided in the pixel 101 are arranged in the column direction, and two pixel electrodes 17c and 17d provided in the pixel 102 are arranged in the column direction. Two pixel electrodes 17A and 17B provided in the pixel 103 are arranged in the column direction, and two pixel electrodes 17C and 17D provided in the pixel 104 are arranged in the column direction. The pixel electrodes 17a, 17b, 17c, and 17d are adjacent to the pixel electrodes 17A, 17B, 17C, and 17D in the line direction, respectively.

The pixel 101 is arranged as below. The pixel electrodes 17a and 17b are connected with each other via coupling capacitors Cab1 and Cab2 which are formed in parallel to each other. The pixel electrode 17a is connected with the data signal line 15x via a transistor 12a, and is connected with the scanning signal line 16x via the transistor 12a. A retention capacitor Cha is formed between the pixel electrode 17a and the retention capacitor wire 18p. A retention capacitor Chb is formed between the pixel electrode 17b and the retention capacitor wire 18p. A liquid crystal capacitor C1a is formed between the pixel electrode 17a and the common electrode com. A liquid crystal capacitor C1b is formed between the pixel electrode 17b and the common electrode com.

The pixel 102 which is adjacent in the column direction to the pixel 101 is arranged as below. The pixel electrodes 17c and 17d are connected with each other via coupling capacitors Ccd1 and Ccd2 which are formed in parallel to each other. The pixel electrode 17c is connected with the data signal line 15x via a transistor 12c, and is connected with the scanning signal line 16y via the transistor 12c. A retention capacitor Chc is formed between the pixel electrode 17c and the retention capacitor wire 18q. A retention capacitor Chd is formed between the pixel electrode 17d and the retention capacitor wire 18q. A liquid crystal capacitor C1c is formed between the pixel electrode 17c and the common electrode com. A liquid crystal capacitor C1d is formed between the pixel electrode 17d and the common electrode com.

The pixel 103 which is adjacent in the line direction to the pixel 101 is arranged as below. The pixel electrodes 17A and 17B are connected with each other via coupling capacitors CAB1 and CAB2 which are formed in parallel to each other. The pixel electrode 17A is connected with the data signal line 15y via a transistor 12A, and is connected with the scanning signal line 16x via the transistor 12A. A retention capacitor ChA is formed between the pixel electrode 17A and the retention capacitor wire 18p. A retention capacitor ChB is formed between the pixel electrode 17B and the retention capacitor wire 18p. A liquid crystal capacitor C1A is formed between the pixel electrode 17A and the common electrode com. A liquid crystal capacitor C1B is formed between the pixel electrode 17B and the common electrode com.

A liquid crystal display apparatus including the liquid crystal panel carries out sequential scanning. That is, the scanning signal lines 16x and 16y are sequentially selected. The pixel electrode 17a is connected with the data signal line 15x (via the transistor 12a), and the pixel electrodes 17a and 17b are capacitively coupled with each other via the coupling capacitors Cab1 and Cab2. Therefore, in a case where, e.g., the scanning signal line 16x is selected, Vb=Va×[(C1+C2)/(C1+Ch+C1+C2)] is satisfied where: C1=capacitance value of C1a=capacitance value of C1b; Ch=capacitance value of Cha=capacitance value of Chb; C1=capacitance value of Cab1; C2=capacitance value of Cab2; Va=electric potential that the pixel electrode 17a has when the transistor 12a is OFF; and Vb=electric potential that the pixel electrode 17b has when the transistor 12a is OFF. That is, |Va|≧|Vb| is satisfied (Note that |Va| for example, indicates a potential difference between Va and an electric potential of the common electrode com=Vcom). Therefore, in a case where a halftone is displayed, a subpixel containing the pixel electrode 17a and a subpixel containing the pixel electrode 17b can be used as a bright subpixel and a dark subpixel, respectively. As a result, the halftone can be displayed by area coverage modulation of the bright subpixel and the dark subpixel. This makes it possible to improve a viewing angle characteristic of the liquid crystal display apparatus.

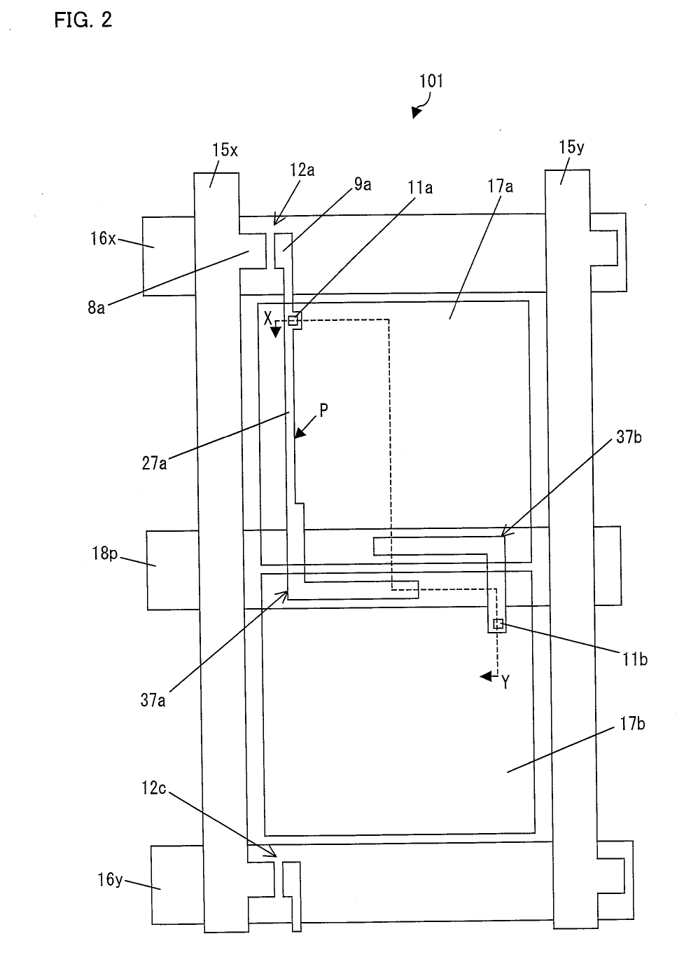

FIG. 2 illustrates a concrete example of the pixel 101 illustrated in FIG. 1. As illustrated in FIG. 2, the transistor 12a is provided in the vicinity of an intersection of the data signal line 15x and the scanning signal line 16x. In a pixel region defined by the data signal line 15x and the scanning signal line 16x, the pixel electrodes 17a and 17b each having a rectangular shape are arranged in the column direction. One of four sides constituting an outer periphery of a first pixel electrode (i.e., pixel electrode 17a) is adjacent to one of four sides constituting an outer periphery of a second pixel electrode (i.e., pixel electrode 17b). Each of capacitor electrodes 37a and 37b is provided so as to overlap the pixel electrodes 17a and 17b, and a gap between the one of the four sides constituting the outer periphery of the first pixel electrode and the one of the four sides constituting the outer periphery of the second pixel electrode (i.e., gap between the pixel electrodes 17a and 17b). The retention capacitor wire 18p which extends in the line direction is provided so as to overlap whole of the gap.

More specifically, the capacitor electrode 37a has a shape like “L,” and includes a first part which extends in the column direction along the data signal line 15x and a second part which extends in the line direction from one end of the first part. The first part and each of the pixel electrode 17a, the gap (gap between the pixel electrodes 17a and 17b), and the pixel electrode 17b overlap each other. On the other hand, the second part and the pixel electrode 17b overlap each other. If the capacitor electrode 37a is rotated by 180° around a point of the gap (e.g., center point of the gap), the capacitor electrode 37a is substantially located in a place where the capacitor electrode 37b is provided. The capacitor electrode 37b includes a first part which extends in the column direction along the data signal line 15y and a second part which extends in the line direction from one end of the first part. The first part and the pixel electrode 17b overlap each other, the gap, and the pixel electrode 17a. On the other hand, the second part and the pixel electrode 17a overlap each other.

A source electrode 8a and a drain electrode 9a of the transistor 12a are formed on the scanning signal line 16x. The source electrode 8a is connected with the data signal line 15x. The drain electrode 9a is connected with a drain drawing wire 27a. The drain drawing wire 27a is connected with the first part of the capacitor electrode 37a. The drain drawing wire 27a and the capacitor electrode 37a are formed in a same layer. The drain drawing wire 27a is also connected with the pixel electrode 17a via a contact hole 11a. As described above, the second part of the capacitor electrode 37a and the pixel electrode 17b overlap each other via an interlayer insulating film. The coupling capacitor Cab1 (see FIG. 1) between the pixel electrodes 17a and 17b is formed in an area where the second part and the pixel electrode 17b overlap each other. The first part of the capacitor electrode 37b is connected with the pixel electrode 17b via the contact hole 11b. As described above, the second part of the capacitor electrode 37b and the pixel electrode 17a overlap each other via the interlayer insulating film. The coupling capacitor Cab2 (see FIG. 1) between the pixel electrodes 17a and 17b is formed in an area where the second part and the pixel electrode 17a overlap each other. Further, the capacitor electrode 37a and the retention capacitor wire 18p overlap each other via a gate insulating film. Much of the retention capacitor Cha (see FIG. 1) is formed in an area where the capacitor electrode 37a and the retention capacitor wire 18p overlap each other. Further, the capacitor electrode 37b and the retention capacitor wire 18p overlap each other via the gate insulating film. Much of the retention capacitor Chb is formed in an area where the capacitor electrode 37b and the retention capacitor wire 18p overlap each other.

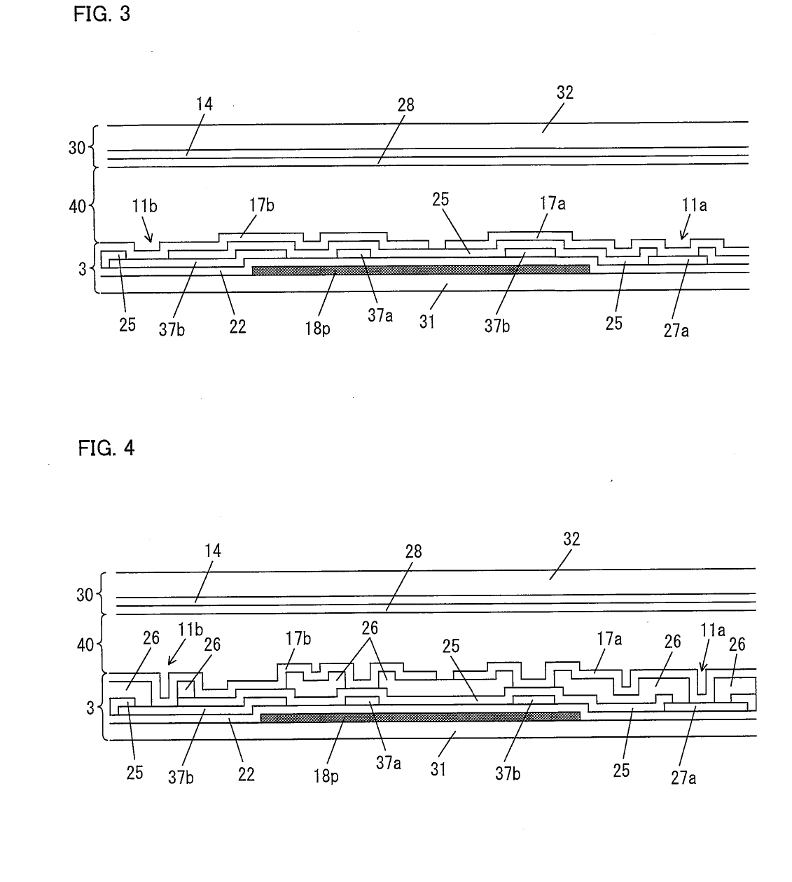

FIG. 3 is a fragmentary cross-sectional view taken along a line between X and Y in FIG. 2. As illustrated in FIG. 3, the liquid crystal panel includes an active matrix substrate 3, a color filter substrate 30 which faces the active matrix substrate 3, and a liquid crystal layer 40 provided between the active matrix substrate 3 and the color filter substrate 30.

In the active matrix substrate 3, the retention capacitor wire 18p is formed on a glass substrate 31. An inorganic gate insulating film 22 is formed so as to cover the glass substrate 31 and the retention capacitor wire 18p. Scanning signal lines (not illustrated) are also formed on the glass substrate 31. Members such as a semiconductor layer (i layer and n+ layer; not illustrated), the source electrode and the drain electrode (not illustrated) which have contact with the n+ layer, the drain drawing wire 27a, and the capacitor electrodes 37a and 37b are formed on the inorganic gate insulating film 22. Further, an inorganic interlayer insulating film 25 is formed so as to cover those thus formed on the inorganic gate insulating film 22. The pixel electrodes 17a and 17b are formed on the inorganic interlayer insulating film 25. Further, an alignment film (not illustrated) is formed so as to cover the pixel electrodes 17a and 17b. In the contact hole 11a, the inorganic interlayer insulating film 25 is hollowed so that the pixel electrode 17a is connected with the drain drawing wire 27a. Similarly, in the contact hole 11b, the inorganic interlayer insulating film 25 is hollowed so that the pixel electrode 17b is connected with the capacitor electrode 37b. The capacitor electrode 37a connected with the drain drawing wire 27a in a same layer and the pixel electrode 17b overlap each other via the inorganic interlayer insulating film 25. As a result, the coupling capacitor Cab1 (see FIG. 1) is formed. The capacitor electrode 37b and the pixel electrode 17a overlap each other via the inorganic interlayer insulating film 25. As a result, the coupling capacitor Cab2 (see FIG. 1) is formed. The capacitor electrode 37a and the retention capacitor wire 18p overlap each other via the inorganic gate insulating film 22. As a result, the retention capacitor Cha (see FIG. 1) is formed. The capacitor electrode 37b and the retention capacitor wire 18p overlap each other via the inorganic gate insulating film 22. As a result, the retention capacitor Chb (see FIG. 1) is formed.

In the color filter substrate 30, a colored layer 14 is formed on a glass substrate 32. A common electrode (com) 28 is formed on the colored layer 14. Further, an alignment film (not illustrated) is formed so as to cover the common electrode 28.

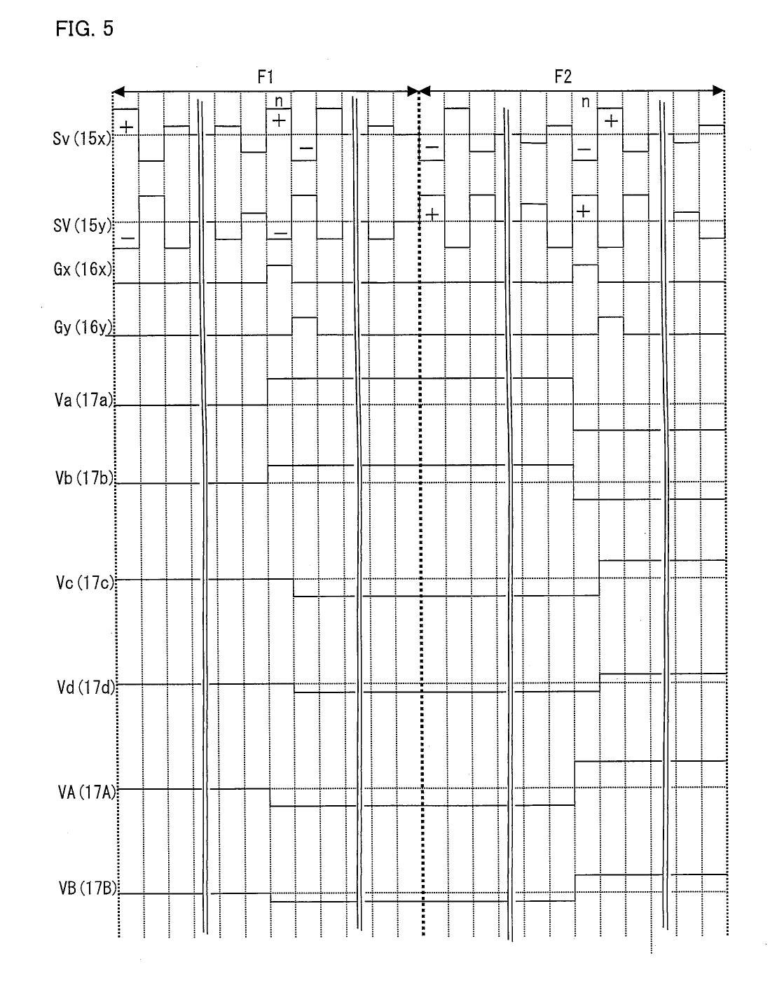

FIG. 5 is a timing chart showing a driving method of the liquid crystal display apparatus (liquid crystal display apparatus of a normally black type) including the liquid crystal panel illustrated in FIGS. 1 and 2. In FIG. 5, Sv and SV indicate signal potentials to be supplied respectively to the data signal lines 15x and 15y which are two adjacent data signal lines; Gx and Gy indicate gate ON pulse signals to be supplied respectively to the scanning signal lines 16x and 16y; and Va, Vb, VA, VB, Vc, and Vd indicate electric potentials of the pixel electrodes 17a, 17b, 17A, 17B, 17c, and 17d, respectively.

According to the driving method, as shown in FIG. 5, the scanning signal lines 16x and 16y are sequentially selected one by one so that a polarity of a signal potential to be supplied to a corresponding data signal line is reversed every one horizontal scanning period (1H). In addition, a polarity of a signal potential to be supplied to a corresponding data signal line in an n-th horizontal scanning period is reversed every frame period. Further, signal potentials having respective polarities which are opposite are supplied to two adjacent data signal lines in one same horizontal scanning period, respectively.

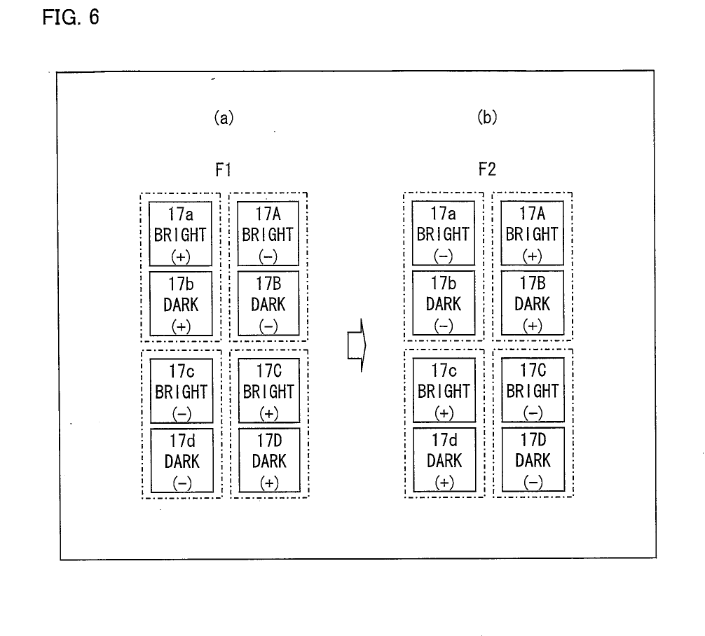

Specifically, in a frame F1 followed by a frame F2, scanning signal lines are sequentially selected one by one (e.g., the scanning signal lines 16x and 16y are sequentially selected one by one in this order). In an n-th horizontal scanning period (e.g., a period for writing in the pixel electrode 17a is included), a positive signal potential is supplied to one of the two adjacent data signal lines (e.g., to the data signal line 15x). In an (n+1)th horizontal scanning period (e.g., a period for writing in the pixel electrode 17c is included), a negative signal potential is supplied to the one of the two adjacent data signal lines. In the n-th horizontal scanning period (e.g., a period for writing in the pixel electrode 17A is included), a negative signal potential is supplied to the other of the two adjacent data signal lines (e.g., to the data signal line 15y). In the (n+1)th horizontal scanning period (e.g., a period for writing in the pixel electrode 17C is included), a positive signal potential is supplied to the other of the two adjacent data signal lines. It follows that |Va|≧|Vb|, |Vc|≧|Vd|, and |VA|≧|VB| are satisfied, as shown in FIG. 5. Accordingly, the subpixel containing the pixel electrode 17a (positive polarity) serves as a bright subpixel (hereinafter, simply referred to as “bright”); the subpixel containing the pixel electrode 17b (positive polarity) serves as a dark subpixel (hereinafter, simply referred to as “dark”); the subpixel containing the pixel electrode 17c (negative polarity) is “bright”; the subpixel containing the pixel electrode 17d (negative polarity) is “dark”; the subpixel containing the pixel electrode 17A (negative polarity) is “bright”; and the subpixel containing the pixel electrode 17B (negative polarity) is “dark.” FIG. 6(a) shows this as a whole.

In the frame F2, the scanning signal lines are sequentially selected one by one (e.g., the scanning signal lines 16x and 16y are sequentially selected one by one in this order). In an n-th horizontal scanning period (e.g., a period for writing in the pixel electrode 17a is included), a negative signal potential is supplied to one of the two adjacent data signal lines (e.g., to the data signal line 15x). In an (n+1)th horizontal scanning period (e.g., a period for writing in the pixel electrode 17c is included), a positive signal potential is supplied to the one of the two adjacent data signal lines. In the n-th horizontal scanning period (e.g., a period for writing in the pixel electrode 17A is included), a positive signal potential is supplied to the other of the two adjacent data signal lines (e.g., to the data signal line 15y). In the (n+1)th horizontal scanning period (e.g., a period for writing in the pixel electrode 17C is included), a negative signal potential is supplied to the other of the two adjacent data signal lines. It follows that |Va|≧|Vb|, |Vc|≧|Vd|, and |VA|≧|VB| are satisfied, as shown in FIG. 5. Accordingly, the subpixel containing the pixel electrode 17a (negative polarity) is “bright”; the subpixel containing the pixel electrode 17b (negative polarity) is “dark”; the subpixel containing the pixel electrode 17c (positive polarity) is “bright”; the subpixel containing the pixel electrode 17d (positive polarity) is “dark”; the subpixel containing the pixel electrode 17A (positive polarity) is “bright”; and the subpixel containing the pixel electrode 17B (positive polarity) is “dark.” FIG. 6(b) shows this as a whole.

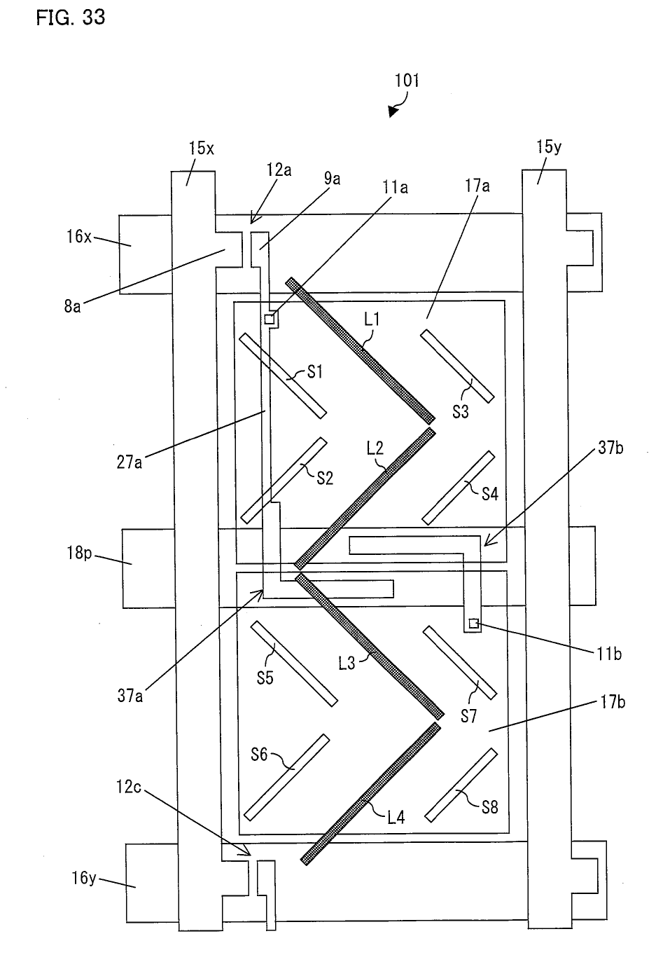

FIG. 2 omits to illustrate an alignment-controlling structure. However, in, e.g., a liquid crystal panel of an MVA (Multi-domain Vertical Alignment) method, slits S1 through S4 for alignment control are provided to the pixel electrode 17a, as illustrated in FIG. 33. In addition, ribs L1 and L2 for alignment control are provided to that area of the color filter substrate which positionally corresponds to the pixel electrode 17a. Further, slits S5 through S8 for alignment control are provided to the pixel electrode 17b, and ribs L3 and L4 for alignment control are provided to that area of the color filter substrate which positionally corresponds to the pixel electrode 17b. Instead of such ribs for alignment control, a slit for alignment control can be provided to the common electrode of the color filter substrate.

In the liquid crystal panel illustrated in FIG. 2, the pixel electrodes 17a and 17b are connected (capacitatively coupled) with each other via the two coupling capacitors (Cab1 and Cab2) which are provided in parallel to each other. Therefore, even if the drain drawing wire 27a is broken at P in FIG. 2 (in a manufacturing step or the like), it is possible to maintain a state in which the pixel electrodes 17a and 17b each of which receives a signal potential from the data signal line 15x are connected with each other via the coupling capacitors.

In a case where short-circuiting of the second part of the capacitor electrode 37a and the retention capacitor wire 18p or the pixel electrode 17b occurred (in a manufacturing step or the like), a correction step is carried out in which the drain drawing wire 27a is cut between the contact hole 11a and the capacitor electrode 37a, or the capacitor electrode 37a is cut by a laser between a part where the short-circuiting occurred and a part where the capacitor electrode 37a and the drain drawing wire 27a are connected with each other. This makes it possible to maintain a state in which the pixel electrodes 17a and 17b are connected with each other via the coupling capacitors.

In a case where short-circuiting of the second part of the capacitor electrode 37b and the retention capacitor wire 18p or the pixel electrode 17a occurred, the capacitor electrode 37b is cut by a laser between a part where the short-circuiting occurred and a part where the capacitor electrode 37b and the pixel electrode 17b are connected with each other.

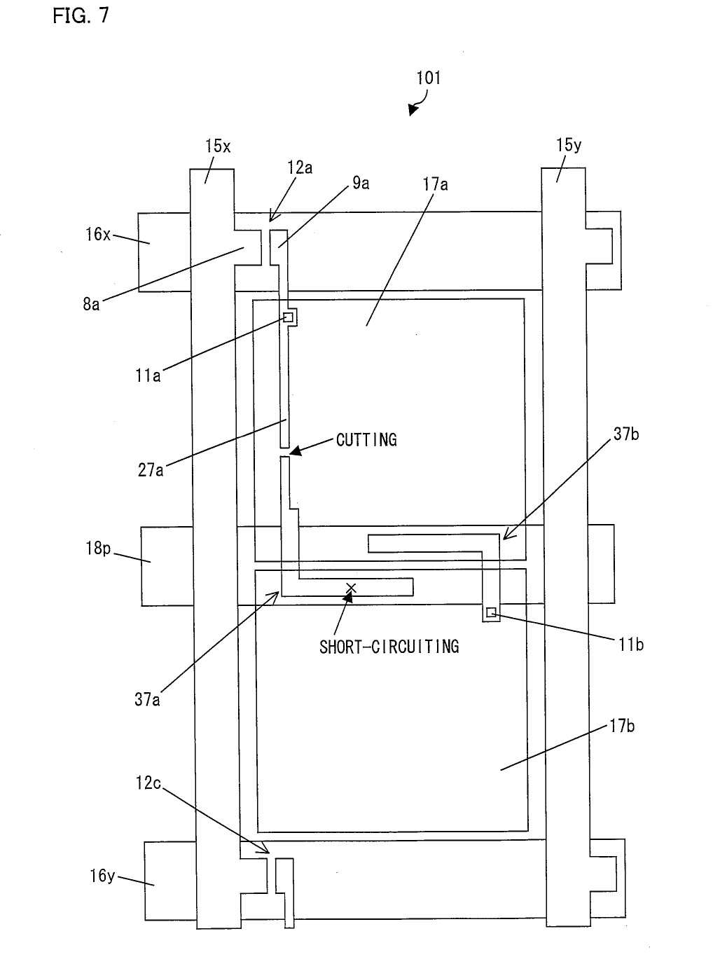

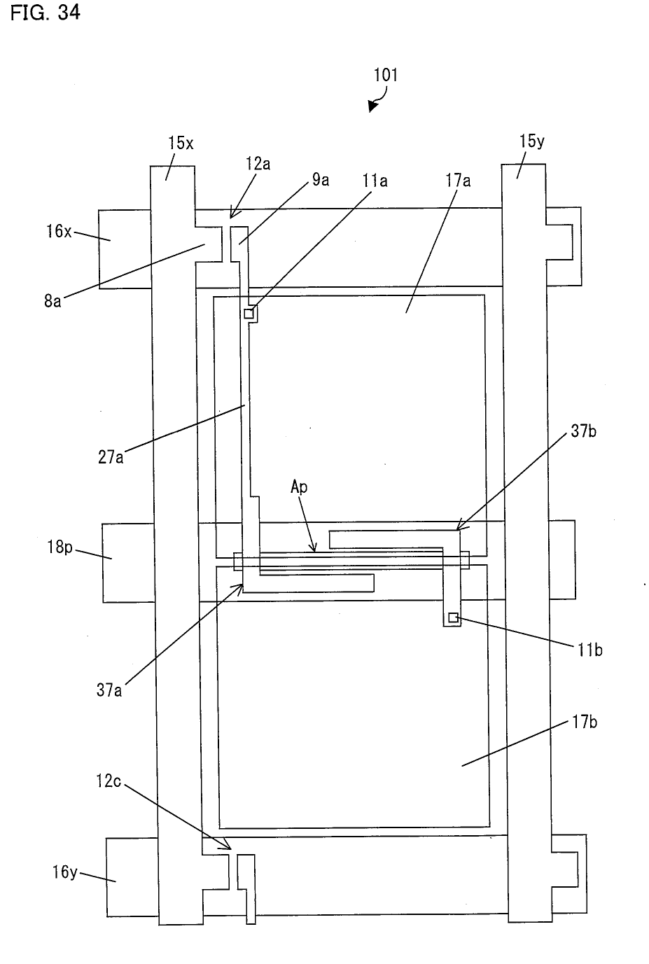

In a case where the correction step is carried out with respect to the active-matrix substrate 3, the drain drawing wire 27a (i.e., drain drawing wire 27a between the contact hole 11a and the capacitor electrode 37a) is irradiated with a laser from a back surface side of the active matrix substrate 3 (i.e., from a glass substrate 31 side) so as to be cut (see FIG. 7). Alternatively, the first part of the capacitor electrode 37a is irradiated with a laser from a top surface side of the active matrix substrate 3 (i.e., from a counter side to the glass substrate 31 side) via the gap between the pixel electrodes 17a and 17b so as to be cut. Such a technique by which the capacitor electrode 37a is irradiated with a laser from the top surface side of the active matrix substrate 3 so as to be cut has an advantage in that there is no need to reverse the active matrix substrate 3 in the correction step. On the other hand, there is concern that another short-circuiting of the capacitor electrode 37a and the retention capacitor wire 18p can occur. In order that the concern is eliminated, as illustrated in FIG. 34 for example, an aperture Ap is formed in the retention capacitor wire 18p so that the aperture Ap and the gap between the pixel electrodes 17a and 17b overlap each other. The technique by which the drain drawing wire 27a is irradiated with a laser from the back surface side of the active matrix substrate 3 so as to be cut also has a possibility of another short-circuiting of the drain drawing wire 27a and the pixel electrode 17a. However, the drain drawing wire 27a and the pixel electrode 17a are originally connected with each other via the contact hole 11a. Therefore, the short-circuiting cannot be a problem. In a case where the correction step is carried out with respect to the liquid crystal panel, the drain drawing wire 27a (i.e., drain drawing wire 27a between the contact hole 11a and the capacitor electrode 37a) is irradiated with a laser from a back surface side of the liquid crystal panel (i.e., from the glass substrate 31 side) so as to be cut.

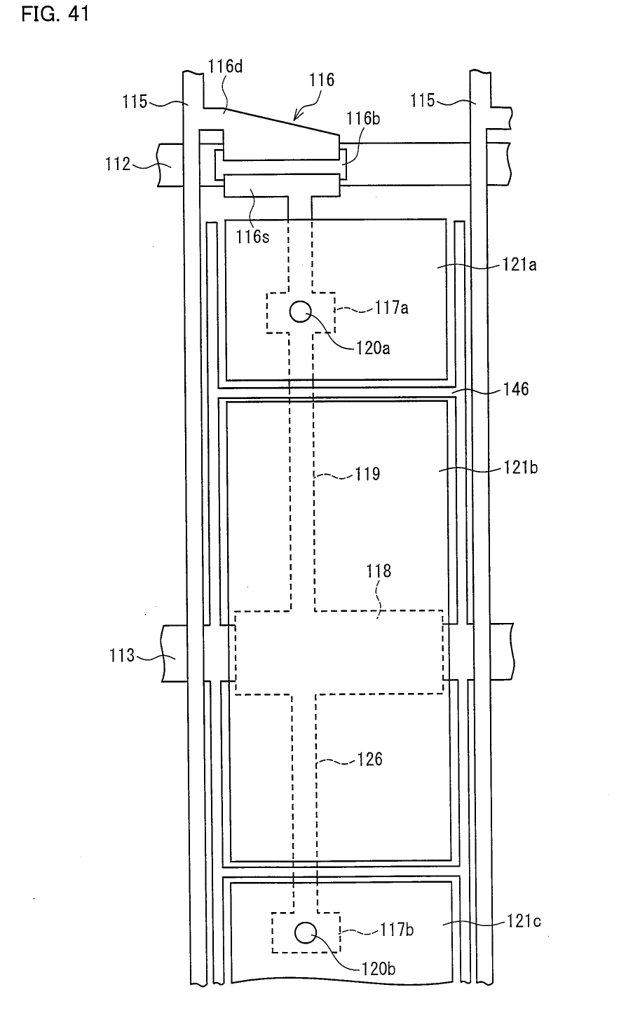

Thus, according to the present embodiment, it is possible to improve a manufacturing yield of a liquid crystal panel and an active-matrix substrate to be provided in the liquid crystal panel. In the case of the conventional active matrix substrate illustrated in FIG. 41, potential control of the pixel electrode 121b cannot be carried out if the drawing wire 119 is broken. In a case where short-circuiting of the control electrode 118 and the capacitor electrode 113 occurred, cutting the drawing wire 119 makes it possible to supply a signal potential to the pixel electrode 121a. However, the potential control of the pixel electrode 121b cannot be carried out.

The liquid crystal panel illustrated in FIG. 2 is arranged so that if the capacitor electrode 37a is rotated by 180° around a point of the gap between the pixel electrodes 17a and 17b, the capacitor electrode 37a is substantially located in a place where the capacitor electrode 37b is provided. Therefore, even if the pixel electrodes 17a and 17b become misaligned with respect to the capacitor electrodes 37a and 37b in a direction perpendicular to the gap (i.e., in the column direction), an area where the capacitor electrode 37a and the pixel electrode 17b overlap each other and an area where the capacitor electrode 37b and the pixel electrode 17a overlap each other complement each other. This is advantageous in that a total amount of the two coupling capacitors (Cab1 and Cab2) is unlikely to change.

Further, in the liquid crystal panel illustrated in FIG. 2, the capacitor electrode 37a and each of the pixel electrode 17b and the retention capacitor wire 18p overlap each other, and the capacitor electrode 37b and each of the pixel electrode 17a and the retention capacitor wire 18p overlap each other. Thus, the capacitor electrodes 37a and 37b provided for forming the coupling capacitors also serve as electrodes for forming retention capacitors. This makes it possible to increase an aperture ratio.

The following describes a method for manufacturing the liquid crystal panel. The method includes an active matrix substrate manufacturing step, a color filter substrate manufacturing step, and an assembly step of combining the active matrix substrate and the color filter substrate and then filling, with liquid crystal, a space between the active matrix substrate and the color filter substrate. Further, an inspection step is carried out while or after at least one of the active matrix substrate manufacturing step and the assembly step is carried out. If a defect of a pixel (or subpixel) is detected in the inspection step, a correction step for correcting the defect is additionally carried out.

The following describes the active matrix substrate manufacturing step.

First, a metal film made from any one of metals such as titanium, chrome, aluminum, molybdenum, tantalum, tungsten, and copper, an alloy film made from at least any two of the metals, or a laminated film (thickness from 1000 Å to 3000 Å) made from at least any two of the metals is formed, by sputtering, on a substrate made from a material such as glass and plastic. Then, patterning is carried out by photolithography (Photo Engraving Process; hereinafter, referred to as “PEP technique”) so that scanning signal lines, gate electrodes of transistors (in some cases, the scanning signal lines double as the gate electrodes), and retention capacitor wires are formed.

Then, a gate insulating film is formed on an entire substrate on which the scanning signal lines etc. are formed. Specifically, an inorganic insulating film (thickness from 3000 Å to 5000 Å) made from a material such as silicon nitride and silicon oxide is formed by CVD (Chemical Vapor Deposition).

Then, an intrinsic amorphous silicon film (thickness of 1000 Å to 3000 Å) and a phosphorus-doped n+ amorphous silicon film (thickness of 400 Å to 700 Å) are continuously formed by CVD on the gate insulating film (i.e., on the entire substrate). Then, patterning is carried out by the PEP technique so that a silicon laminated body including the intrinsic amorphous silicon layer and the n+ amorphous silicon layer is formed on each of gate electrodes in an island shape.

Then, a metal film made from any one of metals such as titanium, chrome, aluminum, molybdenum, tantalum, tungsten, and copper, an alloy film made from at least any two of the metals, or a laminated film (thickness from 1000 Å to 3000 Å) made from at least any two of the metals is formed, by sputtering, on the entire substrate on which the silicon laminated body is formed. Then, patterning is carried out by the PEP technique so that the data signal lines, the source electrodes and drain electrodes of the transistors, the drain electrodes, the drain drawing wires, and the capacitor electrodes are formed.

Further, channels of the transistors are formed. Specifically, the n+ amorphous silicon layer constituting the silicon laminated body is removed by etching in which the source electrode and the drain electrode are used as a mask. As described above, the amorphous silicon film can be formed as a semiconductor layer. Alternatively, a polysilicon film can be formed. Further, the amorphous silicon film and the polysilicon film can be subjected to a laser annealing process so that their crystallinity is improved. This increases a moving speed of an electron in the semiconductor layer. As a result, this makes it possible to improve a characteristic of the transistors (TFT).

Then, an inorganic interlayer insulating film is formed in such a manner that an inorganic insulating film (thickness from 2000 Å to 5000 Å) made from a material such as silicon nitride and silicon oxide is formed, by CVD, on the entire substrate on which the data signal lines etc. are formed.

Then, the interlayer insulating film is etched by the PEP technique so as to be removed. Thus, a contact hole is formed. Then, a transparent conductive film (thickness 1000 Å to 2000 Å) made from a material such as ITO (Indium Tin Oxide), IZO (Indium Zinc Oxide), zinc oxide, and tin oxide is formed, by sputtering, on the entire substrate on which the contact hole has been formed in the interlayer insulating film. Then, patterning is carried out by the PEP technique so that the pixel electrodes are formed.

Lastly, polyimide resin is printed on the entire substrate on which the pixel electrodes are formed. As a result, the polyimide resin has a thickness from 500 Å to 1000 Å. Then, the substrate is subjected to a calcination process. Then, the substrate is subjected to a unidirectional rubbing process by use of a rotating cloth. Thus, an alignment film is formed. The active matrix substrate is thus manufactured.

The following describes the color filter substrate manufacturing step.

First, a chrome thin film or a resin film containing a back pigment is formed on a substrate (on an entire substrate) made from a material such as glass and plastic. Then, patterning is carried out by the PEP technique so that black matrixes are formed. Then, a pattern of a color filter layer (thickness of approximately 2 μm) of red, green, and blue is formed in gaps among the black matrixes by a pigment dispersion method or the like.

Then, the common electrode (com) is formed in such a manner that a transparent conductive film (thickness of approximately 1000 Å) made from a material such as ITO, IZO, zinc oxide, and tin oxide is formed on the entire substrate on which the color filter is formed.

Lastly, polyimide resin is printed on the entire substrate on which the pixel electrode has been formed. As a result, the polyimide resin has a thickness from 500 Å to 1000 Å. Then, the substrate is subjected to a calcination process. Then, the substrate is subjected to a unidirectional rubbing process by use of a rotating cloth. Thus, an alignment film is formed. The color filter substrate is thus manufactured.

The following describes the assembly step.

First, a sealing material made from a material such as thermosetting epoxy resin is applied, by screen printing, to one of the active matrix substrate and the color filter substrate so as to have a pattern of a frame lacking its part corresponding to a liquid crystal filling opening. On the other hand, spherical spacers which are made from plastic or silica and which have a diameter corresponding to a thickness of the liquid crystal layer are dispersed on the other of the active matrix substrate and the color filter substrate.

Then, the active matrix substrate and the color filter substrate are combined. Then, the sealing material is cured.

Lastly, a space enclosed by the active matrix substrate, the color filter substrate, and the sealing material is filled with a liquid crystal material by an evacuation method. Then, UV cure resin is applied to the liquid crystal filling opening. The UV cure resin is irradiated with UV so that the liquid crystal material is sealed in the space. The liquid crystal layer is thus formed. The liquid crystal panel is thus manufactured.

The following describes a first inspection step to be carried out in the active matrix substrate manufacturing step (e.g., after the pixel electrodes are formed and before the alignment film is formed), or after the active matrix substrate manufacturing step is carried out. In the first inspection step, the active matrix substrate is subjected to visual inspection, electro-optical inspection, etc. so that a part where short-circuiting occurred (short-circuiting section) is detected. Short-circuits encompass, e.g., short-circuiting of a capacitor electrode and a retention capacitor wire, and short-circuiting of a capacitor electrode and a pixel electrode. In the visual inspection, a wiring pattern is optically inspected by use of a CCD camera or the like. In the electro-optical inspection, first, a modulator (electro-optical element) is placed so as to face the active matrix substrate. Then, a voltage is applied between the active matrix substrate and the modulator. In addition, light is emitted between the active matrix substrate and the modulator. The CCD camera captures a change in luminance of the light so that the wiring pattern is electro-optically inspected.

If a part where short-circuiting occurred is detected, the correction step is carried out in which a capacitor electrode involved in the short-circuiting or an electric conductor (e.g., drain drawing wire) connected with the capacitor electrode is cut by a laser. In this laser cutting, a fourth harmonic (wavelength of 266 nm) of a YAG (Yttrium Aluminum Garnet) laser is used, for example. This makes it possible to improve accuracy of the laser cutting. In a case where a part where short-circuiting occurred is detected, a correction step can be carried out in some cases, in such a manner that a part in a contact hole of a pixel electrode connected with a short-circuited capacitor electrode via the contact hole is removed (trimmed) by a laser or the like. In the correction step to be carried out after the first inspection step is carried out, it is usually possible to emit a laser from a top surface side of an active matrix substrate (i.e., from a pixel electrodes side) or from a back surface side of the active matrix substrate (i.e., from a glass substrate side).

Other than a timing after the pixel electrodes are formed, the first inspection step and the correction step can be carried out after the capacitor electrodes are formed, or after the channels of the transistors are formed. This makes it possible to correct a defect at an earlier stage in a manufacturing step. As a result, this makes it possible to improve a manufacturing yield of the active matrix substrate.

The following describes a second inspection step to be carried out after the assembly step is carried out. In the second inspection step, a lighting inspection of the liquid crystal panel is carried out so that a part where short-circuiting occurred is detected. Short-circuiting encompasses, e.g., short-circuiting of a capacitor electrode and a retention capacitor wire, and short-circuiting of a capacitor electrode and a pixel electrode. Specifically, for example, a gate inspection signal which is a pulse voltage of +15V, having: a bias voltage of −10V; a cycle of 16.7 msec; and a pulse width of 50 μsec, is inputted in each of the scanning signal lines so that all TFTs have an ON state. In addition, a source inspection signal is inputted in each of the data signal lines. The source inspection signal has an electric potential of ±2V which is reversed in polarity every 16.7 msec. Thus, a signal potential corresponding to the electric potential of ±2V is supplied to each of the pixel electrodes via a source electrode and a drain electrode of a corresponding one of the TFTs. Simultaneously, a common electrode inspection signal which is a DC potential of −1V is supplied to the common electrode (com) and each of the retention capacitor wires. Accordingly, a voltage is applied to a liquid crystal capacitor formed between each of the pixel electrodes and the common electrode, and to a retention capacitor formed between each of the retention capacitor wires and a corresponding one of the capacitor electrodes. As a result, subpixels which are realized respectively by the pixel electrodes have a lighted state. In a part where short-circuiting occurred, a pixel electrode and a corresponding retention capacitor wire are electrically continuous with each other. This results in a black point (i.e., normally black). The part where the short-circuiting occurred is thus detected.

If a part where short-circuiting occurred is detected, the correction step is carried out in which a capacitor electrode involved in the short-circuiting or an electric conductor (e.g., drain drawing wire) connected with the capacitor electrode is cut by a laser. In the correction step to be carried out after the second inspection step is carried out, a laser is usually emitted from the back surface side of the active matrix substrate (i.e., from the glass substrate side of the active matrix substrate).

On the inorganic interlayer insulating film 25 illustrated in FIG. 3, an organic interlayer insulating film thicker than the inorganic interlayer insulating film 25 can be provided so that a channel protection film (interlayer insulating film) has a bilayer structure as illustrated in FIG. 4. This realizes effects such as a reduction in various parasitic capacitances, prevention of short-circuiting, and a reduction in ripping etc. of a pixel electrode due to planarization. In this case, as illustrated in FIG. 4, it is preferable to hollow those parts of the organic interlayer insulating film 26 which overlap the capacitor electrodes 37a and 37b. This makes it possible to realize the effects, with securing a sufficient capacitance of each of the coupling capacitors.

The inorganic interlayer insulating film 25, the organic interlayer insulating film 26, and the contact holes 11a and 11b, which are illustrated in FIG. 4, can be formed as below, for example. After the transistors and the data signal lines are formed, the inorganic interlayer insulating film 25 (passivation film) which is made from SiNx and has a thickness of approximately 3000 Å is formed so as to cover the entire active matrix substrate, by CVD, with the use of a mixture gas of an SiH₄ gas, an NH₃ gas, and an N₂ gas. Then, the organic interlayer insulating film 26 which is made from a positive photosensitive acrylic resin and has a thickness of approximately 3 μm is formed by spin coating or die coating. Then, the organic interlayer insulating film 26 is subjected to a photolithography process so as to have hollowed parts and patterns for various contact holes. Further, the inorganic interlayer insulating film 25 is subjected to a dry etching process in which a mixture gas of a CF₄ gas and an O₂ gas is used and the organic interlayer insulating film 26 thus patterned is used as a mask. For example, for the hollowed parts of the organic interlayer insulating film 26, half exposure is carried out in the photolithography process so that a thin organic interlayer insulating film can be left at completion of a development process. On the other hand, for the contact holes, full exposure is carried out in the photolithography process so that no organic interlayer insulating film is left at the completion of the development process. Then, the dry etching process is carried out with the use of the mixture gas of the CF₄ gas and the O₂ gas. As a result, for the hollowed parts, a remaining part of the organic interlayer insulating film 26 is removed, and for the contact holes, the inorganic interlayer insulating film 25 under the organic interlayer insulating film 26 is removed. The organic interlayer insulating film 26 can be, e.g., an insulating film made from an SOG (Spin-On Glass) material. Further, the organic interlayer insulating film 26 can contain at least one of an acrylic resin, an epoxy resin, a polyimide resin, a polyurethane resin, a novolac resin, and a siloxane resin.

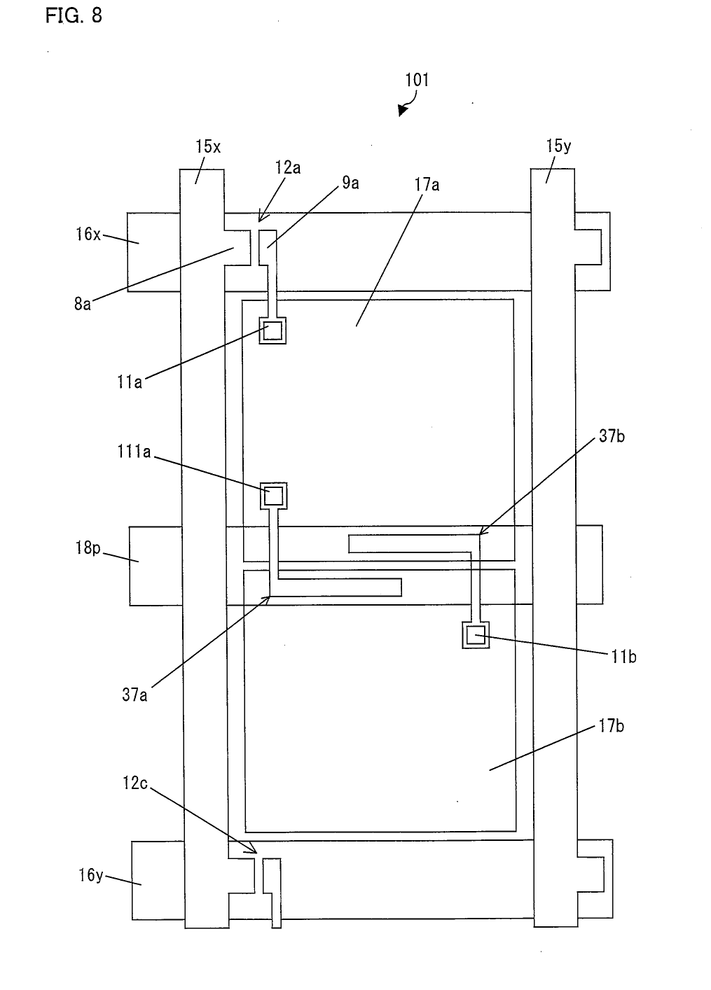

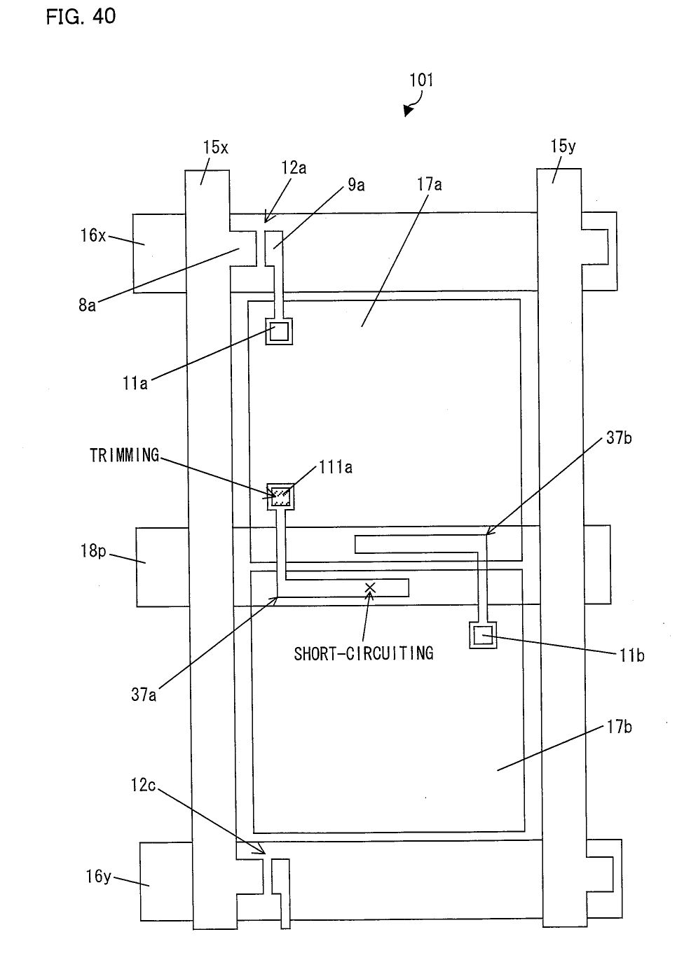

The pixel 101 illustrated in FIG. 2 can be modified as illustrated in FIG. 8. According to an arrangement illustrated in FIG. 8, the drain electrode 9a of the transistor 12a is connected with the pixel electrode 17a via the contact hole 11a, and the pixel electrode 17a and the capacitor electrode 37a are connected with each other via the contact hole 111a. This makes it possible to shorten the drain drawing wire connecting the drain electrode 9a and the capacitor electrode 37a. As a result, an aperture ratio can be increased. In a liquid crystal panel illustrated in FIG. 8, the pixel electrodes 17a and 17b are connected (capacitatively coupled) with each other via the two coupling capacitors (Cab1 and Cab2) which are provided in parallel to each other. Therefore, even if the contact hole 111a becomes defective in a manufacturing process or the like, it is possible to maintain a state in which the pixel electrodes 17a and 17b each of which receives a signal potential from the data signal line 15x are connected with each other via the coupling capacitors. If short-circuiting of the capacitor electrode 37a and the retention capacitor wire 18p or the pixel electrode 17b occurred (in a manufacturing process or the like), a part in the contact hole 111a of the pixel electrode 17a is removed (trimmed), as illustrated in FIG. 40, by a laser or the like so that the pixel electrode 17a and the capacitor electrode 37 are electrically separated. This makes it possible to maintain a state in which the pixel electrodes 17a and 17b are connected with each other via the coupling capacitors.

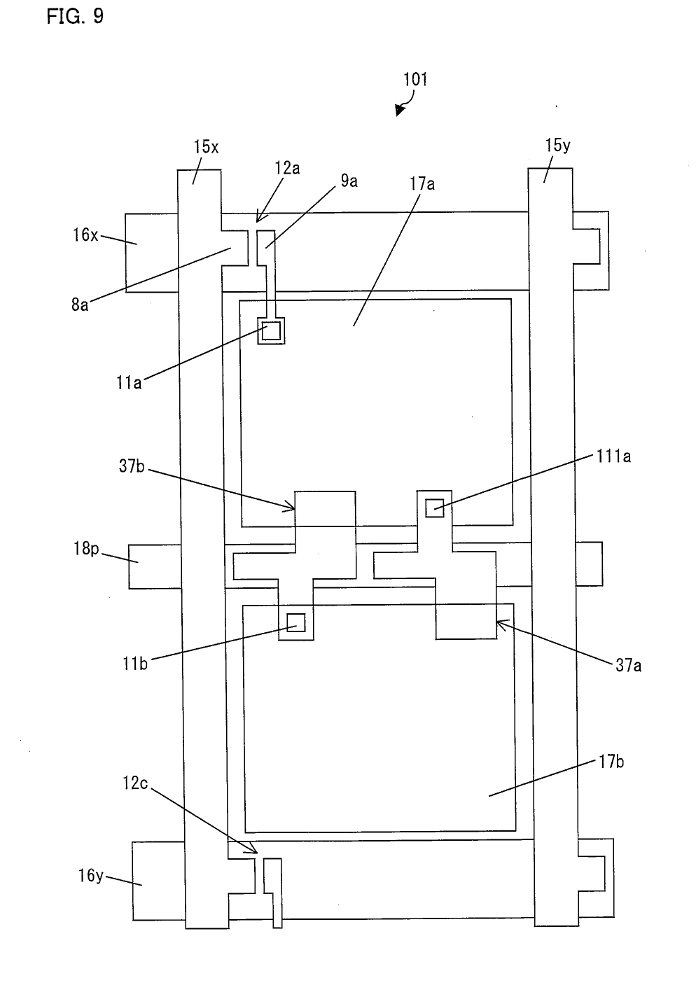

The pixel 101 illustrated in FIG. 2 can be modified as illustrated in FIG. 9. According to the arrangement illustrated in FIG. 9, the pixel electrodes 17a and 17b each having a rectangular shape are arranged in the column direction. One of four sides constituting the outer periphery of the first pixel electrode is adjacent to one of four sides constituting the outer periphery of the second pixel electrode. Each of capacitor electrodes 37a and 37b is provided so as to overlap the pixel electrodes 17a and 17b, and a gap between the one of the four sides constituting the outer periphery of the first pixel electrode and the one of the four sides constituting the outer periphery of the second pixel electrode (i.e., gap between the pixel electrodes 17a and 17b). The retention capacitor wire 18p is provided under the gap.

More specifically, the capacitor electrode 37a includes a main part above the gap, and a first projection projecting from one side of the main part, and a second projection projecting from an opposite side of the main part. If the capacitor electrode 37a is moved in a direction parallel to a longitudinal direction of the gap, and axisymmetrically moved with respect to an axis which is a virtual line which extends in parallel to the longitudinal direction along a center line of the gap, the capacitor electrode 37a is substantially located in a place where the capacitor electrode 37b is provided. The capacitor electrode 37b includes a main part above the gap, and a first projection projecting from one side of the main part, and a second projection projecting from an opposite side of the main part.

The second projection of the capacitor electrode 37a is connected with the pixel electrode 17a via the contact hole 111a. The first projection of the capacitor electrode 37a and the pixel electrode 17b overlap each other via the interlayer insulating film. The coupling capacitor Cab1 (see FIG. 1) is formed in an area where the first projection and the pixel electrode 17b overlap each other. The second projection of the capacitor electrode 37b is connected with the pixel electrode 17b via the contact hole 11b. The first projection of the capacitor electrode 37b and the pixel electrode 17a overlap each other via the interlayer insulting film. The coupling capacitor Cab2 (see FIG. 1) is formed in an area where the first projection and the pixel electrode 17a overlap each other. The main part of the capacitor electrode 37a and the retention capacitor wire 18p overlap each other via the gate insulating film. The retention capacitor Cha (see FIG. 1) is formed in an area where the main part and the retention capacitor wire 18p overlap each other. The main part of the capacitor electrode 37b and the retention capacitor wire 18p overlap each other via the gate insulating film. The retention capacitor Chb (see FIG. 1) is formed in an area where the main part and the retention capacitor wire 18p overlap each other.

According to the arrangement illustrated in FIG. 9, if the capacitor electrode 37a is moved in the direction parallel to the longitudinal direction of the gap, and axisymmetrically moved with respect to the axis which is the virtual line, the capacitor electrode 37a is substantially located in a place where the capacitor electrode 37b is provided. Therefore, even if the pixel electrodes 17a and 17b become misaligned with respect to the capacitor electrodes 37a and 37b in a direction perpendicular to the virtual line (i.e., in the column direction), an area where the capacitor electrode 37a and the pixel electrode 17b overlap each other and an area where the capacitor electrode 37b and the pixel electrode 17a overlap each other complement each other. This is advantageous in that a total amount of the two coupling capacitors (Cab1 and Cab2) is unlikely to change.

Also in the case of the arrangement illustrated in FIG. 9, if short-circuiting of the capacitor electrode 37a and the retention capacitor wire 18p or the pixel electrode 17b occurred (in a manufacturing process or the like), a part in the contact hole 111a of the pixel electrode 17a is removed (trimmed) by a laser or the like so that the pixel electrode 17a and the capacitor electrode 37 are electrically separated. This makes it possible to maintain a state in which the pixel electrodes 17a and 17b are connected with each other via the coupling capacitors.

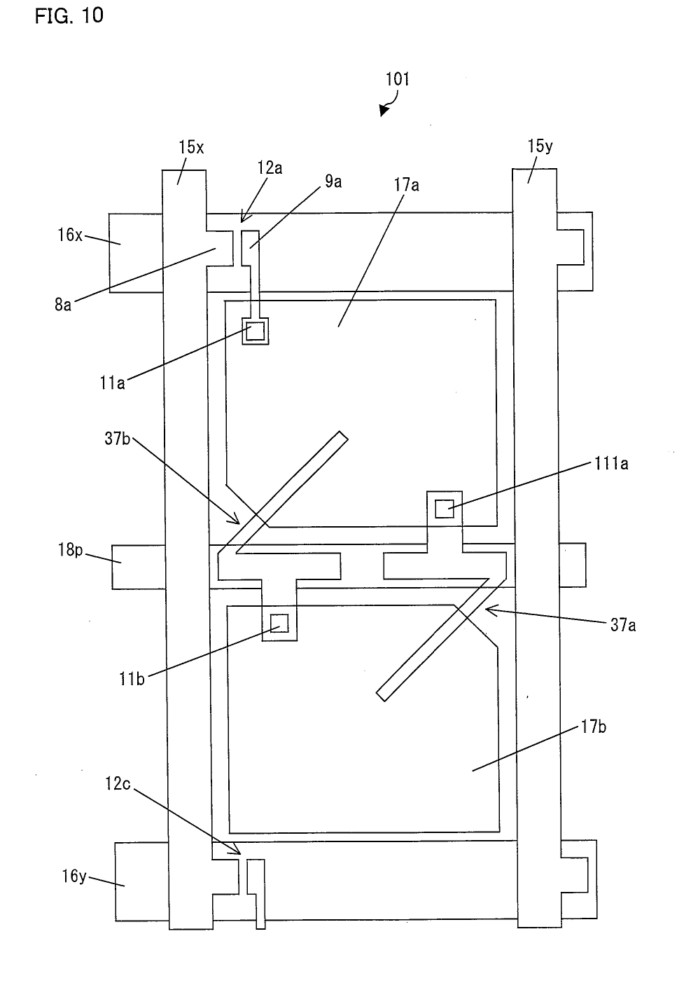

The pixel 101 illustrated in FIG. 9 can be modified as illustrated in FIG. 10. According to the arrangement illustrated in FIG. 10, the pixel electrodes 17a (first pixel electrode) and 17b (second pixel electrode) each having a same rectangular shape whose one corner is cut off are arranged in one pixel region in the column direction so that respective cut parts are diagonally opposite to each other. One of five sides constituting an outer periphery of the first pixel electrode is adjacent to one of five sides constituting an outer periphery of the second pixel electrode. Each of capacitor electrodes 37a and 37b is provided so as to overlap the pixel electrodes 17a and 17b, and a gap between the one of the four sides constituting the outer periphery of the first pixel electrode and the one of the four sides constituting the outer periphery of the second pixel electrode (i.e., gap between the pixel electrodes 17a and 17b). The retention capacitor wire 18p which extends in the line direction is provided so as to overlap whole of the gap.

More specifically, the capacitor electrode 37a includes a projection projecting toward the pixel electrode 17a, and an extension which extends diagonally from one end of the main part so as to cross the cut part of the pixel electrode 17b. If the capacitor electrode 37a is rotated by 180° around a point of the gap (gap between the pixel electrodes 17a and 17b), the capacitor electrode 37a is substantially located in a place where the capacitor electrode 37b is provided. The capacitor electrode 37b includes a main part above the gap (gap between the pixel electrodes 17a and 17b), a projection projecting toward the pixel electrode 17b, and an extension which extends diagonally from one end of the main part so as to cross the cut part of the pixel electrode 17a.

The projection of the capacitor electrode 37a is connected with the pixel electrode 17a via the contact hole 111a. The extension of the capacitor electrode 37a and the pixel electrode 17b overlap each other via the interlayer insulating film. The coupling capacitor Cab1 (see FIG. 1) is formed in an area where the extension and the pixel electrode 17b overlap each other. The extension of the capacitor electrode 37b is connected with the pixel electrode 17b via the contact hole 11b. The extension of the capacitor electrode 37b and the pixel electrode 17a overlap each other via the interlayer insulating film. The coupling capacitor Cab2 (see FIG. 1) is formed in an area where the extension and the pixel electrode 17a overlap each other. The main part of the capacitor electrode 37a and the retention capacitor wire 18p overlap each other via the gate insulating film. The retention capacitor Cha (see FIG. 1) is formed in an area where the main part and the retention capacitor wire 18p overlap each other. The main part of the capacitor electrode 37b and the retention capacitor wire 18p overlap each other via the gate insulating film. The retention capacitor Chb (see FIG. 1) is formed in an area where the main part and the retention capacitor wire 18p overlap each other. The extension of the capacitor electrode 37a orthogonally intersects with a side of the pixel electrode 17a which side is formed by cutting the one corner of the pixel electrode 17b. Similarly, the extension of the capacitor electrode 37b orthogonally intersects with a side of the pixel electrode 17b which side is formed by cutting the one corner of the pixel electrode 17b.

According to the arrangement, respective extensions of the capacitor electrodes 37a and 37b extend diagonally. Therefore, even if the pixel electrodes 17a and 17b become misaligned with respect to the capacitor electrodes 37a and 37b in a direction diagonal to the capacitor electrodes 37a and 37b (i.e., in a direction in which respective extensions extend), an area where the capacitor electrode 37a and the pixel electrode 17b overlap each other and an area where the capacitor electrode 37b and the pixel electrode 17a overlap each other complement each other. This is advantageous in that a total amount of the two coupling capacitors (Cab1 and Cab2) is unlikely to change.

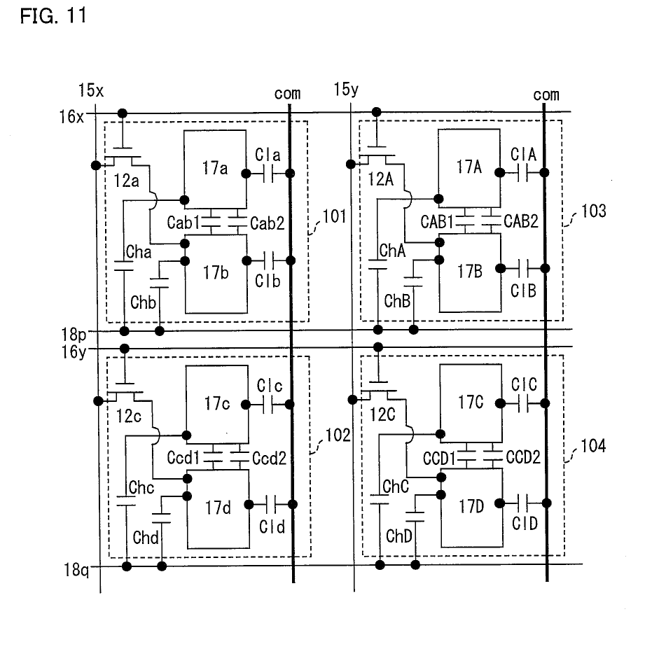

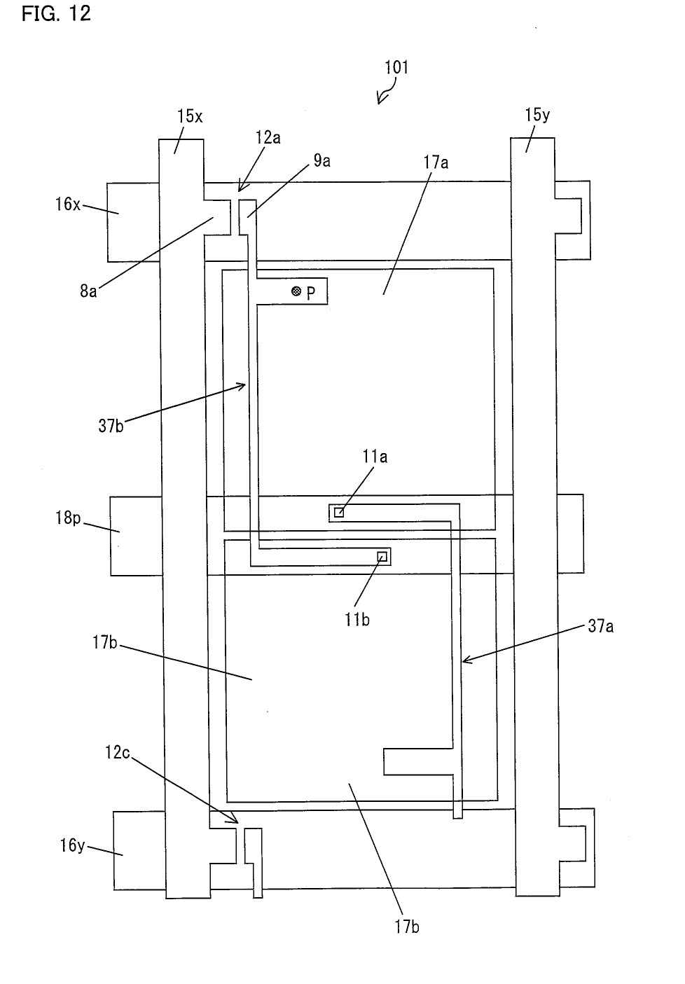

In the liquid crystal panel illustrated in FIG. 1, a transistor is connected with that one of two pixel electrodes provided in one pixel which is closer to the transistor. However, the present embodiment is not limited to this. That is, as illustrated in FIG. 11, the transistor can be connected with that one of the two pixel electrodes provided in the one pixel which is more distant from the transistor. FIG. 12 illustrates a concrete example of the pixel 101 illustrated in FIG. 11. In a liquid crystal panel illustrated in FIG. 12, the transistor 12a is provided in the vicinity of an intersection of the data signal line 15x and the scanning signal line 16x. In a pixel region defined by the data signal line 15x and the scanning signal line 16x, the pixel electrodes 17a and 17b each having a rectangular shape are arranged in the column direction. One of four sides constituting the outer periphery of a first pixel electrode (i.e., pixel electrode 17a) is adjacent to one of four sides constituting the outer periphery of a second pixel electrode (i.e., pixel electrode 17b). Each of capacitor electrodes 37a and 37b is provided so as to overlap the pixel electrodes 17a and 17b, and a gap between the one of the four sides constituting the outer periphery of the first pixel electrode and the one of the four sides constituting the outer periphery of the second pixel electrode (i.e., gap between the pixel electrodes 17a and 17b). The retention capacitor wire 18p which extends in the line direction is provided so as to overlap whole of the gap.

More specifically, the capacitor electrode 37b includes: a first part which extends along the data signal line 15x in the column direction from the vicinity of the transistor 12a; a second part which extends in the line direction from between both ends of the first part; and a third part which extends in the line direction from one end of the first part. The first part and each of the pixel electrode 17a, the gap (gap between the pixel electrodes 17a and 17b), and the pixel electrode 17b overlap each other. The second part and the pixel electrode 17a overlap each other. The third part and the pixel electrode 17b overlap each other. If the capacitor electrode 37b is rotated by 180° around a point of the gap (e.g., around center point of the gap), the capacitor electrode 37b is substantially located in a place where the capacitor electrode 37a is provided. The capacitor electrode 37a includes a first part which extends in the column direction along the data signal line 15y, a second part which extends in the line direction from between both ends of the first part, and a third part which extends in the line direction from one end of the first part. The first part and each of the pixel electrode 17b, the gap (gap between the pixel electrodes 17a and 17b), and the pixel electrode 17a overlap each other. The second part and the pixel electrode 17b overlap each other. The third part and the pixel electrode 17a overlap each other.

The source electrode 8a and the drain electrode 9a of the transistor 12a are formed on the scanning signal line 16x. The source electrode 8a is connected with the data signal line 15x. The drain electrode 9a is connected with the first part of the capacitor electrode 37b. The third part of the capacitor electrode 37b is connected with the pixel electrode 17b via the contact hole 11b. As described above, the second part of the capacitor electrode 37b and the pixel electrode 17a overlap each other via the interlayer insulating film. The coupling capacitor Cab1 (see FIG. 11) is formed in an area where the second part and the pixel electrode 17a overlap each other. The third part of the capacitor electrode 37a is connected with the pixel electrode 17a via the contact hole 11a. As described above, the second part of the capacitor electrode 37a and the pixel electrode 17b overlap each other via the interlayer insulating film. The coupling capacitor Cab2 (see FIG. 11) is formed in an area where the second part and the pixel electrode 17b overlap each other.

The third part of the capacitor electrode 37b and the retention capacitor wire 18p overlap each other. Much of the retention capacitor Chb (see FIG. 11) is formed in an area where the capacitor electrode 37b and the retention capacitor wire 18p overlap each other. The third part of the capacitor electrode 37a and the retention capacitor wire 18p overlap each other. Much of the retention capacitor Cha (see FIG. 11) is formed in an area where the third part and the retention capacitor wire 18p overlap each other.

In the liquid crystal panel illustrated in FIG. 12, the pixel electrodes 17a and 17b are connected (capacitatively coupled) with each other via the two coupling capacitors (Cab1 and Cab2) which are formed in parallel to each other. Therefore, if, e.g., short-circuiting of the second part of the capacitor electrode 37b and the pixel electrode 17a occurred at P in FIG. 12 (in a manufacturing step or the like), a correction step is carried out in which the second part is cut by a laser between a part where the short-circuiting occurred and a part where the second part and the first part are connected with each other. This makes it possible to maintain a state in which the pixel electrodes 17a and 17b are connected with each other via the capacitors. In a case where short-circuiting of the second part of the capacitor electrode 37a and the pixel electrode 17b occurred, the second part is cut by a laser between a part where the short-circuiting occurred and a part where the second part and the first part are connected with each other.

The liquid crystal panel illustrated in FIG. 12 is arranged such that if the capacitor electrode 37b is rotated by 180° around a point of the gap (i.e., gap between the pixel electrodes 17a and 17b), the capacitor electrode 37b is substantially located in a place where the capacitor electrode 37a is provided. This is advantageous in that a total amount of the two coupling capacitors (Cab1 and Cab2) is unlikely to change even if the pixel electrodes 17a and 17b become misaligned with respect to the capacitor electrodes 37a and 37b in a direction perpendicular to the gap (i.e., in the column direction).

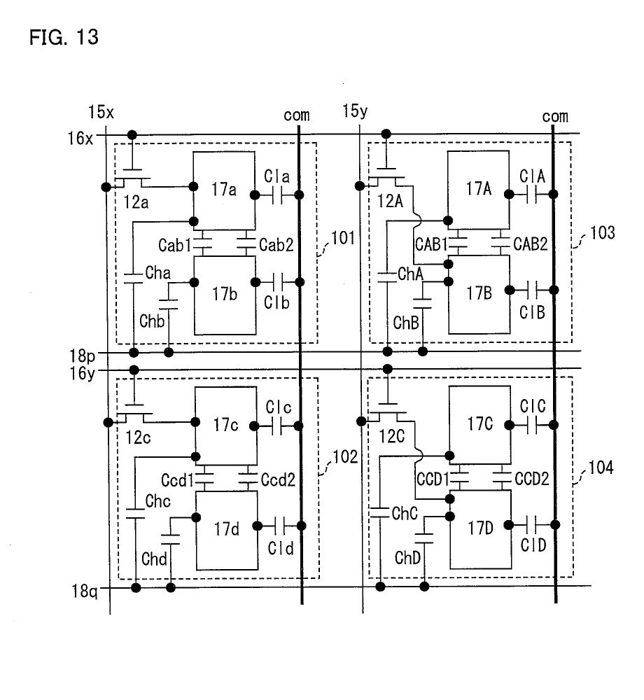

In each of the pixels of the liquid crystal panel illustrated in FIG. 1, a transistor is connected with that one of two pixel electrodes provided in the pixel which is closer to the transistor. However, the present embodiment is not limited to this. That is, as illustrated in FIG. 13, it can be arranged such that in one of two pixels which are adjacent to each other in the line direction, that one of two pixel electrodes which is closer to a corresponding transistor is connected to the transistor whereas in the other of the two pixels, that one of two pixel electrodes which is more distant from a corresponding transistor is connected to the transistor.

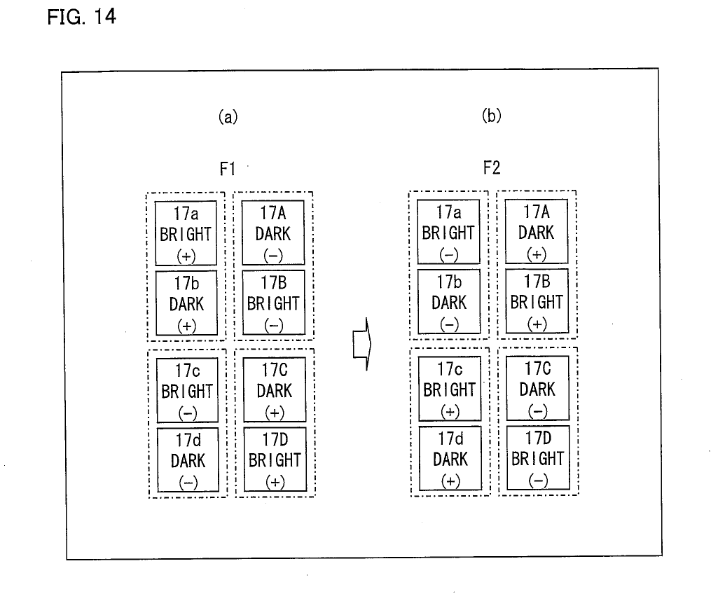

Assume that the data signal lines 15x and 15y are driven, as shown in FIG. 5, in a liquid crystal display apparatus including the liquid crystal panel illustrated in FIG. 13. In this case, in the frame F1, the subpixel containing the pixel electrode 17a (positive polarity) is “bright”; the subpixel containing the pixel electrode 17b (positive polarity) is “dark”; the subpixel containing the pixel electrode 17c (negative polarity) is “bright”; the subpixel containing the pixel electrode 17d (negative polarity) is “dark”; the subpixel containing the pixel electrode 17A (negative polarity) is “dark”; and the subpixel containing the pixel electrode 17B (negative polarity) is “bright.” FIG. 14(a) shows this as a whole. In the frame F2, the subpixel containing the pixel electrode 17a (negative polarity) is “bright”; the subpixel containing the pixel electrode 17b (negative polarity) is “dark”; the subpixel containing the pixel electrode 17c (positive polarity) is “bright”; the subpixel containing the pixel electrode 17d (positive polarity) is “dark”; the subpixel containing the pixel electrode 17A (positive polarity) is “dark”; and the subpixel containing the pixel electrode 17B (positive polarity) is “bright.” FIG. 14(b) shows this as a whole.

In the liquid crystal panel illustrated in FIG. 13, no bright subpixel is adjacent to another bright subpixel in the line direction, nor no dark subpixel is adjacent to another dark subpixel in the line direction. This makes it possible to reduce striped display unevenness.

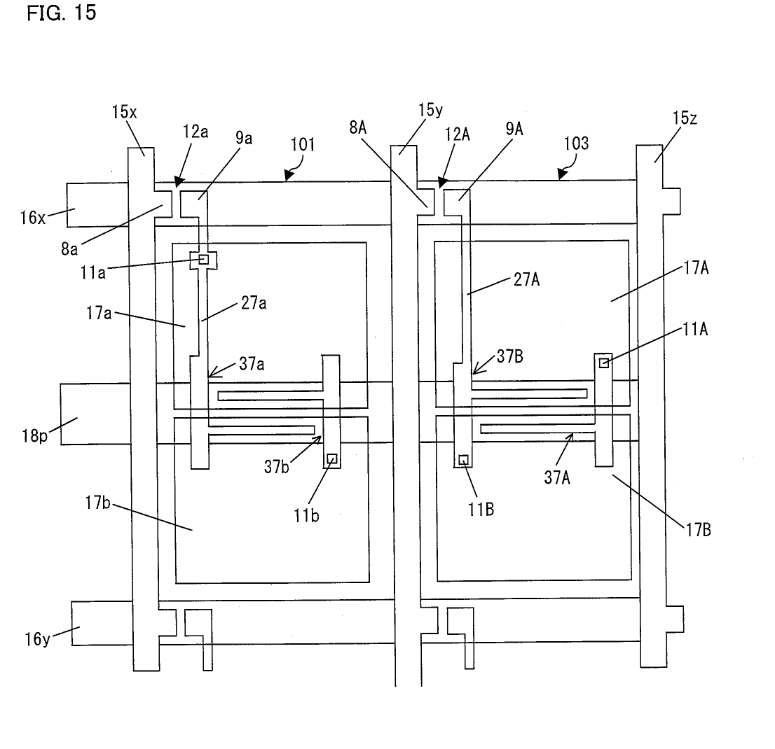

FIG. 15 illustrates a concrete example of the pixels 101 and 103 which are illustrated in FIG. 13. As illustrated in FIG. 15, in the pixel 101, the transistor 12a is provided in the vicinity of an intersection of the data signal line 15x and the scanning signal line 16x. In a pixel region defined by the data signal line 15x and the scanning signal line 16x, the pixel electrodes 17a and 17b each having a rectangular shape are arranged in the column direction. One of four sides constituting the outer periphery of a first pixel electrode (i.e., pixel electrode 17a) is adjacent to one of four sides constituting the outer periphery of a second pixel electrode (i.e., pixel electrode 17b). Each of capacitor electrodes 37a and 37b is provided so as to overlap the pixel electrodes 17a and 17b, and a gap between the one of the four sides constituting the outer periphery of the first pixel electrode and the one of the four sides constituting the outer periphery of the second pixel electrode (i.e., gap between the pixel electrodes 17a and 17b). The retention capacitor wire 18p which extends in the line direction is provided so as to overlap whole of the gap.

More specifically, the capacitor electrode 37a includes a first part which extends in the column direction along the data signal line 15x, and a second part which extends in the line direction from between both ends of the first part. The first part and each of the pixel electrode 17a, the gap (gap between the pixel electrodes 17a and 17b), and the pixel electrode 17b overlap each other. The second part and the pixel electrode 17b overlap each other. If the capacitor electrode 37a is rotated by 180° around a point of the gap (gap between the pixel electrodes 17a and 17b), the capacitor electrode 37a is substantially located in a place where the capacitor electrode 37b is provided. The capacitor electrode 37b includes a first part which extends in the column direction along the data signal line 15y, and a second part which extends in the line direction from between both ends of the first part. The first part and each of the pixel electrode 17b, the gap, and the pixel electrode 17a overlap each other. The second part and the pixel electrode 17a overlap each other.

The source electrode 8a and the drain electrode 9a of the transistor 12a are formed on the scanning signal line 16x. The source electrode 8a is connected with the data signal line 15x. The drain electrode 9a is connected with a drain drawing wire 27a. The drain drawing wire 27a is connected with the first part of the capacitor electrode 37a formed at a same layer level. The drain drawing wire 27a is also connected with the pixel electrode 17a via a contact hole 11a. As described above, the second part of the pixel electrode 37a and the pixel electrode 17b overlap each other via an interlayer insulating film. The coupling capacitor Cab1 (see FIG. 13) is formed in an area where the second part and the pixel electrode 17b overlap each other. The first part of the capacitor electrode 37b is connected with the pixel electrode 17b via the contact hole 11b. As described above, the second part of the capacitor electrode 37b and the pixel electrode 17a overlap each other via the interlayer insulating film. The coupling capacitor Cab2 (see FIG. 13) is formed in an area where the second part and the pixel electrode 17a overlap each other. Most of the capacitor electrode 37a and the retention capacitor wire 18p overlap each other. Much of the retention capacitor Cha (see FIG. 13) is formed in an area where the capacitor electrode 37a and the retention capacitor wire 18p overlap each other. Most of the capacitor electrode 37b and the retention capacitor wire 18p overlap each other. Much of the retention capacitor Chb (see FIG. 13) is formed in an area where the capacitor electrode 37b and the retention capacitor wire 18p overlap each other.

In the pixel 103, on the other hand, the transistor 12A is provided in the vicinity of an intersection of the data signal line 15y and the scanning signal line 16x. In a pixel region defined by the data signal line 15y and the scanning signal line 16x, the pixel electrodes 17A and 17B each having a rectangular shape are arranged in the column direction. One of four sides constituting the outer periphery of a first pixel electrode (i.e., pixel electrode 17A) is adjacent to one of four sides constituting the outer periphery of a second pixel electrode (i.e., pixel electrode 17B). Each of capacitor electrodes 37A and 37B is provided so as to overlap the pixel electrodes 17A and 17B, and a gap between the one of the four sides constituting the outer periphery of the first pixel electrode and the one of the four sides constituting the outer periphery of the second pixel electrode (i.e., gap between the pixel electrodes 17A and 17B). The retention capacitor wire 18p which extends in the line direction is provided so as to overlap whole of the gap.

More specifically, the capacitor electrode 37B includes a first part which extends in the column direction along the data signal line 15y, and a second part which extends in the line direction from between both sides of the first part. The first part and each of the pixel electrode 17A, the gap, and the pixel electrode 17B overlap each other. The second part and the pixel electrode 17A overlap each other. If the capacitor electrode 37B is rotated by 180° around a point of the gap, the capacitor electrode 37B is substantially located in a place where the capacitor electrode 37A is provided. The capacitor electrode 37A includes a first part which extends in the column direction along the data signal line 15z, and a second part which extends in the line direction from between both sides of the first part. The first part and each of the pixel electrode 17B, the gap, and the pixel electrode 17A overlap each other. The second part and the pixel electrode 17B overlap each other.

The source electrode 8A and the drain electrode 9A of the transistor 12A are formed on the scanning signal line 16x. The source electrode 8A is connected with the data signal line 15y. The drain electrode 9A is connected with a drain drawing wire 27A. The drain drawing wire 27A is connected with the first part of the capacitor electrode 37B formed at a same layer level. The first part of the capacitor electrode 37B is connected with the pixel electrode 17B via a contact hole 11B. As described above, the second part of the pixel electrode 37B and the pixel electrode 17A overlap each other via the interlayer insulating film. The coupling capacitor CAB1 (see FIG. 13) is formed in an area where the second part and the pixel electrode 17A overlap each other. The first part of the capacitor electrode 37A is connected with the pixel electrode 17A via a contact hole 11A. As described above, the second part of the capacitor electrode 37A and the pixel electrode 17B overlap each other via the interlayer insulating film. The coupling capacitor CAB2 (see FIG. 13) is formed in an area where the second part and the pixel electrode 17B overlap each other. Most of the capacitor electrode 37B is formed on the retention capacitor wire 18p. Much of the retention capacitor ChB (see FIG. 13) is formed in an area where the capacitor electrode 37B and the retention capacitor wire 18p overlap each other. Most of the capacitor electrode 37A is formed on the retention capacitor wire 18p. Much of the retention capacitor ChA (see FIG. 13) is formed in an area where the capacitor electrode 37A and the retention capacitor wire 18p overlap each other.

### Second Embodiment

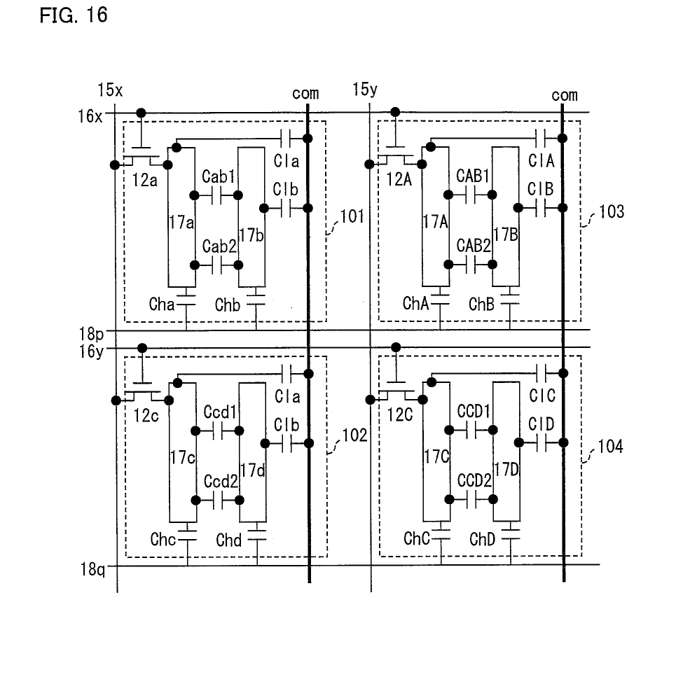

FIG. 16 is an equivalent circuit diagram illustrating a part of a liquid crystal panel of a second embodiment. As illustrated in FIG. 16, the liquid crystal panel includes: data signal lines (15x and 15y) which extend in the column direction (i.e., longitudinal direction in FIG. 1); scanning signal lines (16x and 16y) which extend in the line direction (i.e., transverse direction in FIG. 1); pixels (101 through 104) arranged in the line and column directions; retention capacitor wires (18p and 18q); and a common electrode (counter electrode) com. The pixels have an identical arrangement. A column of pixels which contains the pixels 101 and 102 is adjacent to a column of pixels which contains the pixels 103 and 104. A line of pixels which contains the pixels 101 and 103 is adjacent to a line of pixels which contains the pixels 102 and 104.

In the liquid crystal panel, one data signal line and one scanning signal line are provided for one pixel. Two pixel electrodes are provided in one pixel so as to be arranged in the line direction. Two pixel electrodes 17a and 17b provided in the pixel 101 are arranged in a horizontal line, and two pixel electrodes 17A and 17B provided in the pixel 103 are arranged in a horizontal line. Two pixel electrodes 17c and 17d provided in the pixel 102 are arranged in a horizontal line, and two pixel electrodes 17C and 17D provided in the pixel 104 are arranged in a horizontal line. The pixel electrodes 17a, 17b, 17A, and 17B are adjacent to the pixel electrodes 17c, 17d, 17C, and 17D in the column direction, respectively.

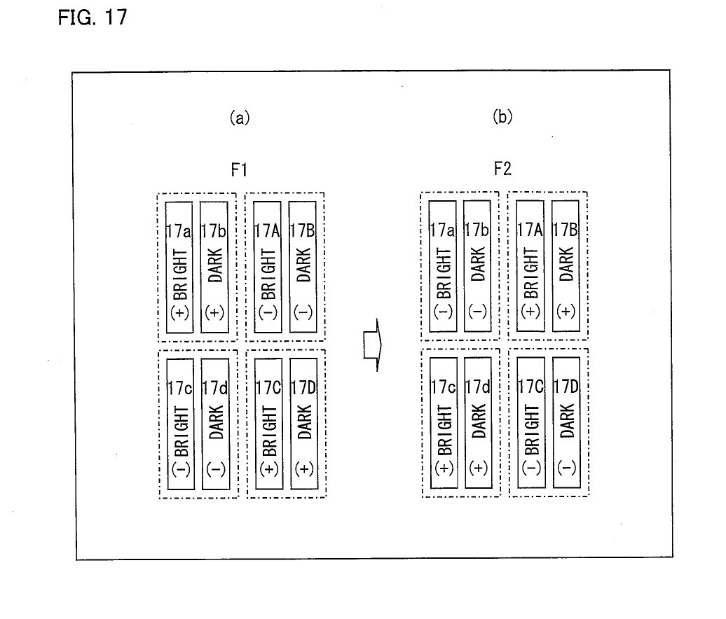

Assume that the data signal lines 15x and 15y are driven, as shown in FIG. 5, in a liquid crystal display apparatus including the liquid crystal panel. In this case, in the frame F1, the subpixel containing the pixel electrode 17a (negative polarity) is “bright”; the subpixel containing the pixel electrode 17b (negative polarity) is “dark”; the subpixel containing the pixel electrode 17c (positive polarity) is “bright”; the subpixel containing the pixel electrode 17d (positive polarity) is “dark”; the subpixel containing the pixel electrode 17A (positive polarity) is “bright”; the subpixel containing the pixel electrode 17B (positive polarity) is “dark.” FIG. 17(a) shows this as a whole. In the frame F2, the subpixel containing the pixel electrode 17a (positive polarity) is “bright”; the subpixel containing the pixel electrode 17b (positive polarity) is “dark”; the subpixel containing the pixel electrode 17c (negative polarity) is “bright”; the subpixel containing the pixel electrode 17d (negative polarity) is “dark”; the subpixel containing the pixel electrode 17A (negative polarity) is “bright”; the subpixel containing the pixel electrode 17B (negative polarity) is “dark.” FIG. 17(b) shows this as a whole.

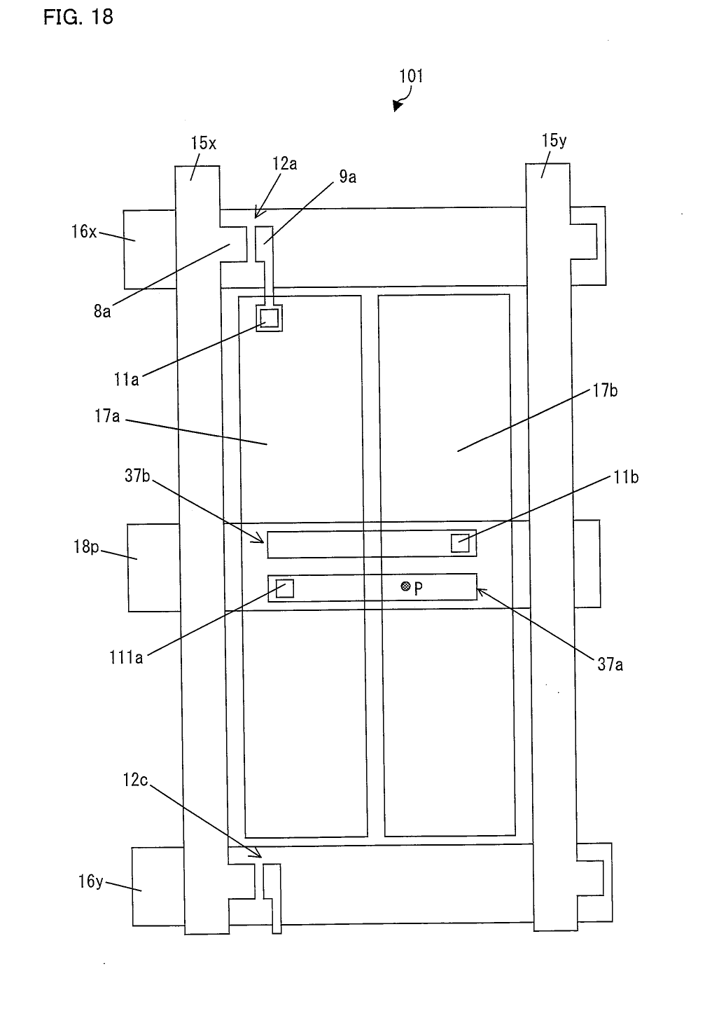

FIG. 18 illustrates a concrete example of the pixel 101 illustrated in FIG. 16. As illustrated in FIG. 18, the transistor 12a is provided in the vicinity of an intersection of the data signal line 15x and the scanning signal line 16x. In a pixel region defined by the data signal line 15x and the scanning signal line 16x, the pixel electrodes 17a and 17b each having a rectangular shape are arranged in the line direction. One of four sides constituting the outer periphery of a first pixel electrode (i.e., pixel electrode 17a) is adjacent to one of four sides constituting the outer periphery of a second pixel electrode (i.e., pixel electrode 17b). Each of the capacitor electrodes 37a and 37b is provided so as to overlap a gap between the one of the four sides constituting the outer periphery of the first pixel electrode and the one of the four sides constituting the outer periphery of the second pixel electrode (i.e., a gap between the pixel electrodes 17a and 17b), and the pixel electrodes 17a and 17b. The retention capacitor wire 18p extends in the line direction so as to cross a center of the pixel 101.

More specifically, each of the capacitor electrodes 37a and 37b has a rectangular shape which extends in the line direction so as to intersect with the gap. The capacitor electrodes 37a and 37b are provided in a central area of the pixel 101 so that if the capacitor electrode 37a is rotated by 180° around a point of the gap, the capacitor electrode 37a is substantially located in a place where the capacitor electrode 37b is provided.

The source electrode 8a and the drain electrode 9a of the transistor 12a are formed on the scanning signal line 16x. The source electrode 8a is connected with the data signal line 15x. The drain electrode 9a is connected with the pixel electrode 17a via the contact hole 11a. The capacitor electrode 37a is connected with the pixel electrode 17a via the contact hole 111a. A part of the capacitor electrode 37a and the pixel electrode 17b overlap each other via the interlayer insulating film. The coupling capacitor Cab1 (see FIG. 16) is formed in an area where the part of the capacitor electrode 37a and the pixel electrode 17b overlap each other. The capacitor electrode 37b is connected with the pixel electrode 17b via the contact hole 11b. A part of the capacitor electrode 37b and the pixel electrode 17a overlap each other via the interlayer insulating film. The coupling capacitor Cab2 (see FIG. 16) is formed in an area where the part of the capacitor electrode 37b and the pixel electrode 17a overlap each other.

The capacitor electrode 37a and the retention capacitor wire 18p overlap each other via the gate insulating film. Much of the retention capacitor Cha (see FIG. 16) is formed in an area where the capacitor electrode 37a and the retention capacitor wire 18p overlap each other. The capacitor electrode 37b and the retention capacitor wire 18p overlap each other via the gate insulating film. Much of the retention capacitor Chb (see FIG. 16) is formed in an area where the capacitor electrode 37b and the retention capacitor wire 18p overlap each other.

In the liquid crystal panel illustrated in FIG. 18, the pixel electrodes 17a and 17b are connected (capacitatively coupled) with each other via the two coupling capacitors (Cab1 and Cab2) which are provided in parallel to each other. Therefore, if, e.g., short-circuiting of the capacitor electrode 37a and the retention capacitor wire 18p or the pixel electrode 17b occurred at P in FIG. 18 (in a manufacturing step or the like), a correction step is carried out in which the capacitor electrode 37a is cut by a laser between the contact hole 111a and a part where the short-circuiting occurred. This makes it possible to maintain a state in which the pixel electrodes 17a and 17b are connected with each other via the capacitors. In addition, even if the contact hole 111a becomes defective in a manufacturing process or the like, it is possible to maintain a state in which the pixel electrodes 17a and 17b each of which receives a signal potential from the data signal line 15x are connected with each other via the coupling capacitors. If short-circuiting of the capacitor electrode 37b and the retention capacitor wire 18p or the pixel electrode 17a occurred, the capacitor electrode 37b is cut by a laser between the contact hole 11b and a part where the short-circuiting occurred.

In the correction step, the first part of the capacitor electrode 37a is irradiated with a laser via the gap from the top surface side of the active matrix substrate 3 (from the counter side to the glass substrate 31 side) so as to be cut. In this case, there is concern that another short-circuiting of the capacitor electrode 37a and the retention capacitor wire 18p can occur. In order that the concern is eliminated, an aperture can be formed in the retention capacitor wire 18p so as to overlap the gap between the pixel electrodes 17a and 17b.

Alternatively, if short-circuiting of the capacitor electrode 37a and the retention capacitor wire 18p or the pixel electrode 17b occurred, a part of the pixel electrode 17a in the contact hole 111a is removed (trimmed) by a laser or the like so that the pixel electrode 17a and the capacitor electrode 37a are electrically separated. This also makes it possible to maintain a state in which the pixel electrodes 17a and 17b each of which receives a signal potential from the data signal line 15x are connected with each other via the coupling capacitors.

Thus, the present embodiment makes it possible to improve a manufacturing yield of a liquid crystal panel and an active matrix substrate to be provided in the liquid crystal panel.

Further, the liquid crystal panel illustrated in FIG. 18 is arranged such that if the capacitor electrode 37a is rotated by 180° around a point of the gap between the pixel electrodes 17a and 17b, the capacitor electrode 37a is substantially located in a place where the capacitor electrode 37b is provided. Therefore, even if the pixel electrodes 17a and 17b become misaligned with respect to the capacitor electrodes 37a and 37b in a direction perpendicular to the gap (i.e., in the line direction), an area where the capacitor electrode 37a and the pixel electrode 17b overlap each other and an area where the capacitor electrode 37b and the pixel electrode 17a overlap each other complement each other. This is advantageous in that a total amount of capacitances of the two coupling capacitors (Cab1 and Cab2) is unlikely to change.

Further, in the liquid crystal panel illustrated in FIG. 18, the capacitor electrode 37a and each of the pixel electrode 17b and the retention capacitor wire 18p overlap each other, and the capacitor electrode 37b and each of the pixel electrode 17a and the retention capacitor wire 18p overlap each other. Thus, the capacitor electrodes 37a and 37b provided for forming the coupling capacitors also serve as electrodes for forming retention capacitors. This makes it possible to increase an aperture ratio.

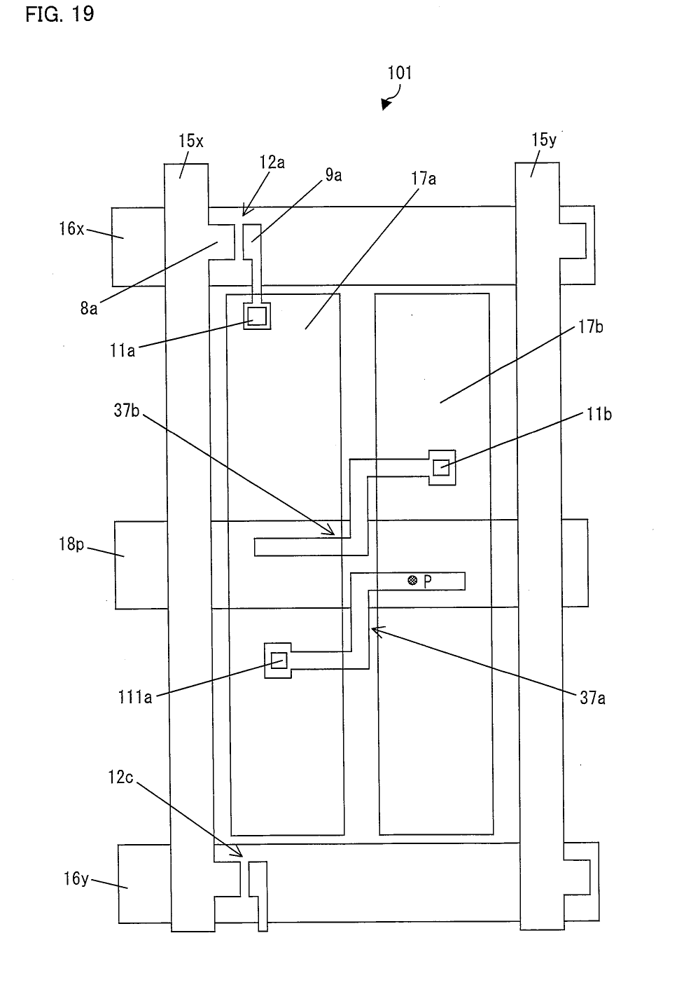

The pixel 101 illustrated in FIG. 18 can be modified as illustrated in FIG. 19. As illustrated in FIG. 19, the transistor 12a is provided in the vicinity of an intersection of the data signal line 15x and the scanning signal line 16x. In a pixel region defined by the data signal line 15x and the scanning signal line 16x, the pixel electrodes 17a and 17b each having a rectangular shape are arranged in the line direction. One of four sides constituting the outer periphery of a first pixel electrode (i.e., pixel electrode 17a) is adjacent to one of four sides constituting the outer periphery of a second pixel electrode (i.e., pixel electrode 17b). Each of the capacitor electrodes 37a and 37b is provided so as to overlap a gap between the one of the four sides constituting the outer periphery of the first pixel electrode and the one of the four sides constituting the outer periphery of the second pixel electrode (i.e., a gap between the pixel electrodes 17a and 17b), and the pixel electrodes 17a and 17b. The retention capacitor wire 18p extends in the line direction so as to cross a center of the pixel 101.

More specifically, the capacitor electrode 37a has a first part which extends in the line direction on the retention capacitor wire 18p, a second part which extends in the column direction under the gap from one end of the first part, and a third part which extends in the line direction from one end of the second part. The first part and each of the pixel electrode 17b and the gap overlap each other. The second part and the gap overlap each other. The third part and each of the gap and the pixel electrode 17a overlap each other. As for the capacitor electrode 37a, although the first part and the retention capacitor wire 18p overlap each other, each of a part of the second part and the third part, and the retention capacitor wire 18p do not overlap each other. If the capacitor electrode 37a is rotated by 180° around a point of the gap, the capacitor electrode 37a is substantially located in a place where the capacitor electrode 37b is provided. The capacitor electrode 37b includes a first part which extends in the line direction on the retention capacitor wire 18p, a second part which extends in the column direction under the gap from one end of the first part, and a third part which extends in the line direction from one end of the second part. The first part and each of the pixel electrode 17a and the gap overlap each other. The second part and the gap overlap each other. The third part and each of the gap and the pixel electrode 17b overlap each other. As for the capacitor electrode 37b, although the first part and the retention capacitor wire 18p overlap each other, each of a part of the second part and the third part, and the retention capacitor wire 18p do not overlap each other.

The third part of the capacitor electrode 37a is connected with the pixel electrode 17a via the contact hole 111a. The first part of the capacitor electrode 37a and the pixel electrode 17b overlap each other via the interlayer insulating film. The coupling capacitor Cab1 (see FIG. 16) is formed in an area where the first part and the pixel electrode 17b overlap each other. The third part of the capacitor electrode 37b is connected with the pixel electrode 17b via the contact hole 11b. The first part of the capacitor electrode 37b and the pixel electrode 17a overlap each other via the interlayer insulating film. The coupling capacitor Cab2 (see FIG. 12) is formed in an area where the first part and the pixel electrode 17a overlap each other.

Each of the first part of the capacitor electrode 37a and a part of the second part of the capacitor electrode 37a, and the retention capacitor wire 18p overlap each other via the gate insulating film. Much of the retention capacitor Cha (see FIG. 16) is formed in this area. Each of the first part of the capacitor electrode 37b and a part of the second part of the capacitor electrode 37b, and the retention capacitor wire 18p overlap each other via the gate insulating film. Much of the retention capacitor Chb (see FIG. 16) is formed in this area.

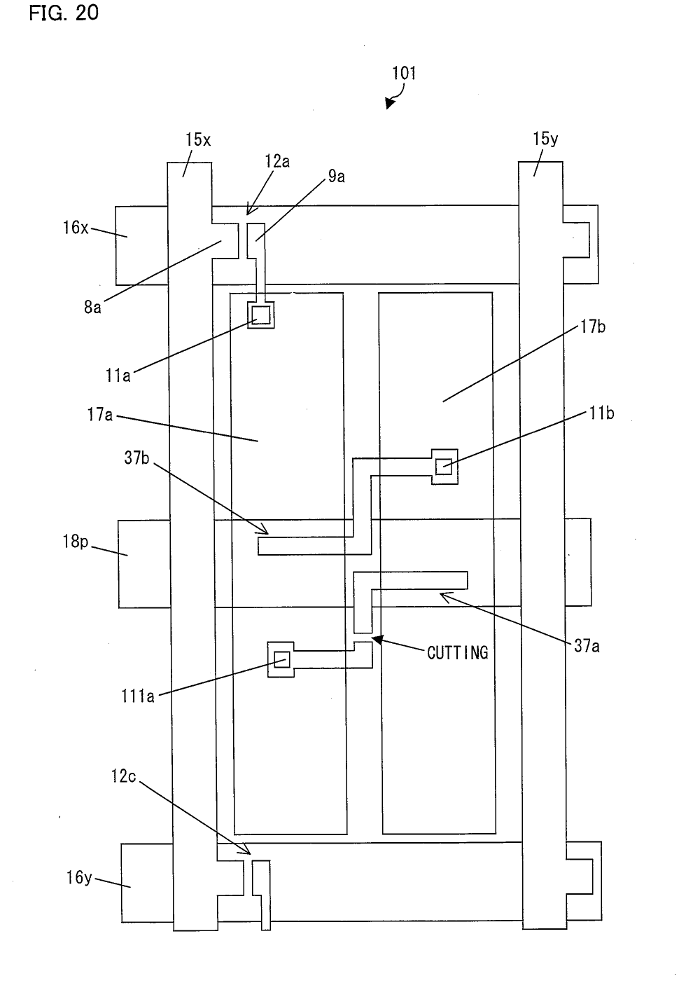

Assume that, e.g., short-circuiting of the capacitor electrode 37a and the retention capacitor wire 18p or the pixel electrode 17b occurred (in a manufacturing step or the like) at P in a liquid crystal panel illustrated in FIG. 19. In this case, as illustrated in FIG. 20, it is possible to irradiate, with a laser, the second part (a part which does not overlap the retention capacitor wire 18p) of the capacitor electrode 37a via the gap between the pixel electrodes 17a and 17b from the top surface side of the active matrix substrate 3 (from the counter side to the glass substrate 31 side) so as to cut the second part.

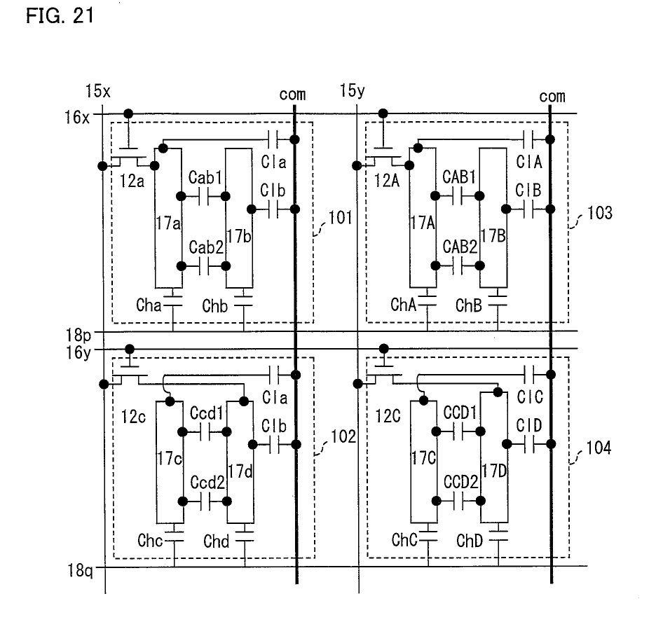

In each of the pixels of the liquid crystal panel illustrated in FIG. 16, a transistor is connected with that one of two pixel electrodes provided in the pixel which is closer to the transistor. However, the present embodiment is not limited to this. That is, as illustrated in FIG. 21, it can be arranged such that in one of two pixels which are adjacent to each other in the column direction, that one of two pixel electrodes which is closer to a corresponding transistor is connected to the transistor whereas in the other of the two pixels, that one of two pixel electrodes which is more distant from a corresponding transistor is connected to the transistor.

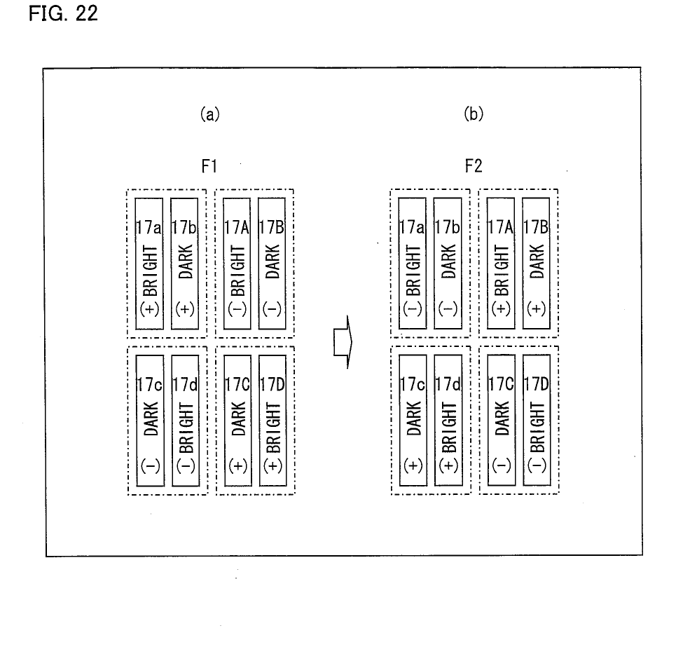

Assume that the data signal lines 15x and 15y are driven, as shown in FIG. 5, in a liquid crystal display apparatus including the liquid crystal panel illustrated in FIG. 21. In this case, in the frame F1, the subpixel containing the pixel electrode 17a (positive polarity) is “bright”; the subpixel containing the pixel electrode 17b (positive polarity) is “dark”; the subpixel containing the pixel electrode 17c (negative polarity) is “dark”; the subpixel containing the pixel electrode 17d (negative polarity) is “bright”; the subpixel containing the pixel electrode 17A (negative polarity) is “bright”; and the subpixel containing the pixel electrode 17B (negative polarity) is “dark.” FIG. 22(a) shows this as a whole. In the frame F2, the subpixel containing the pixel electrode 17a (negative polarity) is “bright”; the subpixel containing the pixel electrode 17b (negative polarity) is “dark”; the subpixel containing the pixel electrode 17c (positive polarity) is “dark”; the subpixel containing the pixel electrode 17d (positive polarity) is “bright”; the subpixel containing the pixel electrode 17A (positive polarity) is “bright”; and the subpixel containing the pixel electrode 17B (positive polarity) is “dark.” FIG. 22(b) shows this as a whole.

In the liquid crystal panel illustrated in FIG. 21, no bright subpixel is adjacent to another bright subpixel in the column direction, and no dark subpixel is adjacent to another dark subpixel in the column direction. This makes it possible to reduce striped display unevenness to be formed in the column direction (i.e., vertical striped display unevenness).

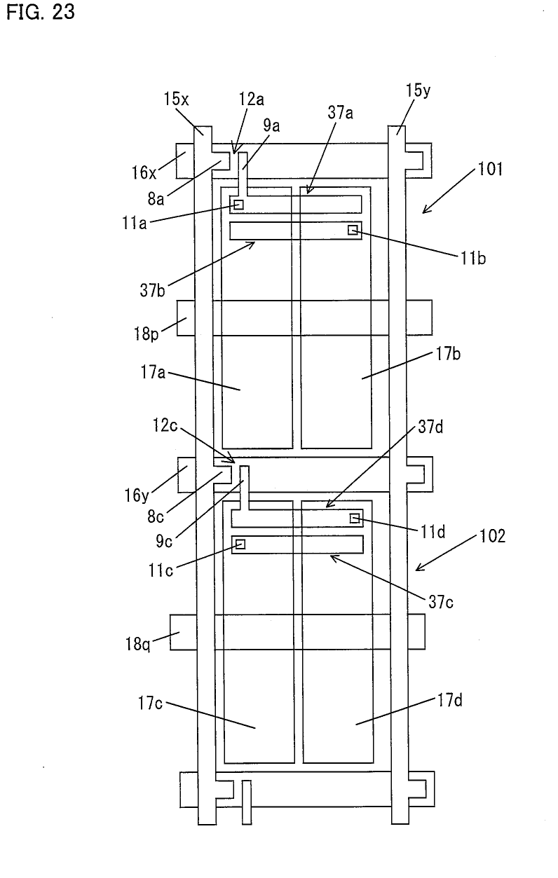

FIG. 23 illustrates a concrete example of the pixels 101 and 102 which are illustrated in FIG. 21. As illustrated in FIG. 23, the transistor 12a is provided in the vicinity of an intersection of the data signal line 15x and the scanning signal line 16x. In a pixel region defined by the data signal line 15x and the scanning signal line 16x, the pixel electrodes 17a and 17b each having a rectangular shape are arranged in the line direction. One of four sides constituting the outer periphery of a first pixel electrode (i.e., pixel electrode 17a) is adjacent to one of four sides constituting the outer periphery of a second pixel electrode (i.e., pixel electrode 17b). Each of the capacitor electrodes 37a and 37b is provided so as to overlap a gap between the one of the four sides constituting the outer periphery of the first pixel electrode and the one of the four sides constituting the outer periphery of the second pixel electrode (i.e., a gap between the pixel electrodes 17a and 17b), and the pixel electrodes 17a and 17b. The retention capacitor wire 18p extends in the line direction so as to cross a center of the pixel 101.

More specifically, each of the capacitor electrodes 37a and 37b has a rectangular shape which extends in the line direction so as to intersect with the gap. The capacitor electrodes 37a and 37b are provided on one side in the pixel 101 (i.e., in the vicinity of the transistor 12a of the pixel 101) so that if the capacitor electrode 37a is rotated by 180° around a point of the gap, the capacitor electrode 37a is substantially located in a place where the capacitor electrode 37b is provided.

The source electrode 8a and the drain electrode 9a of the transistor 12a are formed on the scanning signal line 16x. The source electrode 8a is connected with the data signal line 15x. The drain electrode 9a is connected with the pixel electrode 17a via the contact hole 11a, and also connected with the capacitor electrode 37a. A part of the capacitor electrode 37a and the pixel electrode 17b overlap each other via the interlayer insulating film. The coupling capacitor Cab1 (see FIG. 21) is formed in an area where the part of the capacitor electrode 37a and the pixel electrode 17b overlap each other. The capacitor electrode 37b is connected with the pixel electrode 17b via the contact hole 11b. A part of the capacitor electrode 37b and the pixel electrode 17a overlap each other via the interlayer insulating film. The coupled capacitor Cab2 (see FIG. 21) is formed in an area where the part of the capacitor electrode 37b and the pixel electrode 17a overlap each other. A part of the pixel electrode 17a and the retention capacitor wire 18p overlap each other via the gate insulating film and the interlayer insulating film. Much of the retention capacitor Cha (see FIG. 21) is formed in an area where the part of the pixel electrode 17a and the retention capacitor wire 18p overlap each other. A part of the pixel electrode 17b and the retention capacitor wire 18p overlap each other via the gate insulating film and the interlayer insulating film. Much of the retention capacitor Chb (see FIG. 21) is formed in an area where the part of the pixel electrode 17b and the retention capacitor wire 18p overlap each other.

On the other hand, in the pixel 102, the transistor 12c is provided in the vicinity of an intersection of the data signal line 15x and the scanning signal line 16y. In a pixel region defined by the data signal line 15x and the scanning signal line 16y, the pixel electrodes 17c and 17d each having a rectangular shape are arranged in the line direction. One of four sides constituting the outer periphery of a first pixel electrode (i.e., pixel electrode 17c) is adjacent to one of four sides constituting the outer periphery of a second pixel electrode (i.e., pixel electrode 17d). Each of the capacitor electrodes 37c and 37d is provided so as to overlap a gap between the one of the four sides constituting the outer periphery of the first pixel electrode and the one of the four sides constituting the outer periphery of the second pixel electrode (i.e., a gap between the pixel electrodes 17c and 17d), and the pixel electrodes 17c and 17d. The retention capacitor wire 18q extends in the line direction so as to cross a center of the pixel 102.

More specifically, each of the capacitor electrodes 37c and 37d has a rectangular shape which extends in the line direction so as to intersect with the gap. The capacitor electrodes 37c and 37d are provided on one side in the pixel 102 (i.e., in the vicinity of the transistor 12c of the pixel 102) so that if the capacitor electrode 37c is rotated by 180° around a point of the gap, the capacitor electrode 37c is substantially located in a place where the capacitor electrode 37d is provided.

The source electrode 8c and the drain electrode 9c of the transistor 12c are formed on the scanning signal line 16y. The source electrode 8c is connected with the data signal line 15x. The drain electrode 9c is connected with the pixel electrode 17c via the contact hole 11c, and also connected with the capacitor electrode 37c. A part of the capacitor electrode 37c and the pixel electrode 17d overlap each other via the interlayer insulating film. The coupling capacitor Ccd1 (see FIG. 21) is formed in an area where the part of the capacitor electrode 37c and the pixel electrode 17d overlap each other. The capacitor electrode 37d is connected with the pixel electrode 17d via the contact hole 11d. A part of the capacitor electrode 37d and the pixel electrode 17c overlap each other via the interlayer insulating film. The capacitor electrode Ccd2 (see FIG. 21) is formed in an area where the part of the capacitor electrode 37d and the pixel electrode 17c overlap each other. A part of the pixel electrode 17c and the retention capacitor wire 18q overlap each other via the gate insulating film and the interlayer insulating film. Much of the retention capacitor Chc (see FIG. 21) is formed in an area where the part of the pixel electrode 17c and the retention capacitor wire 18q overlap each other. A part of the pixel electrode 17d and the retention capacitor wire 18q overlap each other via the gate insulating film and the interlayer insulating film. Much of the retention capacitor Chd (see FIG. 21) is formed in an area where the part of the pixel electrode 17d and the retention capacitor wire 18q overlap each other.

### Third Embodiment

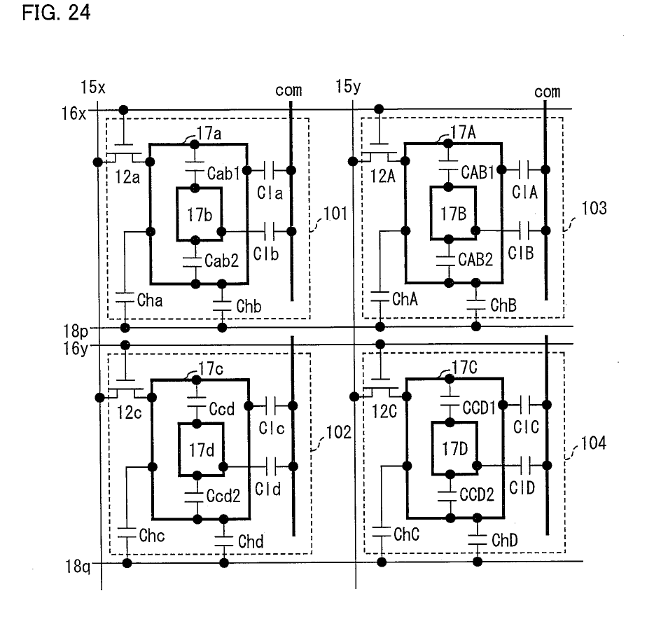

FIG. 24 is an equivalent circuit diagram illustrating a part of a liquid crystal panel of a third embodiment. As illustrated in FIG. 24, the liquid crystal panel includes: data signal lines (15x and 15y) which extend in the column direction (i.e., longitudinal direction in FIG. 1); scanning signal lines (16x and 16y) which extend in the line direction (i.e., transverse direction in FIG. 1); pixels (101 through 104) arranged in the line and column directions; retention capacitor wires (18p and 18q); and a common electrode (counter electrode) com. The pixels have an identical arrangement. A column of pixels which contains the pixels 101 and 102 is adjacent to a column of pixels which contains the pixels 103 and 104. A line of pixels which contains the pixels 101 and 103 is adjacent to a line of pixels which contains the pixels 102 and 104.

In the liquid crystal panel, one data signal line and one scanning signal line are provided for one pixel. Two pixel electrodes are provided in one pixel so that one of the two pixel electrodes surrounds and encloses the other one. In a pixel 101, a pixel electrode 17b and a pixel electrode 17a which surrounds and encloses the pixel electrode 17b are provided. In a pixel 102, a pixel electrode 17d and a pixel electrode 17c which surrounds and encloses the pixel electrode 17d are provided. In a pixel 103, a pixel electrode 17B and a pixel electrode 17A which surrounds and encloses the pixel electrode 17B are provided. In a pixel 104, a pixel electrode 17D and a pixel electrode 17C which surrounds and encloses the pixel electrode 17D are provided.

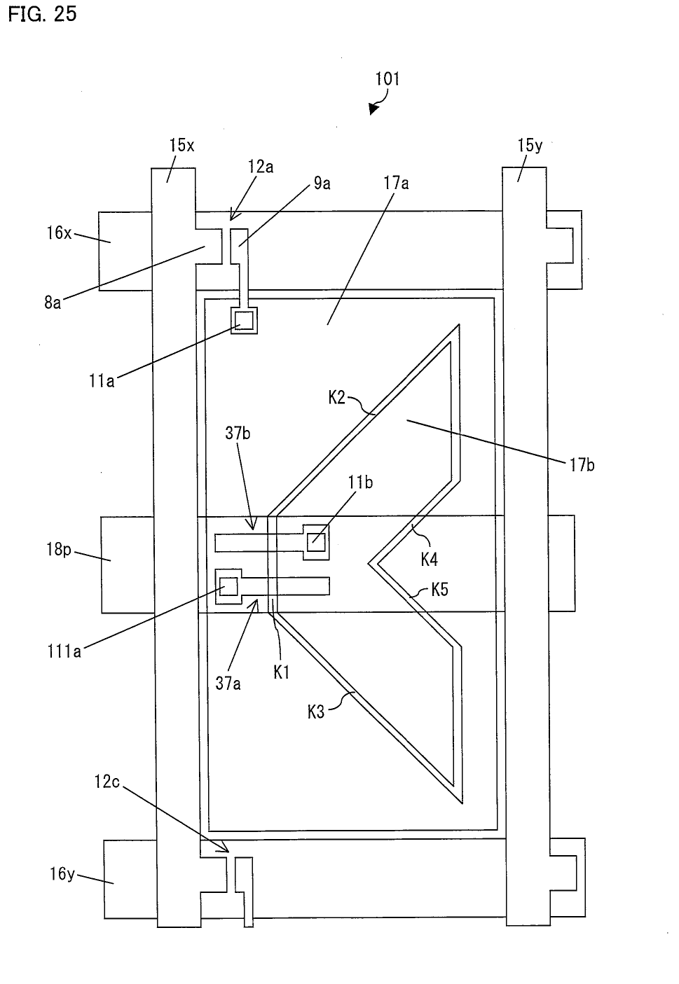

FIG. 25 illustrates a concrete example of the pixel 101 illustrated in FIG. 24. As illustrated in FIG. 25, a transistor 12a is provided in the vicinity of an intersection of a data signal line 15x and a scanning signal line 16x. The pixel electrode 17b which has a V-shape as viewed from a line direction, and the pixel electrode 17a which surrounds and encloses the pixel electrode 17b are provided in a pixel region defined by the data signal line 15x and the scanning signal line 16x. The retention capacitor wire 18p extends in the line direction so as to cross a center of the pixel 101. Specifically, the pixel electrode 17b includes: a first side which is provided on the retention capacitor wire 18p and is at an angle of substantially 90° with respect to the line direction; a second side which extends from one end of the first side at an angle of substantially 45° with respect to the line direction; a third side which extends from the other end of the first side at an angle of substantially 315° with respect to the line direction; a forth side whose one end lies on the retention capacitor wire 18p and which forth side is parallel to and shorter than the second side; a fifth side connected with one end of the fourth side which fifth side is parallel to and shorter than the third side; a sixth side connecting the second side with the fourth side; and a seventh side connecting the third side with the fifth side. An inner periphery of the pixel electrode 17a includes seven sides respectively facing the first through seventh sides.

A gap between the first side of the pixel electrode 17b and one side of the inner periphery of the pixel electrode 17a which one side faces the first side is a first gap K1. A gap between the second side of the pixel electrode 17b and one side of the inner periphery of the pixel electrode 17a which one side faces the second side is a second gap K2. A gap between the third side of the pixel electrode 17b and one side of the inner periphery of the pixel electrode 17a which one side faces the third side is a third gap K3. A gap between the fourth side of the pixel electrode 17b and one side of the inner periphery of the pixel electrode 17a which one side faces the fourth side is a fourth gap K4. A gap between the fifth side of the pixel electrode 17b and one side of the inner periphery of the pixel electrode 17a which one side faces the fifth side is a fifth gap K5. Each of the capacitor electrode 37a and 37b is provided so as to overlap the first gap K1, and the pixel electrodes 17a and 17b.

More specifically, each of the capacitor electrodes 37a and 37b has a shape which extends in the line direction so as to intersect with the first gap K1. The capacitor electrodes 37a and 37b are provided on the retention capacitor wire 18p so that if the capacitor electrode 37a is rotated by 180° around a point of the first gap K1, the capacitor electrode 37a is substantially located in a place where the capacitor electrode 37b is provided.

A source electrode 8a and a drain electrode 9a of the transistor 12a are formed on the scanning signal line 16x. The source electrode 8a is connected with the data signal line 15x. The drain electrode 9a is connected with the pixel electrode 17a via the contact hole 11a. The capacitor electrode 37a is connected with the pixel electrode 17a via the contact hole 111a. A part of the capacitor electrode 37a and the pixel electrode 17b overlap each other via the interlayer insulating film. The coupling capacitor Cab1 (see FIG. 24) is formed in an area where the part of the capacitor electrode 37a and the pixel electrode 17b overlap each other. The capacitor electrode 37b is connected with the pixel electrode 17b via the contact hole 11b. A part of the capacitor electrode 37b and the pixel electrode 17a overlap each other via the interlayer insulating film. The coupling capacitor Cab2 (see FIG. 24) is formed in an area where the part of the capacitor electrode 37b and the pixel electrode 17a overlap each other.

The capacitor electrode 37a and the retention capacitor wire 18p overlap each other via the gate insulating film. The retention capacitor Cha (see FIG. 24) is formed in an area where the capacitor electrode 37a and the retention capacitor wire 18p overlap each other. The capacitor electrode 37b and the retention capacitor wire 18p overlap each other via the gate insulating film. The retention capacitor Chb (see FIG. 24) is formed in an area where the capacitor electrode 37b and the retention capacitor wire 18p overlap each other.

In a liquid crystal panel illustrated in FIG. 25, the pixel electrodes 17a and 17b are connected (capacitatively coupled) with each other via two coupling capacitors (Cab1 and Cab2). Therefore, if, e.g., short-circuiting of the capacitor electrode 37a and the retention capacitor wire 18p or the pixel electrode 17b occurred (in a manufacturing step or the like), a correction step is carried out in which the capacitor electrode 37a is cut by a laser between the contact hole 111a and a part where the short-circuiting occurred. This makes it possible to maintain a state in which the pixel electrodes 17a and 17b are connected with each other via the capacitors. In addition, even if the contact hole 111a becomes defective in a manufacturing process or the like, it is possible to maintain a state in which the pixel electrodes 17a and 17b each of which receives a signal potential from the data signal line 15x are connected with each other via the coupling capacitors. If short-circuiting of the capacitor electrode 37b and the retention capacitor wire 18p or the pixel electrode 17a occurred, the capacitor electrode 37b is cut by a laser between the contact hole 11b and a part where the short-circuiting occurred.

In the correction step, the first part of the capacitor electrode 37a is irradiated with a laser via the gap from the top surface side of the active matrix substrate 3 (from the counter side to the glass substrate 31 side) so as to be cut. In this case, there is concern that another short-circuiting of the capacitor electrode 37a and the retention capacitor wire 18p can occur. In order that the concern is eliminated, an aperture can be formed in the retention capacitor wire 18p so as to overlap the first gap K1.

Alternatively, if short-circuiting of the capacitor electrode 37a and the retention capacitor wire 18p or the pixel electrode 17b occurred, a part of the pixel electrode 17a in the contact hole 111a is removed (trimmed) by a laser or the like so that the pixel electrode 17a and the capacitor electrode 37a are electrically separated. This also makes it possible to maintain a state in which the pixel electrodes 17a and 17b each of which receives a signal potential from the data signal line 15x are connected with each other via the coupling capacitors.

Thus, the present embodiment makes it possible to improve a manufacturing yield of a liquid crystal panel and an active matrix substrate to be provided in the liquid crystal panel.

Further, the liquid crystal panel illustrated in FIG. 25 is arranged such that if the capacitor electrode 37a is rotated by 180° around a point of the first gap K1, the capacitor electrode 37a is substantially located in a place where the capacitor electrode 37b is provided. Therefore, even if the pixel electrodes 17a and 17b become misaligned with respect to the capacitor electrodes 37a and 37b in a direction perpendicular to the first gap K1 (i.e., in the line direction), an area where the capacitor electrode 37a and the pixel electrode 17b overlap each other and an area where the capacitor electrode 37b and the pixel electrode 17a overlap each other complement each other. This is advantageous in that a total amount of capacitances of the two coupling capacitors (Cab1 and Cab2) is unlikely to change.

Further, in the liquid crystal panel illustrated in FIG. 25, the capacitor electrode 37a and each of the pixel electrode 17b and the retention capacitor wire 18p overlap each other, and the capacitor electrode 37b and each of the pixel electrode 17a and the retention capacitor wire 18p overlap each other. Thus, the capacitor electrodes 37a and 37b provided for forming the coupling capacitors also serve as electrodes for forming retention capacitors. This makes it possible to increase an aperture ratio.

Further, in the liquid crystal panel illustrated in FIG. 25, the pixel electrode 17a surrounds and encloses the pixel electrode 17b which is electrically floating. Accordingly, the pixel electrode 17a can serve as a shield electrode so as to prevent problems such as diving of an electric charge into the pixel electrode 17b. This makes it possible to prevent image sticking of the subpixel (dark subpixel) containing the pixel electrode 17b.

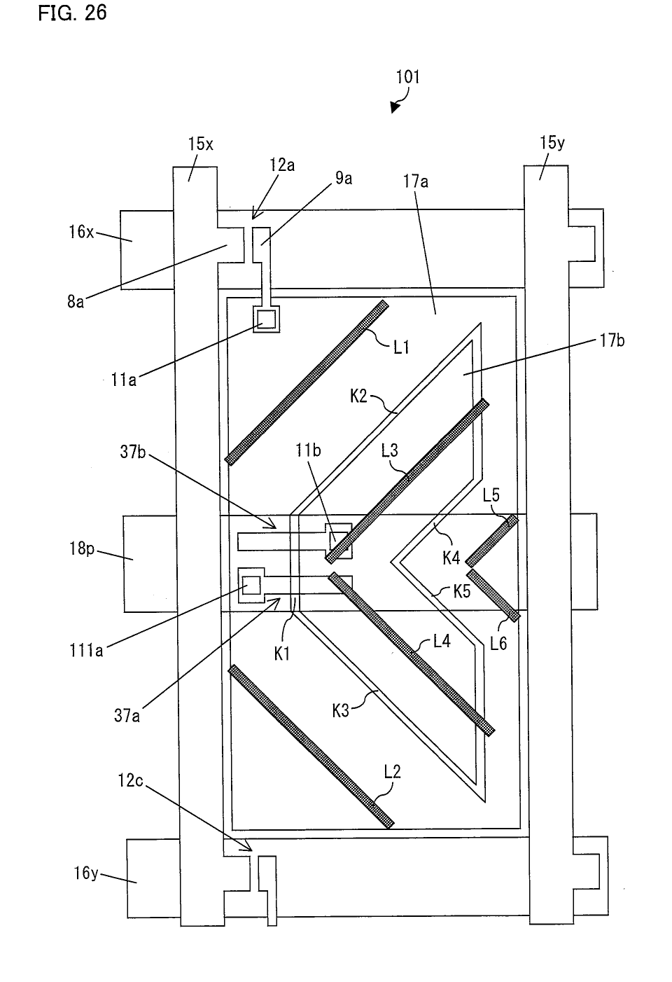

FIG. 25 omits to illustrate an alignment-controlling structure. However, as illustrated in FIG. 26 for example, in the case of, e.g., a liquid crystal panel of an MVA (Multi-domain Vertical Alignment) method, the gaps K2 through K5 between the pixel electrodes 17a and 17b serve as alignment-controlling structures; a rib L3 which is parallel to the gaps K2 and K4 and a rib L4 which is parallel to the gaps K3 and K5 are provided to that area of the color filter substrate which positionally corresponds to the pixel electrode 17b; and ribs L1 and L5 which are parallel to the gaps K2 and K4 and, ribs L2 and L6 which are parallel to the gaps K3 and K5 are provided to that area of the color filter substrate which positionally corresponds to the pixel electrode 17a. Instead of such ribs for alignment control, slits for alignment control can be provided to the common electrode of the color filter substrate.

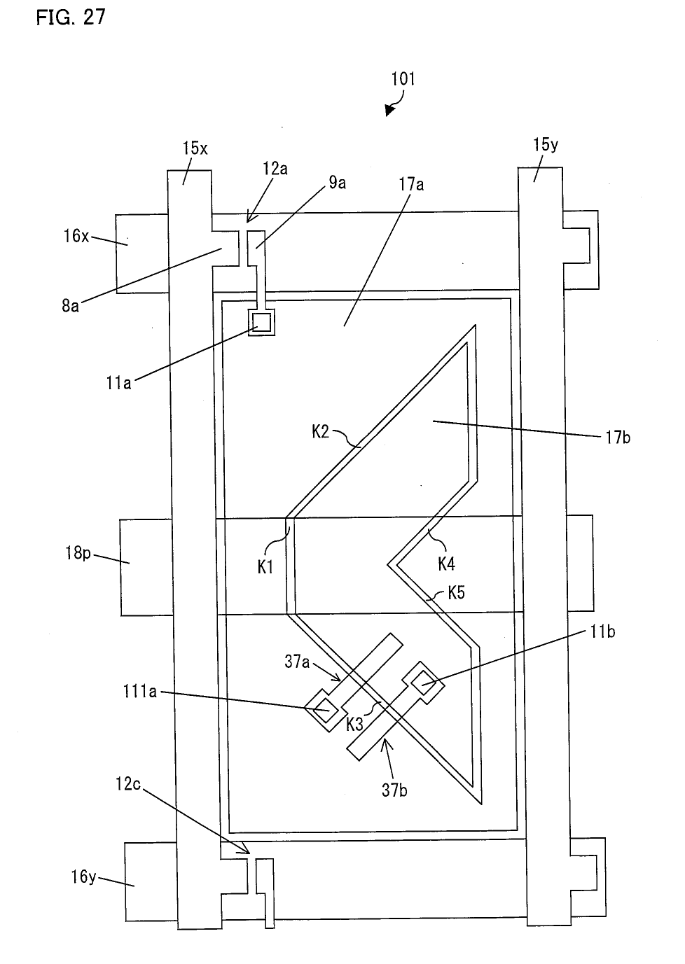

The pixel 101 illustrated in FIG. 25 can be modified as illustrated in FIG. 27. According to the arrangement illustrated in FIG. 27, each of the capacitor electrodes 37a and 37b has a shape which extends in the line direction at an angle of 315° with respect to the line direction so as to intersect with the third gap K3. The capacitor electrodes 37a and 37b are provided so that if the capacitor electrode 37a is rotated by 180° around a point of the third gap K3, the capacitor electrode 37a is substantially located in a place where the capacitor electrode 37b is provided. Neither the capacitor electrodes 37a nor 37b and the retention capacitor wire 18p overlap each other.

The drain electrode 9a of the transistor 12a is connected with the pixel electrode 17a via the contact hole 11a. The capacitor electrode 37a is connected with the pixel electrode 17a via the contact hole 111a. A part of the capacitor electrode 37a and the pixel electrode 17b overlap each other via the interlayer insulating film. The coupling capacitor Cab1 (see FIG. 24) is formed in an area where the part of the capacitor electrode 37a and the pixel electrode 17b. The capacitor electrode 37b is connected with the pixel electrode 17b via the contact hole 11b. A part of the capacitor electrode 37b and the pixel electrode 17a overlap each other via the interlayer insulating film. The coupling capacitor Cab2 (see FIG. 24) is formed in an area where the part of the capacitor electrode 37b and the pixel electrode 17a overlap each other. A part of the pixel electrode 17a and the retention capacitor wire 18p overlap each other via the gate insulating film and the interlayer insulating film. The retention capacitor Cha (see FIG. 24) is formed in an area where the part of the pixel electrode 17a and the retention capacitor wire 18p overlap each other. A part of the pixel electrode 17b and the retention capacitor wire 18p overlap each other via the gate insulating film and the interlayer insulating film. The retention capacitor Chb (see FIG. 24) is formed in an area where the part of the pixel electrode 17a and the retention capacitor wire 18p overlap each other.

If short-circuiting of the capacitor electrode 37a and the pixel electrode 17b occurs (in a manufacturing step or the like) in the liquid crystal panel illustrated in FIG. 27, the capacitor electrode 37a (which does not overlap the retention capacitor wire 18p) can be irradiated with a laser from the top surface side of the active matrix substrate 3 (from the counter side to the glass substrate 31 side) via the third gap K3 so as to be cut. Alternatively, a part in the contact hole 111a of the pixel electrode 17a can be removed (trimmed) by a laser or the like so that the pixel electrode 17a and the capacitor electrode 37a are electrically separated.

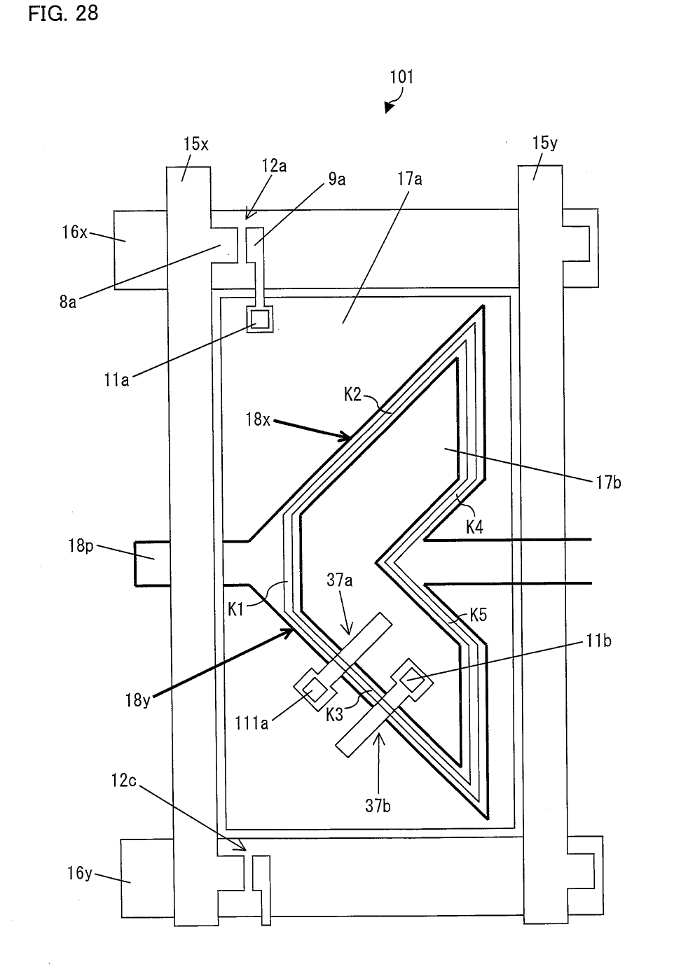

The pixel 101 illustrated in FIG. 27 can be modified as illustrated in FIG. 28. According to the arrangement illustrated in FIG. 28, the pixel 101 includes: a retention capacitor wire extension 18x which extends from the retention capacitor wire 18p so as to overlap the first side, the second side, the sixth side, and the fourth side of the pixel electrode 17b and then meet the retention capacitor wire 18p; and a retention capacitor wire extension 18y which extends from the retention capacitor wire 18p so as to overlap the first side, the third side, the seventh side, and the fifth side of the pixel electrode 17b and then meet the retention capacitor wire 18p.

In a liquid crystal panel illustrated in FIG. 28, the retention capacitor wire extensions 18x and 18y which surround and enclose the pixel electrode 17b which is electrically floating serve as a shield electrode. This makes it possible to prevent problems such as diving of an electric charge into the pixel electrode 17b more effectively. As a result, this makes it possible to prevent image sticking of the subpixel (dark subpixel) containing the pixel electrode 17b.

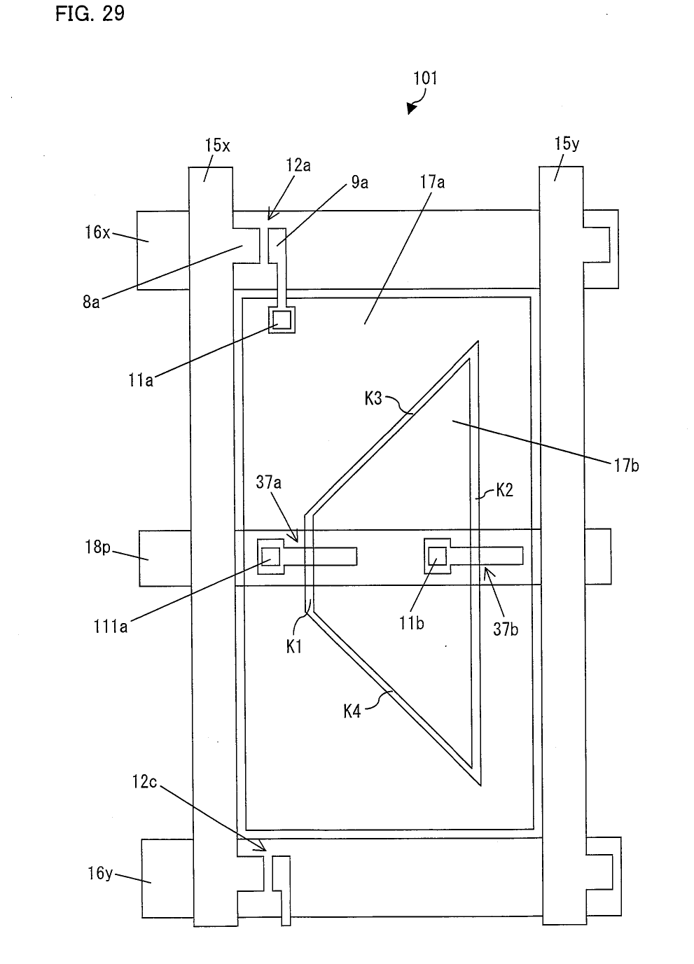

FIG. 29 illustrates a concrete example of the pixel 101 illustrated in FIG. 24. As illustrated in FIG. 29, the transistor 12a is provided in the vicinity of an intersection of the data signal line 15x and the scanning signal line 16x. In a pixel region defined by the data signal line 15x and the scanning signal line 16x, the pixel electrode 17b which has a trapezoidal shape as viewed from the line direction, and the pixel electrode 17a which surrounds and encloses the pixel electrode 17b are provided. The retention capacitor wire 18p extends in the line direction so as to cross a center of the pixel 101. Specifically, the pixel electrode 17b includes: a first side which intersects with the retention capacitor wire 18p and forms an angle of substantially 90° with respect to the line direction; a second side which is parallel to the first side and interests with the retention capacitor wire 18p; a third side which extends from one end of the first side at an angle of substantially 45° with respect to the line direction; and a fourth side which extends from the other end of the first side at an angle of substantially 315° with respect to the line direction. An inner periphery of the pixel electrode 17a includes four sides respectively facing the first through fourth sides. An outer periphery of the pixel electrode 17a has a rectangular shape.

A gap between the first side of the pixel electrode 17b and one side of the inner periphery of the pixel electrode 17a which one side faces the first side is a first gap K1. A gap between the second side of the pixel electrode 17b and one side of the inner periphery of the pixel electrode 17a which one side faces the second side is a second gap K2. The capacitor electrode 37a is provided so as to overlap the pixel electrode 17a, the first gap K1, and the pixel electrode 17b. The capacitor electrode 37b is provided so as to overlap the pixel electrode 17b, the second gap K2, and the pixel electrode 17a.

More specifically, the capacitor electrode 37a has a shape which extends in the line direction so as to intersect with the first gap K1. The capacitor electrode 37b has a shape which extends in the line direction so as to intersect with the second gap K2. The capacitor electrodes 37a and 37b are arranged in the line direction so as to overlap the retention capacitor wire 18p.

The source electrode 8a and the drain electrode 9a of the transistor 12a are formed on the scanning signal line 16x. The source electrode 8a is connected with the data signal line 15x. The drain electrode 9a is connected with the pixel electrode 17a via the contact hole 11a. The capacitor electrode 37a is connected with the pixel electrode 17a via the contact hole 111a. A part of the capacitor electrode 37a and the pixel electrode 17b overlap each other via the interlayer insulating film. The coupling capacitor Cab1 (see FIG. 24) is formed in an area where the part of the capacitor electrode 37a and the pixel electrode 17b overlap each other. The capacitor electrode 37b is connected with the pixel electrode 17b via the contact hole 11b. A part of the capacitor electrode 37b and the pixel electrode 17a overlap each other via the interlayer insulating film. The coupling capacitor Cab2 (see FIG. 24) is formed in an area where the part of the capacitor electrode 37b and the pixel electrode 17a overlap each other.

The capacitor electrode 37a and the retention capacitor wire 18p overlap each other via the gate insulating film. The retention capacitor Cha (see FIG. 24) is formed in an area where the capacitor electrode 37a and the retention capacitor wire 18p overlap each other. The capacitor electrode 37b and the retention capacitor wire 18p overlap each other via the gate insulating film. The retention capacitor Chb (see FIG. 24) is formed in an area where the capacitor electrode 37b and the retention capacitor wire 18p overlap each other.

In a liquid crystal panel illustrated in FIG. 29, the pixel electrodes 17a and 17b are connected (capacitatively coupled) via two coupling capacitors (Cab1 and Cab2). Therefore, if, for example, short-circuiting of the capacitor electrode 37a and the retention capacitor wire 18p or the pixel electrode 17b occurred (in a manufacturing step or the like), a correction step is carried out in which the capacitor electrode 37a is cut by a laser between the contact hole 111a and a part where the short-circuiting occurred. This also makes it possible to maintain a state in which the pixel electrodes 17a and 17b each of which receives a signal potential from the data signal line 15x are connected with each other via the coupling capacitors. If short-circuiting of the capacitor electrode 37b and the retention capacitor wire 18p or the pixel electrode 17a, the capacitor electrode 37b is cut by a laser between the contact hole 11b and a part where the short-circuiting occurred.

In the correction step, the capacitor electrode 37a is irradiated with a laser via the first gap K1 from the top surface side of the active matrix substrate 3 (from the counter side to the glass substrate 31 side) so as to be cut. In this case, there is concern that another short-circuiting occurs between the capacitor electrode 37a and the retention capacitor wire 18p. In order that the concern is eliminated, an aperture is formed in the retention capacitor wire 18p so as to overlap the first gap K1.

Alternatively, if short-circuiting of the capacitor electrode 37a and the retention capacitor wire 18p or the pixel electrode 17b occurred, a part in the contact hole 111a of the pixel electrode 17a is removed (trimmed) by a laser or the like so that the pixel electrode 17a and the capacitor electrode 37a are electrically separated. This also makes it possible to maintain a state in which the pixel electrodes 17a and 17b each of which receives a signal potential from the data signal line 15x are connected with each other via the coupling capacitors.

Thus, the present embodiment makes it possible to improve a manufacturing yield of a liquid crystal panel and an active matrix substrate to be provided in the liquid crystal panel.

Further, in the liquid crystal panel illustrated in FIG. 29, the capacitor electrode 37a and each of the pixel electrode 17b and the retention capacitor wire 18p overlap each other while the capacitor electrode 37b and each of the pixel electrode 17a and the retention capacitor wire 18p overlap each other. Thus, the capacitor electrodes 37a and 37b provided for forming the coupling capacitors also serve as electrodes for forming retention capacitors. This makes it possible to increase an aperture ratio.

Further, the capacitor electrodes 37a and 37b each have the shape extending in the line direction, and are arranged in the line direction so as to overlap the retention capacitor wire 18p. This makes it possible to reduce a line width of the retention capacitor wire 18p. As a result, the aperture ratio can be further increased.

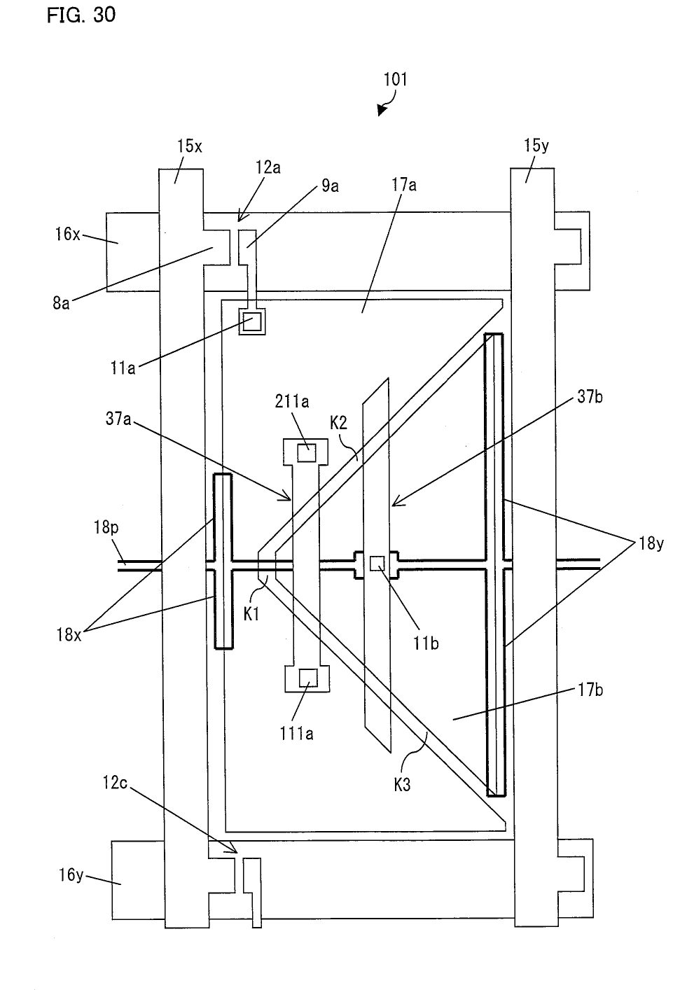

FIG. 30 illustrates a concrete example of the pixel 101 illustrated in FIG. 24. As illustrated in FIG. 30, the transistor 12a is provided in the vicinity of an intersection of the data signal line 15x and the scanning signal line 16x. In a pixel region defined by the data signal line 15x and the scanning signal line 16x, the pixel electrode 17b which has a trapezoidal shape as viewed from the line direction and the pixel electrode 17a which has a shape engaging with the trapezoidal shape are arranged in the line direction. The retention capacitor wire 18p extends in the line direction so as to cross a center of the pixel 101. Specifically, the pixel electrode 17b includes: a first side which intersects with the retention capacitor wire 18p and forms an angle of substantially 90° with respect to the line direction; a second side which extends in the line direction from one end of the first side at an angle of substantially 45° with respect to the line direction; a third side which extends from the other end of the first side at an angle of substantially 315° with respect to the line direction; and a fourth side which is parallel to the first side and intersects with the retention capacitor wire 18p. A line connecting a midpoint of the first side with a midpoint of the fourth side runs on the retention capacitor wire 18p.

An outer periphery of the pixel electrode 17a includes four sides respectively facing the first through fourth sides. A gap between the first side of the pixel electrode 17b and one side of the inner periphery of the pixel electrode 17a which one side faces the first side is a first gap K1. A gap between the second side of the pixel electrode 17b and one side of the inner periphery of the pixel electrode 17a which one side faces the second side is a second gap K2. A gap between the third side of the pixel electrode 17b and one side of the inner periphery of the pixel electrode 17a which one side faces the third side is a third gap K3. The capacitor electrode 37a is provided so as to overlap the pixel electrode 17a, the second gap K2, the pixel electrode 17b, and the third gap K3. The capacitor electrode 37b is provided so as to overlap the pixel electrode 17a, the second gap K2, the pixel electrode 17b, and the third gap K3.

More specifically, the capacitor electrode 37a has a shape extending in the column direction so as to pass under the second gap K2 and the third gap K3. The capacitor electrode 37b also has a shape extending in the column direction so as to pass under the second gap K2 and the third gap K3. Each of the capacitor electrodes 37a and 37b has line symmetry with respect to an axis which is the line connecting the midpoint of the first side and the midpoint of the fourth side. In particular, the capacitor electrode 37b has a trapezoidal shape whose upper base and lower base are two sides parallel to the first side and the fourth side of the pixel electrode 17b. Two sides of the pixel electrode 37b which are legs of the trapezoidal shape are parallel to the second side and the third side of the pixel electrode 17b, respectively.

The source electrode 8a and the drain electrode 9a of the transistor 12a are formed on the scanning signal line 16x. The source electrode 8a is connected with the data signal line 15x. The drain electrode 9a is connected with the pixel electrode 17a via the contact hole 11a. One end of the capacitor electrode 37a is connected with the pixel electrode 17a via the contact hole 111a while the other end is connected with the pixel electrode 17a via the contact hole 211a. A part of the capacitor electrode 37a and the pixel electrode 17b overlap each other via the interlayer insulating film. The coupling capacitor Cab1 (see FIG. 24) is formed in an area where the part of the capacitor electrode 37a and the pixel electrode 17b overlap each other. The capacitor electrode 37b is connected with the pixel electrode 17b via the contact hole 11b. Both end portions of the capacitor electrode 37b and the pixel electrode 17a overlap each other via the interlayer insulating film. The coupling capacitor Cab2 (see FIG. 24) is formed in each of areas where both end portions of the capacitor electrode 37b and the pixel electrode 17a overlap each other.

The retention capacitor Cha (see FIG. 24) is formed in an area where the capacitor electrode 37a and the retention capacitor wire 18p overlap each other and in an area where the pixel electrode 17a and the retention capacitor wire 18p overlap each other. The retention capacitor Chb (see FIG. 24) is formed in an area where the capacitor electrode 37b and the retention capacitor wire 18p overlap each other and in an area where the pixel electrode 17b and the retention capacitor wire 18p overlap each other.

In addition, the pixel 101 includes: a retention capacitor wire extension 18x which extends along the data signal line 15y from the retention capacitor wire 18p so as to overlap the fourth side of the pixel electrode 17b; and a retention capacitor wire extension 18y which extends along the data signal line 15x from the retention capacitor wire 18p so as to overlap the outer periphery of the pixel electrode 17a.

In a liquid crystal panel illustrated in FIG. 30, the pixel electrodes 17a and 17b are connected (capacitatively coupled) via two coupling capacitors (Cab1 and Cab2). Therefore, if, for example, short-circuiting of the capacitor electrode 37a and the retention capacitor wire 18p or the pixel electrode 17b occurred (in a manufacturing step or the like), a correction step is carried out in which the capacitor electrode 37a is cut by a laser between the contact hole 111a and a part where the short-circuiting occurred or between the contact hole 211a and the part. This also makes it possible to maintain a state in which the pixel electrodes 17a and 17b each of which receives a signal potential from the data signal line 15x are connected with each other via the coupling capacitors. In addition, even if the contact holes 111a and/or 211a become defective in a manufacturing process or the like, it is possible to maintain a state in which the pixel electrodes 17a and 17b each of which receives a signal potential from the data signal line 15x are connected with each other via the coupling capacitors. If short-circuiting of the capacitor electrode 37b and the retention capacitor wire 18p or the pixel electrode 17a occurred, the capacitor electrode 37b is cut by a laser between the contact hole 11b and a part where the short-circuiting occurred.

In the correction step, the capacitor electrode 37a is irradiated with a laser via the second gap K2 or the third gap K3 from the top surface side of the active matrix substrate 2 (i.e., from the counter side to the glass substrate 31 side) so as to be cut. Thus, the present embodiment makes it possible to improve a manufacturing yield of a liquid crystal panel and an active matrix substrate to be provided in the liquid crystal panel.

In the liquid crystal panel illustrated in FIG. 30, each of the capacitor electrodes 37a and 37b has line symmetry with respect to the axis which is the line connecting the midpoint of the first side and the midpoint of the fourth side. Therefore, even if the pixel electrodes 17a and 17b become misaligned with respect to the capacitor electrodes 37a and 37b in a direction perpendicular to the axis (i.e., in the column direction), an area where the capacitor electrode 37a and the pixel electrode 17b overlap each other and an area where the capacitor electrode 37b and the pixel electrode 17a overlap each other complement each other. This is advantageous in that a total amount of capacitances of the two coupling capacitors (Cab1 and Cab2) is unlikely to change.

In addition, the retention capacitor wire extensions 18x and 18y which overlap the pixel electrode 17b which is electrically floating serve as a shield electrode of the pixel electrode 17a. This makes it possible to prevent problems such as diving of an electric charge into the pixel electrode 17b more effectively. This makes it possible to prevent image sticking of the subpixel (dark subpixel) containing the pixel electrode 17b.

In a case where the liquid crystal panel illustrated in FIG. 30 is used as that of the MVA method, it is possible to use the second gap K2 or the third gap K3 as an alignment-controlling structure.

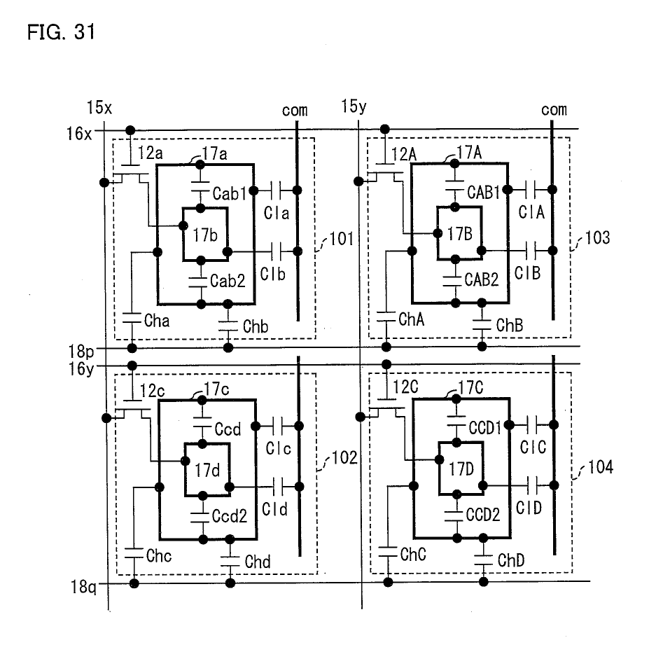

In FIG. 24, one of two pixel electrodes provided in one pixel surrounds and encloses the other one of the two pixel electrodes, and is connected with a corresponding transistor. However, the present embodiment is not limited to this. Alternatively, as illustrated in FIG. 31, the other one of the two pixel electrodes can be connected with the corresponding transistor.

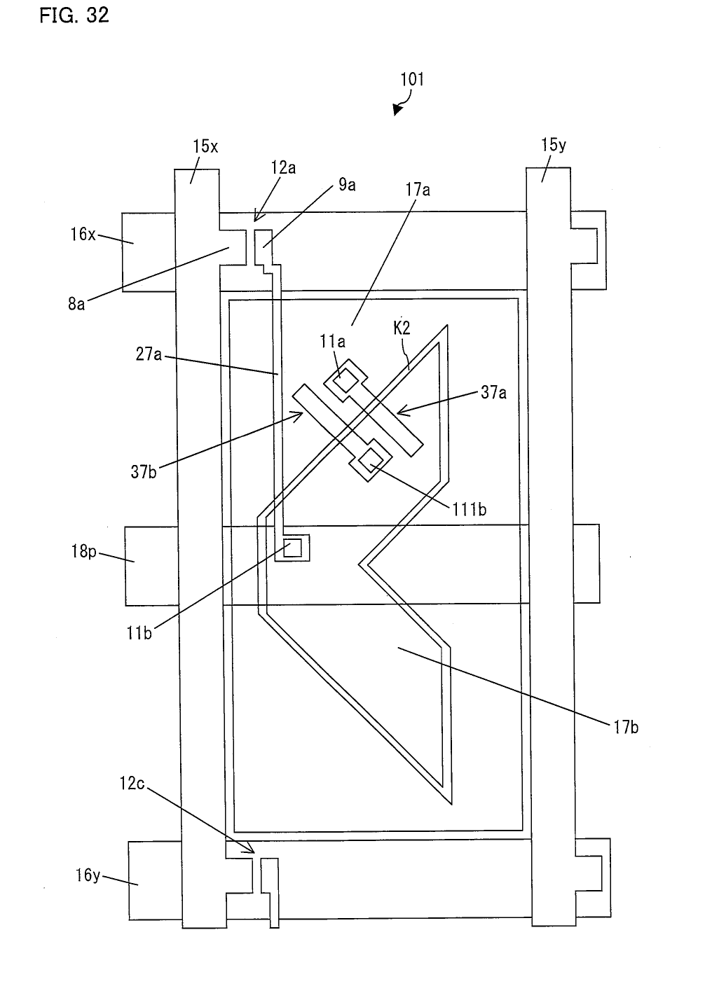

FIG. 32 illustrates a concrete example of the pixel 101 illustrated in FIG. 31. As illustrated in FIG. 32, the pixel electrodes 17a and 17b, and the retention capacitor wire 18p are shaped and located in the same manner as the arrangement illustrated in FIG. 25. Each of the capacitor electrodes 37a and 37b is provided so as to overlap the second gap K2, and the pixel electrodes 17a and 17b.

More specifically, each of the capacitor electrodes 37a and 37b has a shape which extends in the line direction so as to intersect with the second gap K2. The capacitor electrodes 37a and 37b are provided on the retention capacitor wire 18p so that if the capacitor electrode 37a is rotated by 180° around a point of the second gap K2, the capacitor electrode 37a is substantially located in a place where the capacitor electrode 37b is provided.

The source electrode 8a and the drain electrode 9a of the transistor 12a are formed on the scanning signal line 16x. The source electrode 8a is connected with the data signal line 15x. The drain electrode 9a is connected with the pixel electrode 17b via the drain drawing wire 27a and the contact hole 11b. The capacitor electrode 37b is connected with the pixel electrode 17b via the contact hole 111b. A part of the capacitor electrode 37b and the pixel electrode 17a overlap each other via the interlayer insulating film. The coupling capacitor Cab1 (see FIG. 31) is formed in an area where the part of the capacitor electrode 37b and the pixel electrode 17a overlap each other. The capacitor electrode 37a is connected with the pixel electrode 17a via the contact hole 11a. A part of the capacitor electrode 37a and the pixel electrode 17b overlap each other via the interlayer insulating film. The coupling capacitor Cab2 (see FIG. 31) is formed in an area where the part of the capacitor electrode 37a and the pixel electrode 17b overlap each other. A part of the pixel electrode 17a and the retention capacitor wire 18p overlap each other via the gate insulating film and the interlayer insulating film. The retention capacitor Cha (see FIG. 31) is formed in an area where the part of the pixel electrode 17a and the retention capacitor wire 18p overlap each other. A part of the pixel electrode 17b and the retention capacitor wire 18p overlap each other via the gate insulating film and the interlayer insulating film. The retention capacitor Chb (see FIG. 31) is formed in an area where the part of the pixel electrode 17b and the retention capacitor wire 18p overlap each other.

In a liquid crystal panel illustrated in FIG. 32, the pixel electrodes 17a and 17b are connected (capacitatively coupled) via two coupling capacitors (Cab1 and Cab2). Therefore, if, e.g., short-circuiting of the capacitor electrode 37b and the pixel electrode 17a occurred (in a manufacturing step or the like), a correction step is carried out in which the capacitor electrode 37b is cut by a laser between the contact hole 111b and a part where the short-circuiting occurred. This makes it possible to maintain a state in which the pixel electrodes 17a and 17b each of which receives a signal potential from the data signal line 15x are connected with each other via the coupling capacitors. In addition, even if the contact holes 111b becomes defective in a manufacturing process or the like, it is possible to maintain a state in which the pixel electrodes 17a and 17b are connected with each other via the coupling capacitors. If short-circuiting of the capacitor electrode 37a and the pixel electrode 17b occurred, the capacitor electrode 37a is cut by a laser between the contact hole 11a and a part where the short-circuiting occurred.

In the correction step, the capacitor electrode 37b is irradiated with a laser via the second gap K2 from the top surface side of the active matrix substrate 3 (i.e., from the counter side to the glass substrate 31 side) so as to be cut. Thus, the present embodiment makes it possible to improve a manufacturing yield of a liquid crystal panel and an active matrix substrate to be provided in the liquid crystal panel.

Further, the liquid crystal panel illustrated in FIG. 32 is arranged such that if the capacitor electrode 37a is rotated by 180° around a point of the second gap K2, the capacitor electrode 37a is substantially located in a place where the capacitor electrode 37b is provided. Therefore, even if the pixel electrodes 17a and 17b become misaligned with respect to the capacitor electrodes 37a and 37b in a direction perpendicular to the second gap K2, an area where the capacitor electrode 37a and the pixel electrode 17b overlap each other and an area where the capacitor electrode 37b and the pixel electrode 17a overlap each other complement each other. This is advantageous in that a total amount of capacitances of the two coupling capacitors (Cab1 and Cab2) is unlikely to change.

Further, the liquid crystal panel illustrated in FIG. 32 is arranged such that the pixel electrode 17b corresponding to a dark subpixel surrounds and encloses the pixel electrode 17b corresponding to a bright subpixel. This makes it possible to clearly display a video image of a high spatial frequency.

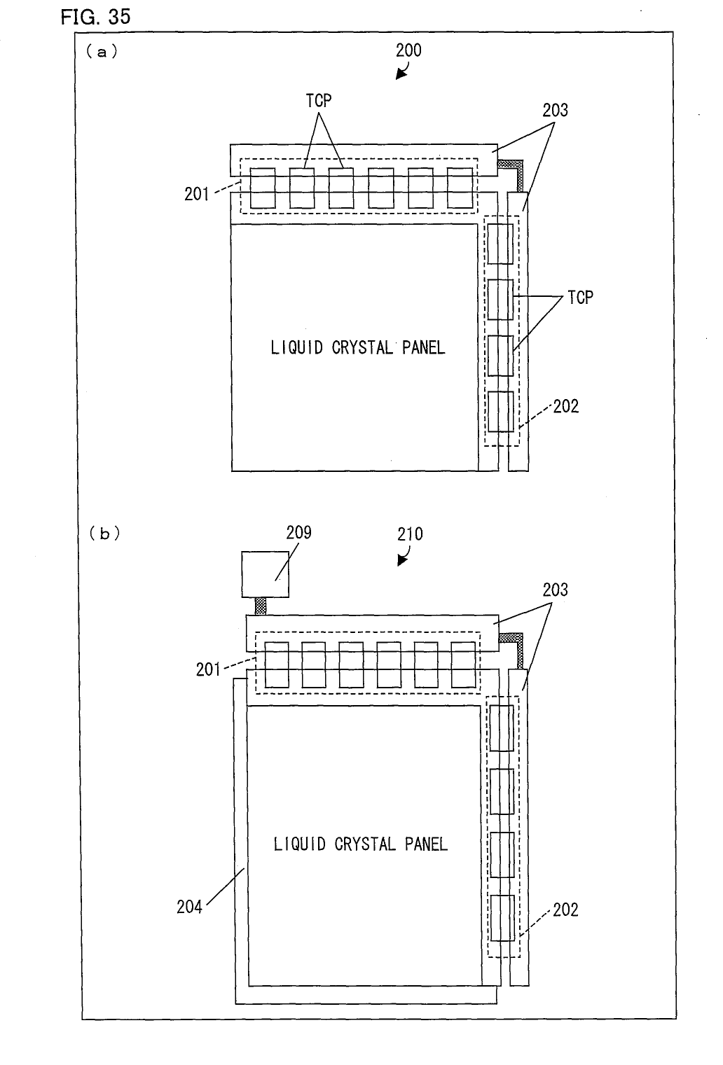

In the present embodiment, a liquid crystal display unit and a liquid crystal display apparatus are made as below. Specifically, two polarizing plates A and B are attached onto both sides of the liquid crystal panel, respectively, so that a polarization axis of the polarizing plate A and a polarization axis of the polarizing plate B are perpendicular to each other. As needed, an optical compensation sheets or the like can be stacked on each of the polarizing plates A and B. Then, as illustrated in (a) of FIG. 35, drivers (gate driver 202 and source driver 201) are connected with the liquid crystal panel. The following deals, as one example, a method in which the drivers are connected with the liquid crystal panel by TCP (Tape Career Package) method. First, an ACF (Anisotropic Conductive Film) is temporarily adhered to a terminal section of the liquid crystal panel by application of a pressure. Then, TCPs on which the drivers are mounted are punched out from carrier tapes, positioned on terminal electrodes of the liquid crystal panel, and heated and pressured so as to be completely adhered to the terminal electrodes. Then, a circuit substrate 209 (PWB: Printed Wiring Board) for connecting the TCPs is connected with input terminals of the TCPs via the ACF. Thus, a liquid crystal display unit 200 is completed. Then, as illustrated in (b) of FIG. 35, the drivers 201 and 202 of the liquid crystal display unit 200 are connected with a display control circuit 209 via the circuit substrate 203. Then, the liquid crystal display unit 200 is combined with an illumination device (backlight unit) 204. Thus, a liquid crystal display apparatus 210 is completed.

In this specification, “a polarity of an electric potential” refers to an electric potential not lower than a reference electric potential (i.e., positive electric potential) or an electric potential higher than the reference electric potential (negative). The reference electric potential can be Vcom (common electric potential) which is an electric potential of the common electrode (counter electrode) or any other electric potential.

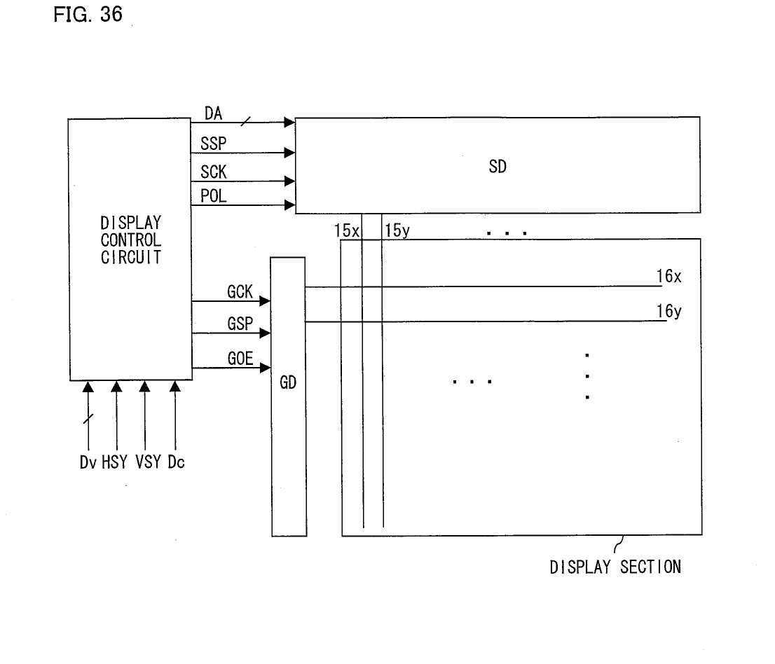

FIG. 36 is a block diagram illustrating an arrangement of the liquid crystal display apparatus. As illustrated in FIG. 36, the liquid crystal display apparatus includes a display section (liquid crystal panel), a source driver (SD), a gate driver (GD), and a display control circuit. The source driver drives data signal lines whereas the gate driver drives scanning signal lines. The display control circuit controls the source driver and the gate driver.

The display control circuit receives, from an external signal source (e.g., tuner), a digital video signal Dv indicative of an image to be displayed, a horizontal synchronization signal HSY and a vertical synchronization signal VSY which correspond to the digital video signal Dv, and a control signal Dc for controlling a display action. In accordance with signals the digital video signal Dv, the horizontal synchronization signal HSY, the vertical synchronization signal VSY, and the control signal Dc thus received, the display control circuit generates, as signals for displaying, on the display section, the image indicated by the digital video signal Dv: a data start pulse signal SSP; a data clock signal SCK; a digital image signal DA indicative of the image to be displayed (i.e., signal corresponding to the digital video signal Dv); a gate start pulse signal GSP; a gate clock signal GCK; and a gate driver output control signal (scanning signal output control signal) GOE.

More specifically, in the display control circuit, the digital video signal Dv is subjected to timing adjustment etc. in an internal memory, as needed. Then, the digital video signal Dv is outputted from the display control circuit as the digital image signal DA. In addition, the display control circuit generates the data clock signal SCK as a signal having pulses corresponding to pixels of the image indicated by the digital image signal DA. Further, the display control circuit (i) generates, in accordance with the horizontal synchronization signal HSY, the data start pulse signal SSP as a signal which has a High level (H level) only for a predetermined period in every one horizontal scanning period, (ii) generates, in accordance with the vertical synchronization signal VSY, the gate start pulse signal GSP as a signal which has an H level only for a predetermined period in every one frame period (i.e., in every one vertical scanning period), (iii) generates, in accordance with the horizontal synchronization signal HSY, the gate clock signal GCK, and (iv) generates the gate driver output control signal GOE in accordance with the horizontal synchronization signal HSY and the control signal Dc.

Of signals thus generated in the display control circuit, the digital image signal DA, a polarity reversal signal POL for controlling a polarity of a signal potential (data signal potential), the data start pulse signal SSP, and the data clock signal SCK are supplied from the display control circuit to the source driver. On the other hand, the gate start pulse signal GSP, the gate clock signal GCK, and the gate driver output control signal GOE are supplied from the display control circuit to the gate driver.

In accordance with the digital image signal DA, the data clock signal SCK, the data start pulse signal SSP, and the polarity reversal signal POL, the source driver sequentially generates analog electric potentials (signal potentials) corresponding respectively to pixel values of the image indicated by the digital image signal DA, for each of the scanning signal lines, every one horizontal scanning period. Data signals thus generated are supplied from the source driver to the data signal lines (e.g., data signal lines 15x and 15y).

In accordance with the gate start pulse signal GSP, the gate clock signal GCK, and the gate driver output control signal GOE, the gate driver generates gate ON pulse signals, and supplies the gate ON pulse signals to the scanning signal lines, thereby selectively driving the scanning signal lines.

Thus, the source driver drives the data signal lines of the display section (liquid crystal panel) while the gate driver drives the scanning signal lines of the display section. Accordingly, a signal potential is supplied from a data signal line to a pixel electrode via a transistor (TFT) connected with a selected scanning signal line. This applies a voltage to a liquid crystal layer of each of subpixels so that an amount of transmission of light emitted from a backlight is controlled. As a result, the image indicated by the digital video signal Dv is displayed by each of the subpixels.

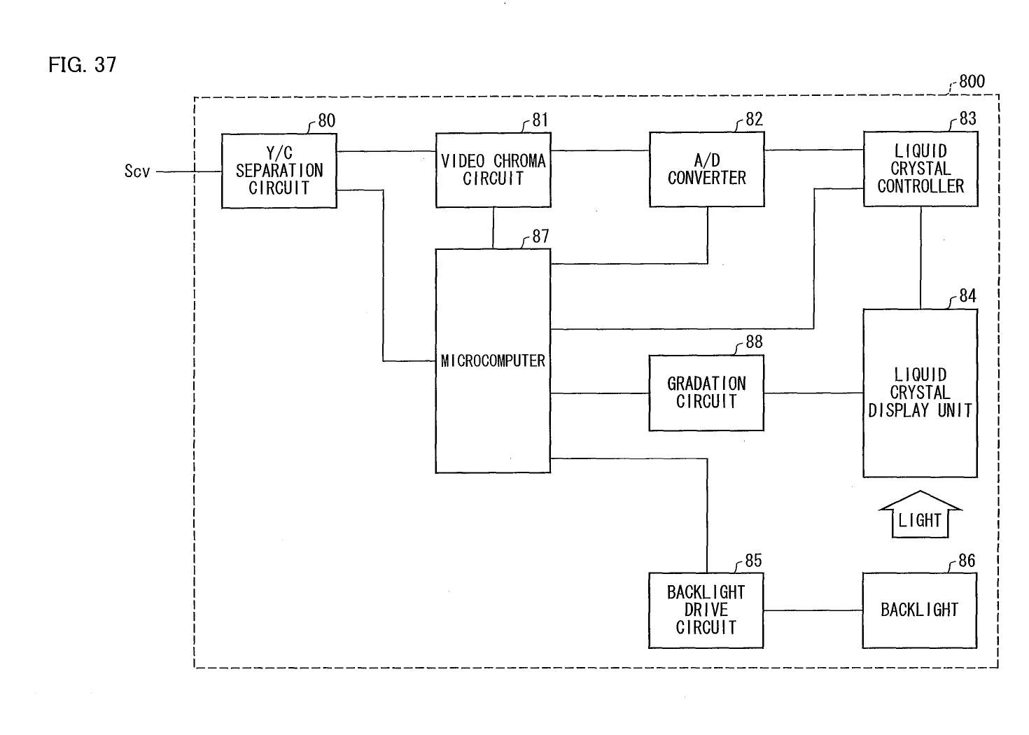

The following describes one arrangement example of application of the liquid crystal display apparatus to a television receiver. FIG. 37 is a block diagram illustrating an arrangement of a liquid crystal display apparatus 800 for a television receiver. The liquid crystal display apparatus 800 includes a liquid crystal display unit 84, a Y/C separation circuit 80, a video chroma circuit 81, an A/D converter 82, a liquid crystal controller 83, a backlight drive circuit 85, a backlight 86, a microcomputer 87, and a gradation circuit 88. The liquid crystal display unit 84 includes a liquid crystal panel, and a source driver and a gate driver which are for driving the liquid crystal panel.

In the liquid crystal display apparatus 800 thus arranged, a composite color video signal Scv which is a television signal is externally supplied to the Y/C separation circuit 80 so as to be split into a luminance signal and a color signal. The luminance signal and the color signal are converted by the video chroma circuit 81 into an analog RGB signal corresponding to three primary colors of light. Further, the analog RGB signal is converted by the A/D converter 82 into a digital RGB signal. The digital RGB signal is supplied to the liquid crystal controller 83. In the Y/C separation circuit 80, a horizontal synchronization signal and a vertical synchronization signal are also extracted from the composite color video signal Scv so as to be also supplied to the liquid crystal controller 83 via the microcomputer 87.

The digital RGB signal and a timing signal based on the horizontal synchronization signal and the vertical synchronization signal are supplied from the liquid crystal controller 83 to the liquid crystal display unit 84 at a predetermined timing. The gradation circuit 88 generates gradation electric potentials corresponding respectively to the three primary colors R, G, and B for color image display. The gradation electric potentials are also supplied to the liquid crystal display unit 84. In accordance with the digital RGB signal, the timing signal, and the gradation electric potentials, the liquid crystal display unit 84 generates drive signals (data signals=signal potentials, scanning signals, etc.) by use of an internal source driver, an internal gate driver, etc. In accordance with the drive signals, a color image is displayed on an internal liquid crystal panel. In order to cause the liquid crystal display unit 84 to display an image, it is necessary to emit light from behind the liquid crystal panel in the liquid crystal display unit 84. In the case of the liquid crystal display apparatus 800, the backlight drive circuit 85 drives the backlight 86 under control of the microcomputer 87. As a result, light is emitted onto a back surface of the liquid crystal panel. Control of an entire system, including this process, is carried out by the microcomputer 87. It is possible to use, as an externally-supplied video signal (composite color video signal), not only a video signal of a television broadcast but also a video signal of an image captured by a camera, a video signal supplied via the Internet, etc. Thus, the liquid crystal display apparatus 800 can display images in accordance with various video signals.

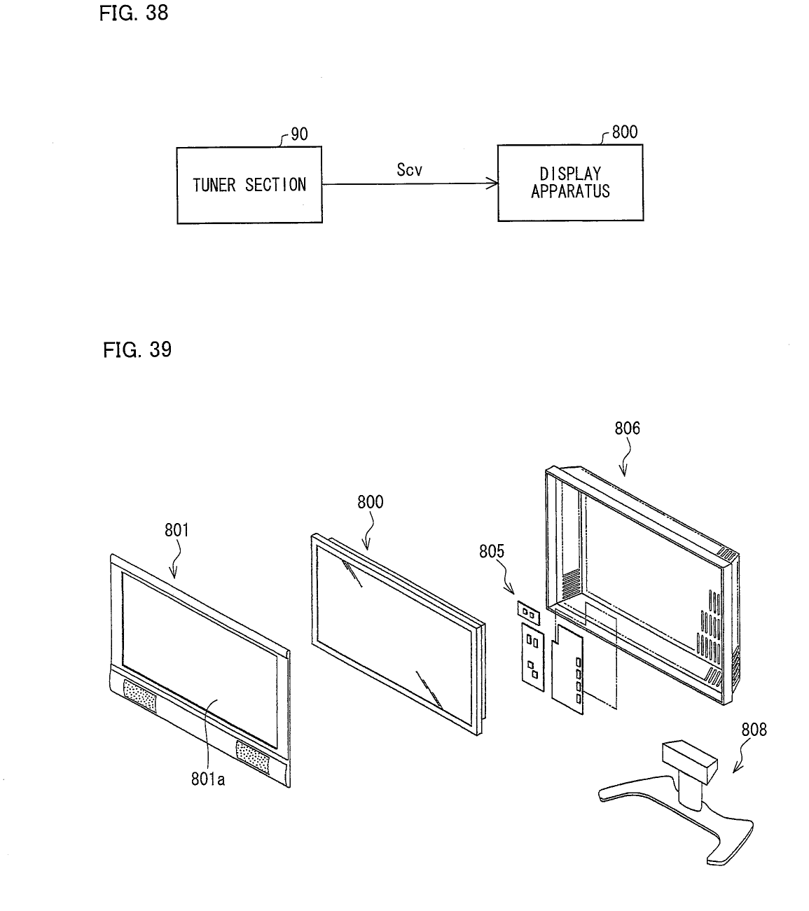

In a case where the liquid crystal display apparatus 800 displays an image of a television broadcast, a tuner section 90 is connected with the liquid crystal display apparatus 800 as illustrated in FIG. 38. Thus, a television receiver is realized. The tuner section 90 selects, among airwaves (high-frequency signals) received via an antenna (not illustrated), a signal of a channel to be received, then converts the signal into an intermediate frequency signal, and demodulates the intermediate frequency signal. Thus, the composite color video signal Scv is extracted from the intermediate frequency signal as a television signal. The composite color video signal Scv is supplied to the liquid crystal display apparatus 800, as described above. Accordingly, the liquid crystal display apparatus 800 displays an image in accordance with the composite color video signal Scv.

FIG. 39 is an exploded perspective view illustrating one arrangement example of the television receiver. As illustrated in FIG. 39, the television receiver includes, as its components, a first housing 801 and a second housing 802, in addition to the liquid crystal display apparatus 800. The television receiver is arranged such that the first housing 801 and the second housing 806 sandwich the liquid crystal display apparatus 800 therebetween so as to enwrap the liquid crystal display apparatus 800. The first housing 801 has an opening section 801a through which an image to be displayed by the liquid crystal display apparatus 800 passes through. The second housing 806 is a member for covering a backside of the liquid crystal display apparatus 800. The second housing 806 includes an operation circuit 805 for operating the liquid crystal display apparatus 800. In addition, a supporting member 808 is provided to a lower part of the second housing 806.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

An active matrix substrate of the present invention and a liquid crystal panel including the active matrix substrate are suitably applicable to, e.g., a liquid crystal television.

1. An active matrix substrate comprising a scanning signal line, a data signal line, a transistor being connected with the scanning signal line and the data signal line, a first pixel electrode, and a second pixel electrode, the first pixel electrode and the second pixel electrode being provided in a single pixel region,
said active matrix substrate, further comprising a first capacitor electrode and a second capacitor electrode,
the first capacitor electrode, the first pixel electrode, and a conductive electrode of the transistor being electrically connected with each other, the second capacitor electrode being electrically connected with the second pixel electrode,
the first capacitor electrode and the second pixel electrode forming a capacitor, and
the second capacitor electrode and the first pixel electrode forming a capacitor.

2. The active matrix substrate as set forth in claim 1, wherein the conductive electrode of the transistor, the first capacitor electrode, and the second capacitor electrode are formed in a same layer.

3. The active matrix substrate as set forth in claim 1, wherein at least a part of the first capacitor electrode and the second pixel electrode overlap each other via an interlayer insulating film which covers a channel of the transistor, and at least a part of the second capacitor electrode and the first pixel electrode overlap each other via the interlayer insulating film.

4. The active matrix substrate as set forth in claim 1, wherein:
each of an outer periphery of the first pixel electrode and an outer periphery of the second pixel electrode includes a plurality of sides;
one of the plurality of sides of the first pixel electrode is adjacent to one of the plurality of sides of the second pixel electrode; and
each of the first capacitor electrode and the second capacitor electrode, the first pixel electrode, the second pixel electrode, and a gap between the one of the plurality of sides of the first pixel electrode and the one of the plurality of sides of the second pixel electrode are provided so as to overlap one another.

5. The active matrix substrate as set forth in claim 4, wherein the first and second capacitor electrodes are provided so that, if the first capacitor electrode is virtually rotated by 180° around a point of the gap, the first capacitor electrode is substantially located in a place where the second capacitor electrode is provided.

6. The active matrix substrate as set forth in claim 4, wherein the first and second capacitor electrodes are provided so that, if the first capacitor electrode (i) is moved in a direction parallel to a longitudinal direction of the gap and (ii) is axisymmetrically moved with respect to an axis which extends along a center line of the gap which center line extends in the longitudinal direction, the first capacitor electrode is substantially located in a place where the second capacitor electrode is provided.

7. The active matrix substrate as set forth in claim 1, wherein the conductive electrode of the transistor is connected with the first pixel electrode via a contact hole, and is connected with the first capacitor electrode via a wire for drawing out the first capacitor electrode.

8. The active matrix substrate as set forth in claim 1, wherein the conductive electrode is connected with the first pixel electrode via a contact hole, and the first pixel electrode is connected with the first capacitor electrode via a contact hole.

9. The active matrix substrate as set forth in claim 1, wherein the first pixel electrode and the second pixel electrode are arranged in a column direction which is perpendicular to a line direction in which the scanning signal line extends.

10. The active matrix substrate as set forth in claim 1, wherein the first pixel electrode and the second pixel electrode are arranged in a line direction in which the scanning signal line extends.

11. The active matrix substrate as set forth in claim 1, wherein the first pixel electrode surrounds and encloses the second pixel electrode.

12. The active matrix substrate as set forth in claim 1, wherein the second pixel electrode surrounds and encloses the first pixel electrode.

13. The active matrix substrate as set forth in claim 1, wherein the transistor is closer to the first pixel electrode than to the second pixel electrode.

14. The active matrix substrate as set forth in claim 9, wherein first and second pixel regions, adjacent to each other in the line direction, in each of which the first and second pixel electrodes are arranged in the column direction, and a first pixel electrode in the first pixel region is adjacent, in the line direction, to the second pixel electrode in the second pixel region.

15. The active matrix substrate as set forth in claim 10, wherein first and second pixel regions, adjacent to each other in the column direction, in each of which the first and second pixel electrodes are arranged in the line direction, and a first pixel electrode in the first pixel region is adjacent, in the column direction, to the second pixel electrode in the second pixel region.

16. The active matrix substrate as set forth in claim 1, further comprising a retention capacitor wire, (i) the retention capacitor wire and the first pixel electrode or an electric conductor being electrically connected with the first pixel electrode forming a capacitor, and (ii) the retention capacitor wire and the second pixel electrode or an electric conductor being electrically connected with the second pixel electrode forming a capacitor.

17. The active matrix substrate as set forth in claim 16, wherein the retention capacitor wire extends so as to cross a center of the pixel region in a direction in which the scanning signal line extends.

18. The active matrix substrate as set forth in claim 16, wherein each of the first capacitor electrode and the second capacitor electrode and the retention capacitor wire form a capacitor.

19. The active matrix substrate as set forth in claim 3, wherein:
the interlayer insulating film includes an inorganic insulating film and an organic insulating film which is thicker than the inorganic insulating film; and
no organic insulating film is provided in (i) at least a part of a portion of the interlayer insulating film in which portion the interlayer insulating film, the first capacitor electrode, and the second pixel electrode overlap one another and (ii) at least a part of a portion of the interlayer insulating film in which portion the interlayer insulating film, the second capacitor electrode, and the first pixel electrode overlap one another.

20. The active matrix substrate as set forth in claim 1, wherein the gap between the first pixel electrode and the second pixel electrode serves as an alignment-controlling structure.

21. The active matrix substrate as set forth in claim 18, wherein:
each of an outer periphery of the first pixel electrode and an outer periphery of the second pixel electrode includes a plurality of sides;
one of the plurality of sides of the first pixel electrode is adjacent to one of the plurality of sides of the second pixel electrode;
each of the first capacitor electrode and the second capacitor electrode, the first pixel electrode, the second pixel electrode, and a gap between the one of the plurality of sides of the first pixel electrode and the one of the plurality of sides of the second pixel electrode are provided so as to overlap one another; and
the retention capacitor wire has an opening so that the opening, the gap, and the first capacitor electrode overlap one another.

22. The active matrix substrate as set forth in claim 1, wherein:
the first pixel electrode surrounds and encloses the second pixel electrode;
an outer periphery of the second pixel electrode includes two parallel sides;
an outer periphery of the first pixel electrode includes a side facing, via a first gap, one of the two parallel sides, and a side facing the other of the two parallel sides via a second gap;
the first capacitor electrode is provided so that the first capacitor electrode, the first pixel electrode, the first gap, and the second pixel electrode overlap one another; and
the second capacitor electrode is provided so that the second capacitor electrode, the second pixel electrode, the second gap, and the first pixel electrode overlap one another.

23-26. (canceled)

27. A liquid crystal panel comprising an active matrix substrate recited in claim 1.

28-30. (canceled)
